(19) United States
(12) Patent Application Publication
(10) Pub. No.: US 2026/0049192 A1
(43) Pub. Date: Feb. 19, 2026

(54) DYED ARTICLES FOR VISIBLE AND INFRARED LIGHT ABSORPTION

(71) Applicant: Oakley, Inc., Foothill Ranch, CA (US)

(72) Inventors: Drew R. HEITZ, Columbus, OH (US); Timothy P. POLLAGI, Bellbrook, OH (US); Paul A. CAHILL, Dayton, OH (US)

(73) Assignee: Oakley, Inc., Foothill Ranch, CA (US)

(21) Appl. No.: 19/369,655

(22) Filed: Oct. 27, 2025

Related U.S. Application Data
(63) Continuation of application No. PCT/US2024/060541, filed on Dec. 17, 2024.
(60) Provisional application No. 63/626,155, filed on Jan. 29, 2024.

(51) Int. Cl. C08J 7/06; B29C 48/00; B29C 71/02; C08J 3/24; C08K 5/18; C08K 5/315; C08K 5/3462; C08K 11/00

(52) U.S. Cl. CPC C08J 7/06; B29C 48/022; C08J 3/24; C08J 7/08; C08K 5/18; C08K 5/315; C08K 5/3462; C08K 11/00; C08K 2201/013

(57) ABSTRACT

The present disclosure provides dyed articles comprising a polymer resin and a) a first dye that provides peak infrared absorption in the range of between about 900 nm and about 1100 nm in the resin and b) a minus-violet dye. The present disclosure also provides minus-violet dyes according to Formulae II and III, and methods of making the minus-violet dyes.

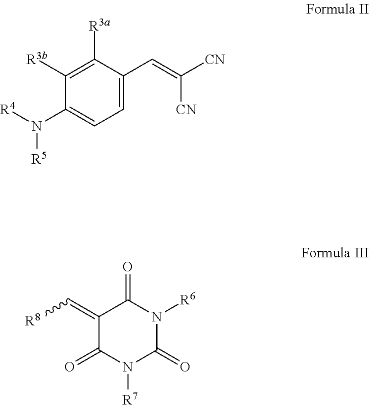

### CROSS REFERENCE TO RELATED APPLICATIONS

This application is a continuation of PCT/US2024/060541 filed Dec. 17, 2024, which claims the benefit of U.S. Provisional Patent Application No. 63/626,155, filed Jan. 29, 2024, which are hereby incorporated by reference in their entireties.

### FIELD

The present disclosure provides articles comprising a polymer resin, a first dye that provides peak infrared absorption in the range of between about 900 nm and about 1100 nm in the resin, and a minus-violet dye, i.e., a dye compound that selectively or predominantly absorbs blue and/or violet light.

### BACKGROUND

Protective articles that block transmission of light are needed to protect human eyes from hazardous levels of light radiation exposure. For example, and without limitation, as the applications for, and use of, continuous wave and pulsed lasers continue to grow, articles that can protect against harmful laser light radiation are needed. Laser protection and protection for eyes against other harmful light sources (natural and artificial) can take many forms, such as machine guards, laser safety windows, panels, curtains, and personal protective equipment of all types: eyewear, including goggles, shields, visors, as well as clothing and helmets that may include face shields (such as visors for helmets).

In particular, high-power infrared fiber and disc lasers generally having wavelengths longer than 900 nm, e.g., diode lasers near 980 nm, Nd:YAG lasers near 1064 nm, and fiber lasers at yet longer wavelengths are increasingly used. Thus, there is a need to develop protective articles comprising dyes or combinations of dyes that selectively block infrared laser radiation while allowing visible light transmission.

### BRIEF SUMMARY

In one aspect, the present disclosure is directed to a dyed article comprising a polymer resin and
(a) a first dye that provides peak infrared absorption in the range of between about 900 nm and about 1100 nm in the resin, and
(b) a minus-violet dye.

In another aspect, the first dye is a dye according to Formula I:

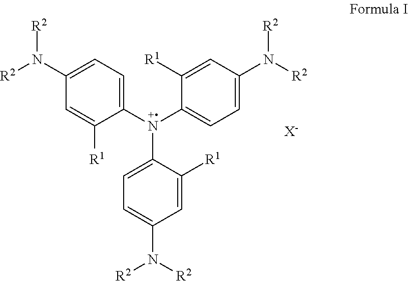

wherein each R¹ is independently at each occurrence H or C₁-C₄ alkyl;
each R² is independently at each occurrence selected from the group consisting of C₁-C₆ alkyl, C₁-C₆ haloalkyl, and C₁-C₆ cyanoalkyl; and
X⁻ is an anion.

In another aspect, the first dye is a dye according to Formula I, wherein each R¹ is H.

In another aspect, the first dye is a dye according to Formula I, wherein

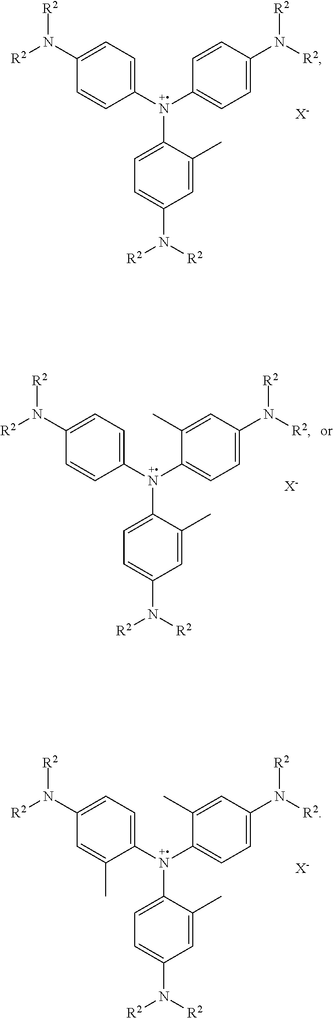

In another aspect, the first dye is a dye according to Formula I, wherein R² at each occurrence is n-butyl.

In another aspect, the first dye is a dye according to Formula I, wherein the anion is a carboxylate selected from the group consisting of CH₃CO₂— and CF₃CO₂—.

In another aspect, the first dye is a dye according to Formula I, wherein the anion is a sulfonate having the formula [X^{a}SO₃]⁻, wherein X^{a} is selected from the group consisting of halo, C₁-C₄ alkyl, C₁-C₄ haloalkyl, and phenyl optionally substituted with one to five groups selected from halo, C₁-C₄ alkyl, and C₁-C₄ haloalkyl.

In another aspect, the sulfonate is [CH₃SO₃]⁻, [C₆H₅SO₃]⁻, [4-CH₃—C₆H₄SO₃]⁻, or [CF₃SO₃]⁻.

In another aspect, the first dye is a dye according to Formula I, wherein the anion is a bis(alkylsulfonyl)amide having the formula [N(SO₂X^{b})₂]⁻, wherein each X^{b} is independently selected from the group consisting of halo, C₁-C₄ alkyl, C₁-C₄ haloalkyl, and phenyl optionally substituted with one to five groups selected from halo, C₁-C₄ alkyl, and C₁-C₄ haloalkyl.

In another aspect, the bis(alkylsulfonyl)amide is [N(SO₂CF₃)₂]⁻.

In another aspect, the first dye is a dye according to Formula I, wherein the anion is a borate having the formula [BX^{c}₄]⁻, wherein X^{c} is selected from the group consisting of halo, C₁-C₄ alkyl, C₁-C₄ haloalkyl, and phenyl optionally substituted with one to five groups selected from halo and C₁-C₄ haloalkyl.

In another aspect, the borate is [BF₄]⁻, [B(C₆F₅)₄]⁻, or [B(3,5-(CF₃)₂C₆H₃)₄]⁻.

In another aspect, the first dye is a compound selected from the group consisting of:
tris(4-di(n-butyl)amino-2-methylphenyl)amminium tetrafluoroborate;
bis(4-di(n-butyl)amino-2-methylphenyl)(4-di(n-butyl)amino-phenyl)amminium tetrafluoroborate;
bis(4-di(n-butyl)amino-phenyl)(4-di(n-butyl)amino-2-methylphenyl)amminium tetrafluoroborate;
tris(4-di(n-butyl)aminophenyl)amminium tetrakis(pentafluorophenyl)borate tetrafluoroborate;
tris(4-di(n-butyl)amino-2-methylphenyl)amminium perchlorate;
bis(4-di(n-butyl)amino-2-methylphenyl)(4-di(n-butyl)amino-phenyl)amminium perchlorate;
bis(4-di(n-butyl)amino-phenyl)(4-di(n-butyl)amino-2-methylphenyl)amminium perchlorate;
tris(4-di(n-butyl)aminophenyl)amminium perchlorate;
bis(4-di(n-butyl)amino-2-methylphenyl)(4-di(n-butyl)aminophenyl)amminium tetrakis(pentafluorophenyl)borate;
tris(4-di(n-butyl)amino-2-methylphenyl)amminium tetrakis(pentafluorophenyl)borate;
bis(4-di(n-butyl)amino-phenyl)(4-di(n-butyl)amino-2-methylphenyl)amminium tetrakis(pentafluorophenyl)borate;
tris(4-di(n-butyl)aminophenyl)amminium tetrakis(pentafluorophenyl)borate;
tris(4-di(n-butyl)amino-2-methylphenyl)amminium methanesulfonate;
bis(4-di(n-butyl)amino-2-methylphenyl)(4-di(n-butyl)amino-phenyl)amminium methanesulfonate;
bis(4-di(n-butyl)amino-phenyl)(4-di(n-butyl)amino-2-methylphenyl)amminium methanesulfonate;
tris(4-di(n-butyl)aminophenyl)amminium methanesulfonate;
tris(4-di(3-cyanopropyl)amino-2-methylphenyl)amminium tetrafluoroborate;
bis(4-di(3-cyanopropyl))amino-2-methylphenyl)(4-di(3-cyanopropyl)amino-phenyl)amminium tetrafluoroborate;
bis(4-di(3-cyanopropyl)amino-phenyl)(4-di(3-cyanopropyl)amino-2-methylphenyl)amminium tetrafluoroborate;
tris(4-di(3-cyanopropyl)aminophenyl)amminium tetrafluoroborate;
tris(4-di(3-cyanopropyl)amino-2-methylphenyl)amminium tetrakis(pentafluorophenyl)borate;
bis(4-di(3-cyanopropyl))amino-2-methylphenyl)(4-di(3-cyanopropyl)amino-phenyl)amminium tetrakis(pentafluorophenyl)borate;
bis(4-di(3-cyanopropyl)amino-phenyl)(4-di(3-cyanopropyl)amino-2-methylphenyl)amminium tetrakis(pentafluorophenyl)borate; and
tris(4-di(3-cyanopropyl)aminophenyl)amminium tetrakis(pentafluorophenyl)borate.

In another aspect, the minus-violet dye is a dye according to Formula II:

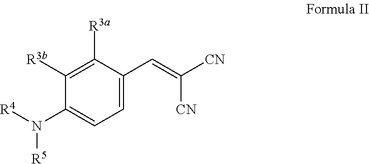

wherein:
   R^{3a} and R^{3b} are each independently selected from the group consisting of H, C₁-C₄ alkyl, C₁-C₄ alkoxy, phenoxy, C₁-C₄ alkylthio, hydroxyl, and halo;
   R⁴ and R⁵ are each independently selected from the group consisting of C₁-C₆ alkyl, C₁-C₆ haloalkyl, C₁-C₆ cyanoalkyl, C₆-C₁₀ aryl, C₁-C₆ alkylene-C(═O)OR^{4a}, C₁-C₆ alkylene-C(═O)R^{4a}, and C₁-C₆ alkylene-OC(═O)NR^{4a}R^{4b}; or
   R⁴ and R⁵ are taken together with the nitrogen atom to which they are attached to form an optionally substituted 4- to 7-membered heterocycle;
   R^{4a} is independently at each occurrence selected from the group consisting of C₁-C₆ alkyl and C₆-C₁₀ aryl; and
   R^{4b} is independently at each occurrence selected from the group consisting of H and C₁-C₄ alkyl.

In another aspect, the minus-violet dye is a dye according to Formula II, wherein:
R^{3a} is H, methyl, methoxy, ethyloxy, phenoxy, hydroxyl, fluoro, chloro, or bromo;
R^{3b} is H; and
R⁴ and R⁵ are each independently selected from the group consisting of methyl, ethyl, n-butyl, phenyl, 3-cyanopropyl, —CH₂C(═O)OCH₂CH₃, —CH₂CH₂C(═O)CH₃ and —CH₂CH₂OC(═O)NH(C₆-C₁₀ aryl) or
R⁴ and R⁵ are taken together with the nitrogen atom to which they are attached to form a pyrrolidinyl group.

In another aspect, the minus-violet dye is a dye according to Formula II, wherein:
R^{3a} is H;
R^{3b} is H; and
R⁴ and R⁵ are each methyl, ethyl, or —CH₂C(═O)OCH₂CH₃; or
R⁴ and R⁵ are taken together with the nitrogen atom to which they are attached to form a pyrrolidinyl group.

In another aspect, the minus-violet dye is a dye according to Formula II, wherein:
R^{3a} is methyl;
R^{3b} is H; and
R⁴ and R⁵ are each methyl; or
R⁴ is ethyl and R⁵ is —CH₂CH₂OC(═O)NHPh.

In another aspect, the minus-violet dye is a dye according to Formula II, wherein:
R^{3a} is methoxy;
R^{3b} is H; and
R⁴ and R⁵ are each 3-cyanopropyl or —CH₂C(═O)OCH₂CH₃.

In another aspect, the minus-violet dye is a dye according to Formula II, wherein:
R^{3a} is ethoxy;
R^{3b} is H; and
R⁴ and R⁵ are each ethyl.

In another aspect, the minus-violet dye is a dye according to Formula II, wherein:
R^{3a} is phenoxy;
R^{3b} is H; and
R⁴ and R⁵ are each ethyl.

In another aspect, the minus-violet dye is a dye according to Formula II, wherein:
R^{3a} is fluoro;
R^{3b} is H; and
R⁴ and R⁵ are each —CH₂C(═O)OCH₂CH₃.

In another aspect, the minus-violet dye is a dye according to Formula II, wherein the minus-violet dye is a compound selected from the group consisting of:
2-(4-(dimethylamino)benzylidene)malononitrile;
2-(4-(diethylamino)benzylidene)malononitrile;
2-(4-(pyrrolidin-1-yl)benzylidene)malononitrile;
2-(4-(dimethylamino)-2-methylbenzylidene)malononitrile;
2-(4-(diethylamino)-2-ethoxybenzylidene)malononitrile;
2-(4-(diethylamino)-2-phenoxybenzylidene)malononitrile;
diethyl 2,2′-((4-(2,2-dicyanovinyl)phenyl)azanediyl)diacetate;
diethyl 2,2′-((4-(2,2-dicyanovinyl)-3-methoxyphenyl)azanediyl)diacetate;
diethyl 2,2′-((4-(2,2-dicyanovinyl)-3-fluorophenyl)azanediyl)diacetate;
2-(4-(bis(3-cyanopropyl)amino)-2-methoxybenzylidene)malononitrile; and
2-((4-(2,2-dicyanovinyl)-3-methylphenyl)(ethyl)amino)ethyl phenylcarbamate.

In another aspect, the minus-violet dye is a dye according to Formula III:

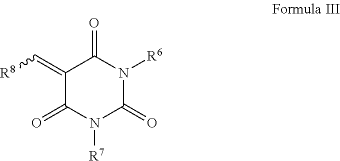

or a stereoisomer thereof, wherein:
R⁶ is selected from the group consisting of H, C₁-C₆ alkyl, —(CH₂)ₙO(CH₂)ₘCH₃, C₃-C₁₂ cycloalkyl, C₆-C₁₀ aryl, and C₆-C₁₀ arylene-C₁-C₄ alkyl;
R⁷ is selected from the group consisting of H, C₁-C₆ alkyl, —(CH₂)ₙO(CH₂)ₘCH₃, C₃-C₁₂ cycloalkyl, C₆-C₁₀ aryl, C₆-C₁₀ arylene-C₁-C₄ alkyl, and C₁-C₁₂ alkylene-R¹²;
n at each occurrence is independently an integer from 1 to 6;
m at each occurrence is independently an integer from 0 to 3;
R⁸ is

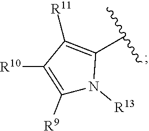

R⁹, R¹⁰, and R¹¹ are each independently selected from the group consisting of C₁-C₆ alkyl, C₃-C₁₂ cycloalkyl, C₆-C₁₀ aryl, and C₆-C₁₀ arylene-C₁-C₄ alkyl;
R¹³ is selected from the group consisting of H, C₁-C₆ alkyl, C₁-C₆ haloalkyl, C₁-C₆ cyanoalkyl, C₁-C₆ alkylene-C₆-C₁₀ aryl, C₁-C₆ alkylene-OC(═O)R¹⁴, and C₁-C₁₂ alkylene-R¹⁵;
R¹² is

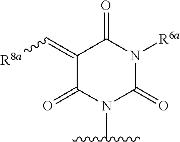

provided that when R⁷ is C₁-C₁₂ alkylene-R¹², R^{8a} is identical to R¹ and R^{6a} is identical to R⁶;
R¹⁴ is C₁-C₆ alkyl; and
R¹⁵ is

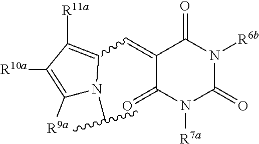

provided that when R¹³ is C₁-C₁₂ alkylene-R¹, R^{9a} is identical to R⁹, R^{10a} is identical to R¹⁰, R^{11a} is identical to R¹¹, R^{6b} is identical to R⁶, and R^{7a} is identical to R⁷.

In another aspect, the minus-violet dye is a dye according to Formula III, wherein:
R⁶ is methyl, 3-methoxypropyl, cyclohexyl, phenyl, or 3-tert-butylphenyl;
R⁷ is methyl, 3-methoxypropyl, cyclohexyl, phenyl, 3-tert-butylphenyl, or hexylene-R¹²;
R⁹ is H, methyl, tert-butyl, or —CH₂C(═O)OCH₂CH₃;
R¹⁰ is H, tert-butyl, or —CH₂C(═O)OCH₂CH₃;
R¹¹ is H or methyl; and
R¹³ is H, methyl, n-butyl, cyanomethyl, —CH₂C(═O)OCH₂CH₃, benzyl, 2-napthalenylmethyl, or hexylene-R¹.

In another aspect, the minus-violet dye is a dye according to Formula III, wherein R⁶ and R⁷ are each methyl, cyclohexyl, phenyl, or 3-tert-butylphenyl.

In another aspect, the minus-violet dye is a dye according to Formula III, wherein R⁶ is 3-methoxypropyl and R⁷ is phenyl.

In another aspect, the minus-violet dye is a dye according to Formula III, wherein R⁶ is cyclohexyl and R⁷ is phenyl.

In another aspect, the minus-violet dye is a dye according to Formula III, wherein R⁶ is 3-methoxypropyl or 3-tert-butylphenyl and R⁷ is hexylene-R¹².

In another aspect, the minus-violet dye is a dye according to Formula III, wherein R⁸ is:

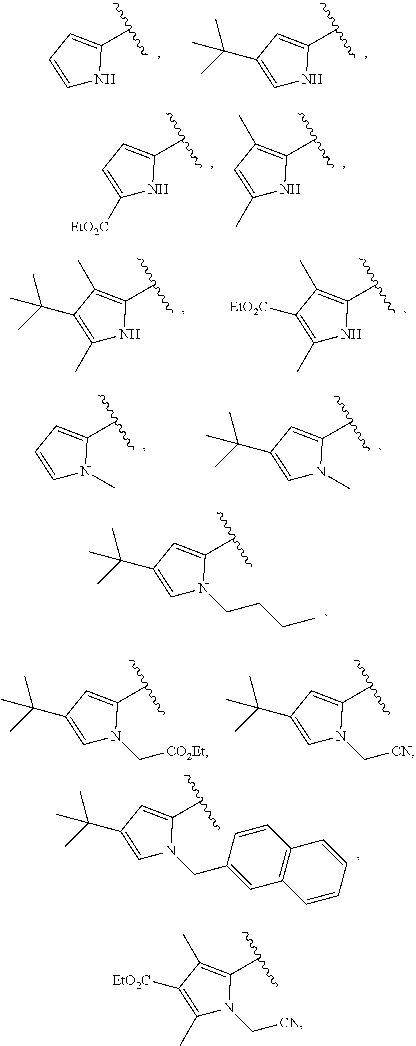

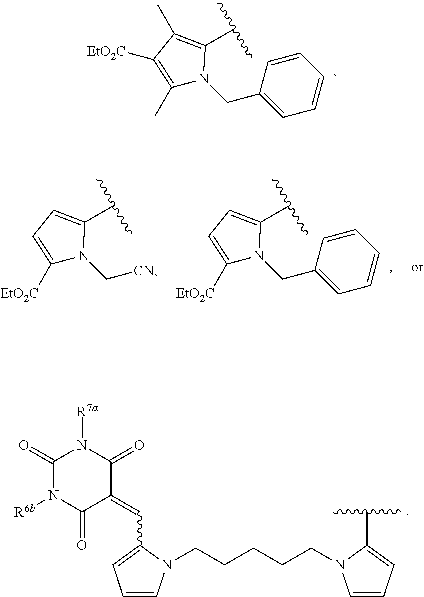

In another aspect, the minus-violet dye is a dye according to Formula III, wherein the minus-violet dye is a compound selected from the group consisting of:
5-((1H-pyrrol-2-yl)methylene)-1,3-dimethylpyrimidine-2,4,6(1H,3H,5H)-trione;
5-((1H-pyrrol-2-yl)methylene)-1,3-diphenylpyrimidine-2,4,6(1H,3H,5H)-trione;
5-((1H-pyrrol-2-yl)methylene)-1,3-dicyclohexylpyrimidine-2,4,6(1H,3H,5H)-trione;
5-((1H-pyrrol-2-yl)methylene)-1,3-bis(3-(tert-butyl)phenyl)pyrimidine-2,4,6(1H,3H,5H)-trione;
5-((1H-pyrrol-2-yl)methylene)-1-(3-methoxypropyl)-3-phenylpyrimidine-2,4,6(1H,3H,5H)-trione;
(E)-5-((1H-pyrrol-2-yl)methylene)-1-(3-methoxypropyl)-3-phenylpyrimidine-2,4,6(1H,3H,5H)-trione;
(Z)-5-((1H-pyrrol-2-yl)methylene)-1-(3-methoxypropyl)-3-phenylpyrimidine-2,4,6(1H,3H,5H)-trione;
5-((4-(tert-butyl)-1H-pyrrol-2-yl)methylene)-1,3-dimethylpyrimidine-2,4,6(1H,3H,5H)-trione;
5-((3,5-dimethyl-1H-pyrrol-2-yl)methylene)-1,3-dimethylpyrimidine-2,4,6(1H,3H,5H)-trione;
5-((3,5-dimethyl-1H-pyrrol-2-yl)methylene)-1,3-diphenylpyrimidine-2,4,6(1H,3H,5H)-trione;
1,3-dicyclohexyl-5-((3,5-dimethyl-1H-pyrrol-2-yl)methylene)pyrimidine-2,4,6(1H,3H,5H)-trione;
1,3-bis(3-(tert-butyl)phenyl)-5-((3,5-dimethyl-1H-pyrrol-2-yl)methylene)pyrimidine-2,4,6(1H,3H,5H)-trione;
1-cyclohexyl-5-((3,5-dimethyl-1H-pyrrol-2-yl)methylene)-3-phenylpyrimidine-2,4,6(1H,3H,5H)-trione;
(E)-1-cyclohexyl-5-((3,5-dimethyl-1H-pyrrol-2-yl)methylene)-3-phenylpyrimidine-2,4,6(1H,3H,5H)-trione;
(Z)-1-cyclohexyl-5-((3,5-dimethyl-1H-pyrrol-2-yl)methylene)-3-phenylpyrimidine-2,4,6(1H,3H,5H)-trione;
5-((3,5-dimethyl-1H-pyrrol-2-yl)methylene)-1-(3-methoxypropyl)-3-phenylpyrimidine-2,4,6(1H,3H,5H)-trione;
(E)-5-((3,5-dimethyl-1H-pyrrol-2-yl)methylene)-1-(3-methoxypropyl)-3-phenylpyrimidine-2,4,6(1H,3H,5H)-trione;
(Z)-5-((3,5-dimethyl-1H-pyrrol-2-yl)methylene)-1-(3-methoxypropyl)-3-phenylpyrimidine-2,4,6(1H,3H,5H)-trione;
5-((4-(tert-butyl)-3,5-dimethyl-1H-pyrrol-2-yl)methylene)-1,3-dimethylpyrimidine-2,4,6(1H,3H,5H)-trione;
ethyl 5-((1,3-dimethyl-2,4,6-trioxotetrahydropyrimidin-5(2H)-ylidene)methyl)-2,4-dimethyl-1H-pyrrole-3-carboxylate;
ethyl 2,4-dimethyl-5-((2,4,6-trioxo-1,3-diphenyltetrahydropyrimidin-5(2H)-ylidene)methyl)-1H-pyrrole-3-carboxylate;
ethyl 5-((1,3-dimethyl-2,4,6-trioxotetrahydropyrimidin-5(2H)-ylidene)methyl)-1H-pyrrole-2-carboxylate;
ethyl 5-((2,4,6-trioxo-1,3-diphenyltetrahydropyrimidin-5(2H)-ylidene)methyl)-1H-pyrrole-2-carboxylate;
1,3-dimethyl-5-((1-methyl-1H-pyrrol-2-yl)methylene)pyrimidine-2,4,6(1H,3H,5H)-trione;
5-((4-(tert-butyl)-1-methyl-1H-pyrrol-2-yl)methylene)-1,3-dimethylpyrimidine-2,4,6(1H,3H,5H)-trione;
5-((4-(tert-butyl)-1-butyl-1H-pyrrol-2-yl)methylene)-1,3-dimethylpyrimidine-2,4,6(1H,3H,5H)-trione;
ethyl 2-(4-(tert-butyl)-2-((1,3-dimethyl-2,4,6-trioxotetrahydropyrimidin-5(2H)-ylidene)methyl)-1H-pyrrol-1-yl)acetate;
2-(4-(tert-butyl)-2-((1,3-dimethyl-2,4,6-trioxotetrahydropyrimidin-5(2H)-ylidene)methyl)-1H-pyrrol-1-yl)acetonitrile;
5-((4-(tert-butyl)-1-(naphthalen-2-ylmethyl)-1H-pyrrol-2-yl)methylene)-1,3-dimethylpyrimidine-2,4,6(1H,3H,5H)-trione;
ethyl 1-(cyanomethyl)-5-((1,3-dimethyl-2,4,6-trioxotetrahydropyrimidin-5(2H)-ylidene)methyl)-2,4-dimethyl-1H-pyrrole-3-carboxylate;
ethyl 1-benzyl-5-((1,3-dimethyl-2,4,6-trioxotetrahydropyrimidin-5(2H)-ylidene)methyl)-2,4-dimethyl-1H-pyrrole-3-carboxylate;
ethyl 1-(cyanomethyl)-5-((1,3-dimethyl-2,4,6-trioxotetrahydropyrimidin-5(2H)-ylidene)methyl)-1H-pyrrole-2-carboxylate;
ethyl 1-(cyanomethyl)-5-((2,4,6-trioxo-1,3-diphenyltetrahydropyrimidin-5(2H)-ylidene)methyl)-1H-pyrrole-2-carboxylate;
ethyl 1-benzyl-5-((1,3-dimethyl-2,4,6-trioxotetrahydropyrimidin-5(2H)-ylidene)methyl)-1H-pyrrole-2-carboxylate;
5,5′-((pentane-1,5-diylbis(1H-pyrrole-1,2-diyl))bis(methaneylylidene))bis(1,3-dimethylpyrimidine-2,4,6(1H,3H,5H)-trione);
3,3′-(hexane-1,6-diyl)bis(5-((3,5-dimethyl-1H-pyrrol-2-yl)methylene)-1-(3-methoxypropyl)pyrimidine-2,4,6(1H,3H,5H)-trione);
(5E,5′E)-3,3′-(hexane-1,6-diyl)bis(5-((3,5-dimethyl-1H-pyrrol-2-yl)methylene)-1-(3-methoxypropyl)pyrimidine-2,4,6(1H,3H,5H)-trione);
(5E,5′Z)-3,3′-(hexane-1,6-diyl)bis(5-((3,5-dimethyl-1H-pyrrol-2-yl)methylene)-1-(3-methoxypropyl)pyrimidine-2,4,6(1H,3H,5H)-trione);
(5Z,5′Z)-3,3′-(hexane-1,6-diyl)bis(5-((3,5-dimethyl-1H-pyrrol-2-yl)methylene)-1-(3-methoxypropyl)pyrimidine-2,4,6(1H,3H,5H)-trione);
3,3′-(hexane-1,6-diyl)bis(1-(3-(tert-butyl)phenyl)-5-((3,5-dimethyl-1H-pyrrol-2-yl)methylene)pyrimidine-2,4,6(1H,3H,5H)-trione);
(5E,5′E)-3,3′-(hexane-1,6-diyl)bis(1-(3-(tert-butyl)phenyl)-5-((3,5-dimethyl-1H-pyrrol-2-yl)methylene)pyrimidine-2,4,6(1H,3H,5H)-trione);
(5E,5′Z)-3,3′-(hexane-1,6-diyl)bis(1-(3-(tert-butyl)phenyl)-5-((3,5-dimethyl-1H-pyrrol-2-yl)methylene)pyrimidine-2,4,6(1H,3H,5H)-trione); or
(5Z,5′Z)-3,3′-(hexane-1,6-diyl)bis(1-(3-(tert-butyl)phenyl)-5-((3,5-dimethyl-1H-pyrrol-2-yl)methylene)pyrimidine-2,4,6(1H,3H,5H)-trione).

In another aspect, the dyed article is in the form of a shield, a lens, a window, a lid, a cover, a case, a plaque, a sheet, a film, clothing, a panel, or a curtain.

In another aspect, the polymer resin is selected from the group consisting of an acrylic resin, a styrenic resin, a cellulosic resin, a polyamide resin, a polycarbonate resin, a polyester resin, and a polyurethane resin.

In another aspect, the polymer resin is crosslinked.

The disclosure also provides a process of preparing the dyed articles disclosed herein, comprising coating, casting, extruding, or molding the polymer resin, the first dye, and the minus-violet dye.

In another aspect, the process comprises mixing the polymer resin, the first dye, and the minus-violet dye for about 30 minutes to about 90 minutes.

In another aspect, the process comprises mixing the polymer resin, the first dye, and the minus-violet dye with a radical initiator.

In another aspect, the process comprises heating the polymer resin, the first dye, and the minus-violet dye to a temperature of from about 60° C. to about 300° C.

Additional aspects and advantages of the disclosure will be set forth, in part, in the description that follows, and will flow from the description, or can be learned by practice of the disclosure.

It is to be understood that both the foregoing summary and the following detailed description are exemplary and explanatory only, and do not restrict the scope of the claims.

### BRIEF DESCRIPTION OF THE DRAWINGS

FIG. 1 illustrates a perspective view of a dyed article, for example a lens, configured to provide protection from harmful light, for example laser radiation, according to some aspects.

FIG. 1A illustrates an aspect of a lens that can be included in the eyewear depicted in FIG. 1.

FIG. 1B illustrates another aspect of a lens that can be included in the eyewear depicted in FIG. 1, the lens comprising an optical filter including a variable filter component and a static filter component.

FIG. 2 depicts the internal spectral transmission of bis(4-di(n-butyl)amino-2-methylphenyl)(4-di(n-butyl)aminophenyl)amminium tetrakis(pentafluorophenyl)borate in an injection molded acrylic.

FIG. 3 depicts the calculated transmission of an infrared dye (bis(4-di(n-butyl)amino-2-methylphenyl)(4-di(n-butyl)aminophenyl)amminium tetrakis(pentafluorophenyl)borate), a minus-violet dye (Compound 7), and a combination of the infrared dye and the minus-violet dye.

### DETAILED DESCRIPTION

The headings provided herein are not limitations of the various aspects of the disclosure, which can be defined by reference to the specification as a whole. It is also to be understood that the terminology used herein is for the purpose of describing particular aspects only, and is not intended to be limiting, since the scope of the present disclosure will be limited only by the appended claims.

The present disclosure generally relates to dyed articles comprising a polymer resin, a first dye that provides peak infrared absorption in the range of between about 900 and nm 1100 nm in the resin, and a minus-violet dye. The present disclosure further provides minus-violet dyes, methods of making the minus-violet dyes, and methods of making articles comprising the first dye and the minus-violet dye.

### Definitions

For convenience, the meaning of some terms and phrases used in the specification, examples, and appended claims are provided below. Unless stated otherwise, or implicit from context, the following terms and phrases include the meanings provided below. The definitions are provided to aid in describing particular aspects, and are not intended to limit the claimed technology, because the scope of the technology is limited only by the claims. Unless otherwise defined, all technical and scientific terms used herein have the same meaning as commonly understood by one of ordinary skill in the art to which this technology belongs. If there is an apparent discrepancy between the usage of a term in the art and its definition provided herein, the definition provided within the specification will control.

The articles “a,” “an,” and “the” are used herein to refer to one or to more than one (i.e., to at least one) of the grammatical object of the article. By way of example, “an element” means one element or more than one element. As used herein, the use of “or” means “and/or” unless expressly stated or understood by one skilled in the art. In the context of a multiple dependent claim, the use of “or” refers back to more than one preceding independent or dependent claim.

As used herein, the term “about” means within an acceptable error range for the particular value as determined by one of ordinary skill in the art, which depends in part on how the value is measured or determined, i.e., the limitations of the measurement system. For example, “about” can mean a range of up to 10% (e.g., up to 5%, or up to 1%) of a given value.

The term “article” as used herein refers to a piece of transparent material (such as glass, polycarbonate, polyurethane, resin, etc.), for example, cast, extruded, or molded polymer shapes, including shapes with varying geometry. The term can refer to products that are used for eye, face, and general protection including but not limited to a shield, a lens, a window, a lid, a cover, a case, a plaque, a sheet, a film, clothing, a panel, and a curtain. In some aspects, the article can be incorporated into eyewear. Eyewear can include but is not limited to general-purpose eyewear, protective eyewear, special-purpose eyewear, sunglasses, shields, face-shields (including eye-shields), eyewear incorporated into a head worn support (such as visors for helmets), visors, driving glasses, sporting glasses, goggles, vision-correcting eyewear, prescription and non-prescription eyeglasses, color vision deficiency eyewear, indoor eyewear, outdoor eyewear, contrast-enhancing eyewear, chroma-enhancing eyewear, color-enhancing eyewear, color-altering eyewear, gaming eyewear, eyewear designed for another purpose, or eyewear designed for a combination of purposes.

The term “dyed” as used herein indicates that an object, e.g., an article, comprises one or more compounds that absorb ultraviolet, visible, and/or infrared light, e.g., a dye. In some aspects a dyed article comprises at least two dyes as described herein.

The term “minus-violet dye” denotes a dye compound that selectively or predominantly absorbs blue and/or violet light, e.g., light having a wavelength of from about 400 nm to about 500 nm. Exemplary minus-violet dyes include, but are not limited to, compounds of Formula II and Formula III.

The term “alkyl,” used either alone or in compound words such as “haloalkyl” or “cyanoalkyl” includes straight-chain and branched alkyl, examples of which include C₁-C₁₂ alkyls and C₁-C₆ alkyls, such as, methyl, ethyl, n-propyl, i-propyl, and the different butyl, pentyl and hexyl isomers. In some aspects the alkyl group can be optionally substituted.

The term “alkylene” denotes a straight-chain or branched alkanediyl. Examples of “alkylene” include —CH₂—, —CH₂CH₂—, —CH(CH₃)—, —CH₂CH₂CH₂—, —CH₂CH(CH₃)—, the different butylene isomers, the different pentylene isomers, and the different hexylene isomers. In some aspects the alkylene group can be optionally substituted. In some aspects, the alkylene group is straight-chain hexylene, i.e., —CH₂CH₂CH₂CH₂CH₂CH₂—.

The term “cycloalkyl” denotes a C₃₋₁₂ cycloalkyl or, in certain aspects, a C₃₋₆ cycloalkyl, for example, cyclopropyl, cyclobutyl, cyclopentyl and cyclohexyl.

The term “aryl” denotes an aromatic ring system having six to ten carbon atoms, i.e., C₆-C₁₀ aryl. Non-limiting exemplary aryl groups include phenyl, naphthyl, indenyl, and azulenyl groups. In some aspects the aryl group can be optionally substituted. The term “arylene” as used herein refers to a diradical derived from an aromatic ring system by removal of two hydrogen atoms. In some aspects the aryl group is phenyl. The term “phenyl” as used herein refers to the radical —C₆H₅, derived from benzene by removal of a hydrogen atom. Phenyl may also be abbreviated as “Ph.” The term “phenylene” as used herein refers to the radical —C₆H₄—, derived from benzene by removal of two hydrogen atoms.

The term “heterocycle” denotes a ring wherein at least one of the atoms forming the ring backbone is other than carbon. Unless otherwise indicated, a heterocyclic ring can be a saturated, partially unsaturated, or fully unsaturated ring. When a fully unsaturated heterocyclic ring satisfies Hückel's rule, then said ring is also called a “heteroaryl” or aromatic heterocyclic ring. “Saturated heterocyclic ring” refers to a heterocyclic ring containing only single bonds between ring members. In some aspects the heterocycle or heteroaryl group can be optionally substituted.

The term “cyano” as used herein by itself, as part of another group, or in compound words such as “cyanoalkyl,” refers to the group —CN. When used in words such as “cyanoalkyl,” or when used in descriptions such as “alkyl substituted with cyano,” said alkyl can be substituted with one, two, or three —CN groups. Examples of “cyanoalkyl” groups include cyanomethyl, e.g., —CH₂CN, 2-cyanoethyl, e.g., —CH₂CH₂CN, 3-cyanopropyl, e.g., —CH₂CH₂CH₂CN, and 4-cyanobutyl, e.g., —CH₂CH₂CH₂CH₂CN.

The term “halo” either alone or in compound words such as “haloalkyl,” or when used in descriptions such as “alkyl substituted with halo” includes fluorine, chlorine, bromine or iodine (—Cl, —F, —Br, or —I). Further, when used in compound words such as “haloalkyl,” or when used in descriptions such as “alkyl substituted with halo” said alkyl can be partially or fully substituted with halo atoms which can be the same or different. Examples of “haloalkyl” or “alkyl substituted with halo” include —CF₃, —CHF₂, —CH₂Cl, —CF₂Cl, —CFCl₂, —CCl₃, —CF₃CH₂, —CF₃CCl₂, —CH₂CH₂CF₃, —CH₂CH₂CHF₂, —CH₂CF₃, and —CH₂CHF₂.

The term “hydroxyl” either alone or in compound words such as “hydroxyalkyl,” or when used in descriptions such as “alkyl substituted with hydroxyl” refers to the group —OH. When used in words such as “hydroxyalkyl,” said alkyl can be substituted with one, two, or three —OH groups.

The term “alkoxy” denotes a group having the formula —OR′ wherein R′ is, in some aspects, C₁₋₆ alkyl, for example, methoxy, ethoxy, n-propyloxy, i-propyloxy, and the different butoxy, pentoxy and hexyloxy isomers.

The term “phenoxy” denotes a group having the formula —OPh. In some aspects the Ph is optionally substituted.

The term “alkylthio” denotes a group having the formula —SR^{X} wherein R^{X} is, in some aspects, C₁-C₆ alkyl, for example, —SCH₃, —SCH₂CH₃, and —SCH₂CHₑCH₃.

The phrase “optionally substituted” means that the number of substituents can be zero. Unless otherwise indicated, optionally substituted groups can be substituted with as many optional substituents as can be accommodated by replacing a hydrogen atom with a non-hydrogen substituent on any available carbon or nitrogen atom. Commonly, the number of optional substituents (when present) ranges from 1 to 3.

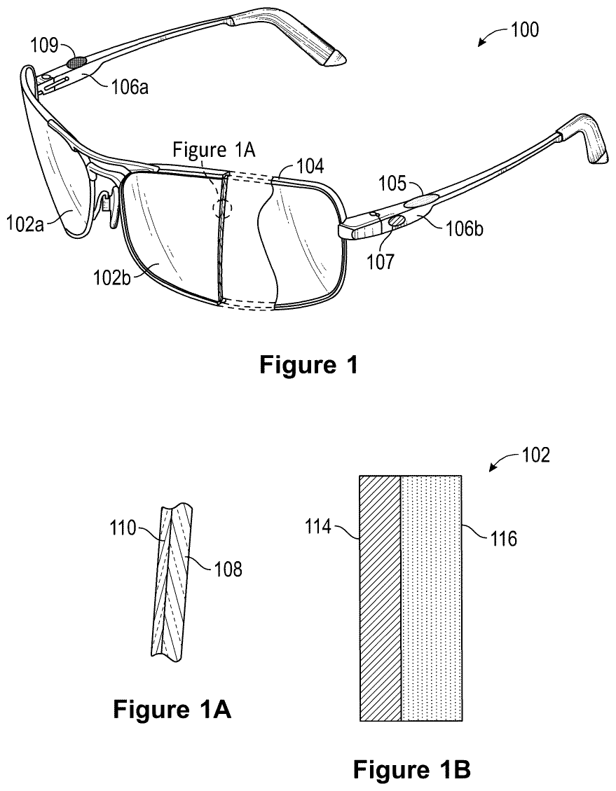

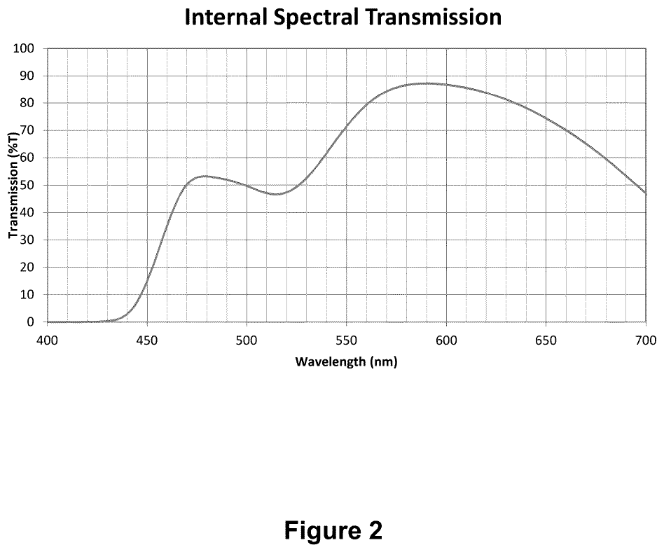

The term “lens” as used herein refers to a piece of transparent material (such as glass, polycarbonate, polyurethane, resin, etc.) that has two opposite regular surfaces either both curved or one curved and the other planar and that is used either singly or combined to form an image. In some aspects, the lens can be a focusing lens. In some aspects, the lens can be a non-focusing lens. The term can refer to lenses used in eyewear including but not limited to general-purpose eyewear, protective eyewear, special-purpose eyewear, sunglasses, eyeshields, eyewear incorporated into head worn support (such as visors for helmets), visors, driving glasses, sporting glasses, goggles, vision-correcting eyewear, prescription and non-prescription eyeglasses, color vision deficiency eyewear, indoor eyewear, outdoor eyewear, contrast-enhancing eyewear, chroma-enhancing eyewear, color-enhancing eyewear, color-altering eyewear, gaming eyewear, eyewear designed for another purpose, or eyewear designed for a combination of purposes. The eyewear can be provided with a unitary lens that is placed in front of both eyes or dual lenses (see, e.g., FIG. 1) with one lens placed in front of each eye when the eyewear is worn.

The phrase “disposed on” means that a first component (e.g., layer) is in direct contact with a second component. A first component “disposed on” a second component can be deposited, formed, placed, or otherwise applied directly onto the second component. In other words, if a first component is disposed on a second component, there are no components between the first component and the second component.

### Articles

The present disclosure provides dyed articles comprising an infrared-absorbing dye, e.g., an amminium dye, and a minus-violet dye. Surprisingly, the light stability of infrared-absorbing amminium dyes can be improved by adding one or more minus-violet dyes. Without wishing to be bound by a particular theory, it is believed that the minus-violet dyes have essentially no impact on visible light transmission, yet extend fade resistance of the infrared dyes from high energy violet blue light. By combining one or more infrared-absorbing amminium dyes with one or more minus-violet dyes, loss of transmission, e.g., loss due to fading, can be reduced from that of the infrared dye alone.

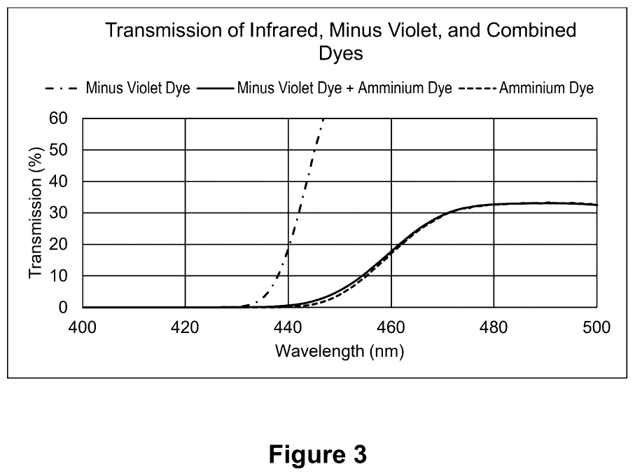

FIG. 3 shows the transmission of Compound 7 at about 8 OD (peak near 409 nm), the transmission of bis(4-di(n-butyl)amino-2-methylphenyl)(4-di(n-butyl)aminophenyl)amminium tetrakis(pentafluorophenyl)borate at about 6 OD (from 990 nm to 1100 nm), and the transmission of the combined dyes. The loss of transmission from the combination of dyes at these optical densities peaks at <1.5% near 450 nm.

In some aspects, the dyed article comprises a polymer resin and
a) a first dye that provides peak infrared absorption in the range of between about 900 and nm 1100 nm in the resin, and
b) a minus-violet dye.

In some aspects, the first dye is a dye according to Formula I:

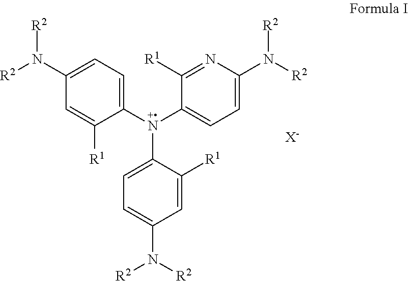

wherein each R¹ is independently at each occurrence H or C₁-C₄ alkyl;
each R² is independently at each occurrence selected from the group consisting of C₁-C₆ alkyl, C₁-C₆ haloalkyl, and C₁-C₆ cyanoalkyl; and
X⁻ is an anion.

In some aspects, the first dye is a dye according to Formula I, wherein each R¹ is H.

In some aspects, the first dye is

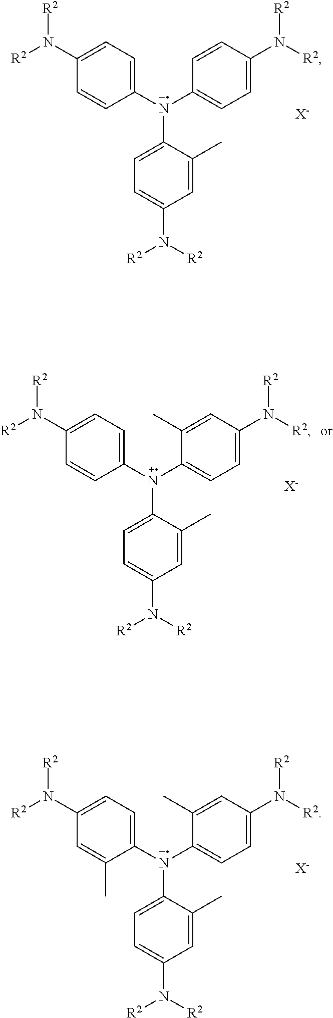

In some aspects, the first dye is a dye according to Formula I, wherein R² at each occurrence is n-butyl.

The anion may be any monovalent anion, i.e., a compound having a charge of −1. In some aspects, the anion can be a coordinating anion. In some aspects, the anion can be a weakly coordinating anion. Weakly coordinating anions are discussed, e.g., in Riddlestone, I. M., et al, “Taming the Cationic Beast: Novel Developments in the Synthesis and Application of Weaking Coordinating Anions,” Angew. Chem., Int. Ed. 57:13982-14024 (2018), which is incorporated by reference herein in its entirety. In some aspects, the anion can be a noncoordinating anion.

Applicant surprisingly discovered that amminium dyes comprising a weakly coordinating anion or a noncoordinating anion are more compatible with curing the polymer resin, e.g., via a free radical polymerization process, relative to amminium dyes having coordinating anions. The greater compatibility is evident from increased retention of optical density after polymerization, with retention calculated on the basis of expected optical density of the cured article based on dye concentrations in liquid solutions. The greater compatibility is also evident from increased retention of visible light transmission after polymerization, again with retention calculated on the basis of approximate expected visible light transmission based on dye concentrations in liquid solutions.

In some aspects, the anion is a carboxylate. Non-limiting examples of carboxylates include CH₃CO₂⁻ and CF₃CO₂⁻.

In some aspects, the anion is a sulfonate. In some aspects, the sulfonate may have the formula [X^{a}SO₃]⁻, wherein X^{a} can be halo, C₁-C₄ alkyl, C₁-C₄ haloalkyl, or phenyl optionally substituted with one to five groups selected from halo, C₁-C₄ alkyl, and C₁-C₄ haloalkyl. In some aspects, the sulfonate can be [CH₃SO₃]⁻, [C₆H₅SO₃]⁻, [4-CH₃-C₆H₄SO₃]⁻, or [CF₃SO₃]⁻.

In some aspects, the anion is a bis(alkylsulfonyl)amide. In some aspects, the bis(alkylsulfonyl)amide may have the formula [N(SO₂X^{b})₂]⁻, wherein each X^{b} can, independently, be halo, C₁-C₄ alkyl, C₁-C₄ haloalkyl, or phenyl optionally substituted with one to five groups selected from halo, C₁-C₄ alkyl, and C₁-C₄ haloalkyl. In some aspects, the bis(alkylsulfonyl)amide may be [N(SO₂CF₃)₂]⁻.

In some aspects, the anion is a borate. In some aspects, the borate may have the formula [BX^{c}₄]⁻, wherein X° may be halo, C₁-C₄ alkyl, C₁-C₄ haloalkyl, or phenyl optionally substituted with one to five groups selected from halo and C₁-C₄ haloalkyl. In some aspects, the borate may be [BF₄]⁻, [B(C₆F₅)₄]⁻, or [B(3,5-(CF₃)₂C₆H₃)₄]⁻.

In some aspects, the first dye is a dye according to Formula I, wherein the first dye is a compound selected from the group consisting of:
tris(4-di(n-butyl)amino-2-methylphenyl)amminium tetrafluoroborate;
bis(4-di(n-butyl)amino-2-methylphenyl)(4-di(n-butyl)amino-phenyl)amminium tetrafluoroborate;
bis(4-di(n-butyl)amino-phenyl)(4-di(n-butyl)amino-2-methylphenyl)amminium tetrafluoroborate;
tris(4-di(n-butyl)aminophenyl)amminium tetrakis(pentafluorophenyl)borate tetrafluoroborate;
tris(4-di(n-butyl)amino-2-methylphenyl)amminium perchlorate;
bis(4-di(n-butyl)amino-2-methylphenyl)(4-di(n-butyl)amino-phenyl)amminium perchlorate;
bis(4-di(n-butyl)amino-phenyl)(4-di(n-butyl)amino-2-methylphenyl)amminium perchlorate;
tris(4-di(n-butyl)aminophenyl)amminium perchlorate;
bis(4-di(n-butyl)amino-2-methylphenyl)(4-di(n-butyl)aminophenyl)amminium tetrakis(pentafluorophenyl)borate;
tris(4-di(n-butyl)amino-2-methylphenyl)amminium tetrakis(pentafluorophenyl)borate;
bis(4-di(n-butyl)amino-phenyl)(4-di(n-butyl)amino-2-methylphenyl)amminium tetrakis(pentafluorophenyl)borate;
tris(4-di(n-butyl)aminophenyl)amminium tetrakis(pentafluorophenyl)borate;
tris(4-di(n-butyl)amino-2-methylphenyl)amminium methanesulfonate;
bis(4-di(n-butyl)amino-2-methylphenyl)(4-di(n-butyl)amino-phenyl)amminium methanesulfonate;
bis(4-di(n-butyl)amino-phenyl)(4-di(n-butyl)amino-2-methylphenyl)amminium methanesulfonate;
tris(4-di(n-butyl)aminophenyl)amminium methanesulfonate;
tris(4-di(3-cyanopropyl)amino-2-methylphenyl)amminium tetrafluoroborate;
bis(4-di(3-cyanopropyl))amino-2-methylphenyl)(4-di(3-cyanopropyl)amino-phenyl)amminium tetrafluoroborate;
bis(4-di(3-cyanopropyl)amino-phenyl)(4-di(3-cyanopropyl)amino-2-methylphenyl)amminium tetrafluoroborate;
tris(4-di(3-cyanopropyl)aminophenyl)amminium tetrafluoroborate;
tris(4-di(3-cyanopropyl)amino-2-methylphenyl)amminium tetrakis(pentafluorophenyl)borate;
bis(4-di(3-cyanopropyl))amino-2-methylphenyl)(4-di(3-cyanopropyl)amino-phenyl)amminium tetrakis(pentafluorophenyl)borate;
bis(4-di(3-cyanopropyl)amino-phenyl)(4-di(3-cyanopropyl)amino-2-methylphenyl)amminium tetrakis(pentafluorophenyl)borate; and
tris(4-di(3-cyanopropyl)aminophenyl)amminium tetrakis(pentafluorophenyl)borate.

In some aspects, the minus-violet dye is a dye according to Formula II:

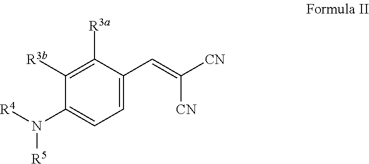

In certain aspects, R^{3a} and R^{3b} can each, independently, be H, C₁-C₄ alkyl, C₁-C₄ alkoxy, phenoxy, C₁-C₄ alkylthio, hydroxyl, or halo;
R⁴ and R⁵ can each, independently, be C₁-C₆ alkyl, C₁-C₆ haloalkyl, C₁-C₆ cyanoalkyl, C₆-C₁₀ aryl, C₁-C₆ alkylene-C(═O)OR^{4a}, C₁-C₆ alkylene-C(═O)R^{4a}, or C₁-C₆ alkylene-OC(═O)NR^{4a}R^{4b}; or
R⁴ and R⁵ can be taken together with the nitrogen atom to which they are attached to form an optionally substituted 4- to 7-membered heterocycle; R^{4a} can, independently at each occurrence, be C₁-C₆ alkyl or C₆-C₁₀ aryl; and
R^{4b} can, independently at each occurrence, be H or C₁-C₄ alkyl.

In another aspect, R^{3a} can be H, methyl, methoxy, ethyoxy, phenoxy, hydroxyl, fluoro, chloro, or bromo;
R^{3b} can be H; and
R⁴ and R⁵ can each, independently, be methyl, ethyl, n-butyl, phenyl, 3-cyanopropyl, —CH₂C(═O)OCH₂CH₃, —CH₂CH₂C(═O)CH₃ or —CH₂CH₂OC(═O)NH(C₆-C₁₀ aryl); or
R⁴ and R⁵ can be taken together with the nitrogen atom to which they are attached to form a pyrrolidinyl group.

In some aspects, R^{3a} can be H;
R^{3b} can be H; and
R⁴ and R⁵ can each, independently, be methyl, ethyl, or —CH₂C(═O)OCH₂CH₃; or
R⁴ and R⁵ can be taken together with the nitrogen atom to which they are attached to form a pyrrolidinyl group.

In some aspects, R^{3a} can be methyl;
R^{3b} can be H; and
R⁴ and R⁵ can each be methyl; or
R⁴ can be ethyl and R⁵ can be —CH₂CH₂OC(═O)NHPh.

In some aspects, R^{3a} can be methoxy;
R^{3b} can be H; and
R⁴ and R⁵ can each, independently, be 3-cyanopropyl or —CH₂C(═O)OCH₂CH₃.

In some aspects, R^{3a} can be ethoxy;
R^{3b} can be H; and
R⁴ and R⁵ can each be ethyl.

In some aspects, R^{3a} can be phenoxy;
R^{3b} can be H; and
R⁴ and R⁵ can each be ethyl.

In some aspects, R^{3a} can be fluoro;
R^{3b} can be H; and
R⁴ and R⁵ can each be —CH₂C(═O)OCH₂CH₃.

In certain aspects, the minus-violet dye of Formula II can be a compound as set forth in Table 1, below.

TABLE 1
Representative Compounds of Formula II

| Cmpd | | |
|---|---|---|
| No. | Cmpd Name | Structure |
| 1 | 2-(4- (dimethylamino)benzylidene) malononitrile | 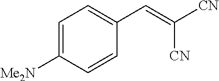 [SMILES: CN(C)c1ccc(C=C(C#N)C#N)cc1] |
| 2 | 2-(4- (diethylamino)benzylidene) malononitrile | 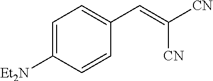 |
| 3 | 2-(4-(pyrrolidin-1- yl)benzylidene)malononitrile | 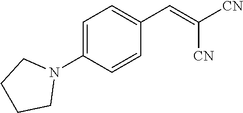 [SMILES: N#CC(C#N)=Cc1ccc(N2CCCC2)cc1] |
| 4 | 2-(4-(dimethylamino)-2- methylbenzylidene)malononitrile | 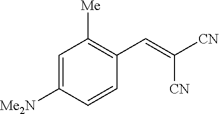 [SMILES: Cc1cc(N(C)C)ccc1C=C(C#N)C#N] |
| 5 | 2-(4-(diethylamino)-2- ethoxybenzylidene)malononitrile | 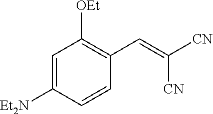 |
| 6 | 2-(4-(diethylamino)-2- phenoxybenzylidene)malononitrile | 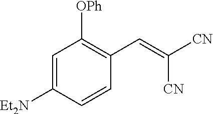 |
| 7 | diethyl 2,2′-((4-(2,2- dicyanovinyl)phenyl)azanediyl)diacetate | 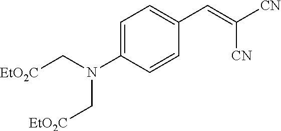 [SMILES: CCOC(=O)CN(CC(=O)OCC)c1ccc(C=C(C#N)C#N)cc1] |
| 8 | diethyl 2,2′-((4-(2,2-dicyanovinyl)-3- methoxyphenyl)azanediyl)diacetate | 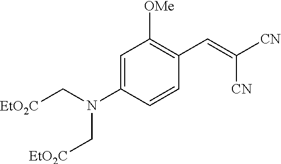 [SMILES: CCOC(=O)CN(CC(=O)OCC)c1ccc(C=C(C#N)C#N)c(OC)c1] |
| 9 | diethyl 2,2′-((4-(2,2-dicyanovinyl)-3- fluorophenyl)azanediyl)diacetate | 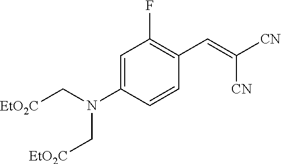 [SMILES: CCOC(=O)CN(CC(=O)OCC)c1ccc(C=C(C#N)C#N)c(F)c1] |
| 10 | 2-(4-(bis(3-cyanopropyl)amino)-2- methoxybenzylidene)malononitrile | 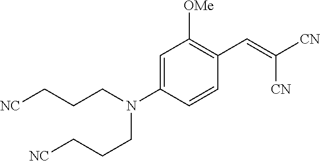 [SMILES: COc1cc(N(CCCC#N)CCCC#N)ccc1C=C(C#N)C#N] |
| 11 | 2-((4-(2,2-dicyanovinyl)-3- methylphenyl)(ethyl)amino)ethyl phenylcarbamate | 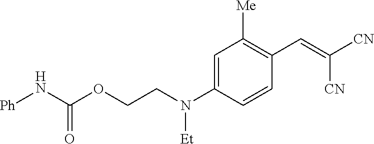 [SMILES: CCN(CCOC(=O)Nc1ccccc1)c1ccc(C=C(C#N)C#N)c(C)c1] |

In some aspects, the minus-violet dye is a dye according to Formula III:

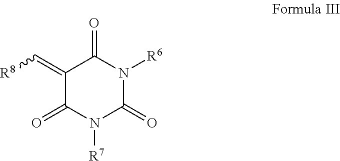

In some aspects, R⁶ can be H, C₁-C₆ alkyl, —(CH₂)ₙO(CH₂)ₘCH₃, C₃-C₁₂ cycloalkyl, C₆-C₁₀ aryl, or C₆-C₁₀ arylene-C₁-C₄ alkyl;
R⁷ can be H, C₁-C₆ alkyl, —(CH₂)ₙO(CH₂)ₘCH₃, C₃-C₁₂ cycloalkyl, C₆-C₁₀ aryl, C₆-C₁₀ arylene-C₁-C₄ alkyl, or C₁-C₁₂ alkylene-R¹²;
n at each occurrence can, independently, be an integer from 1 to 6;
m at each occurrence can, independently, be an integer from 0 to 3;
R⁸ can be

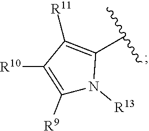

R⁹, R¹⁰, and R¹¹ can each, independently, be C₁-C₆ alkyl, C₃-C₁₂ cycloalkyl, C₆-C₁₀ aryl, or C₆-C₁₀ arylene-C₁-C₄ alkyl;
R¹³ can be H, C₁-C₆ alkyl, C₁-C₆ haloalkyl, C₁-C₆ cyanoalkyl, C₁-C₆ alkylene-C₆-C₁₀ aryl, C₁-C₆ alkylene-OC(═O)R¹⁴, or C₁-C₁₂ alkylene-R¹⁵;
R¹² can be

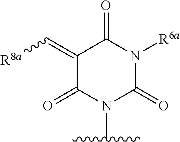

provided that when R⁷ is C₁-C₁₂ alkylene-R¹², R^{8a} is identical to R⁸ and R^{6a} is identical to R⁶;
R¹⁴ can be C₁-C₆ alkyl; and
R¹⁵ can be

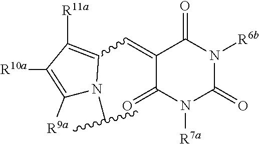

provided that when R¹³ is C₁-C₁₂ alkylene-R¹⁵, R^{9a} is identical to R⁹, R^{10a} is identical to R¹⁰, R^{11a} is identical to R¹¹, R^{6b} is identical to R⁶, and R^{7a} is identical to R⁷.

In some aspects, R⁶ can be methyl, 3-methoxypropyl, cyclohexyl, phenyl, or 3-tert-butylphenyl;
R⁷ can be methyl, 3-methoxypropyl, cyclohexyl, phenyl, 3-tert-butylphenyl, or hexylene-R¹²;
R⁹ can be H, methyl, tert-butyl, or —CH₂C(═O)OCH₂CH₃;
R¹⁰ can be H, tert-butyl, or —CH₂C(═O)OCH₂CH₃;
R¹¹ can be H or methyl; and
R¹³ can be H, methyl, n-butyl, cyanomethyl, —CH₂C(═O)OCH₂CH₃, benzyl, 2-napthalenylmethyl, or hexylene-R¹.

In some aspects, R⁶ and R⁷ can each be methyl, cyclohexyl, phenyl, or 3-tert-butylphenyl.

In some aspects, R⁶ can be 3-methoxypropyl and R⁷ can be phenyl.

In some aspects, R⁶ can be cyclohexyl and R⁷ can be phenyl.

In some aspects, R⁶ can be 3-methoxypropyl or 3-tert-butylphenyl and R⁷ can be hexylene-R¹².

In some aspects, R⁸ can be:

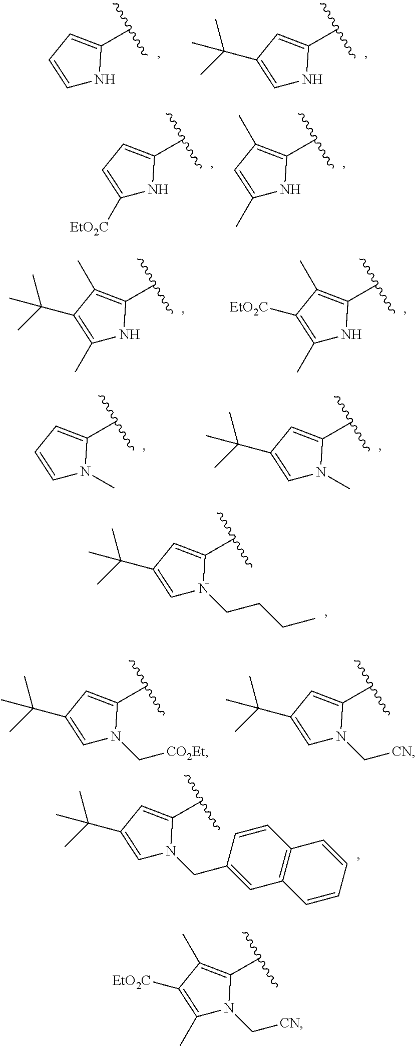

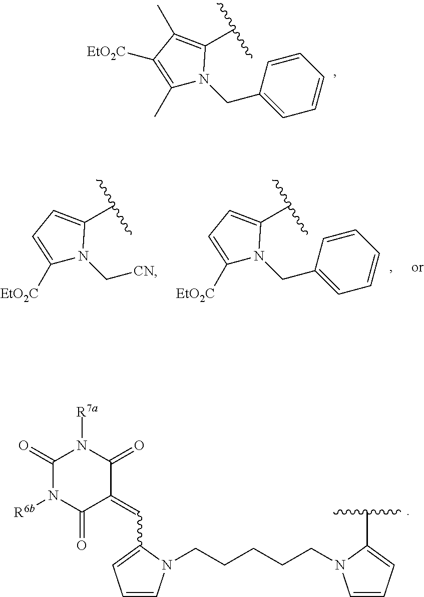

In certain aspects, the dye of Formula III can be a compound as set forth in Table 2a and Table 2b, below.

TABLE 2a
Representative Compounds of Formula III

| Cmpd | | | |
|---|---|---|---|
| No. | Cmpd Name | Structure (Isomer A) | Structure (Isomer B) |
| 12 | 5-((1H-pyrrol-2- yl)methylene)-1,3- dimethylpyrimidine- 2,4,6(1H,3H,5H)- trione | 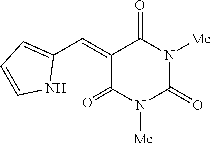 [SMILES: CN1C(=O)C(=Cc2ccc[nH]2)C(=O)N(C)C1=O] | N/A |
| 13 | 5-((1H-pyrrol-2- yl)methylene)-1,3- diphenylpyrimidine- 2,4,6(1H,3H,5H)- trione | 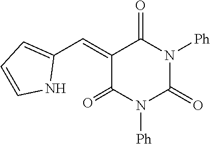 [SMILES: O=C1C(=Cc2ccc[nH]2)C(=O)N(c2ccccc2)C(=O)N1c1ccccc1] | N/A |
| 14 | 5-((1H-pyrrol-2- yl)methylene)-1,3- dicyclohexylpyrimidine- 2,4,6(1H,3H,5H)- trione | 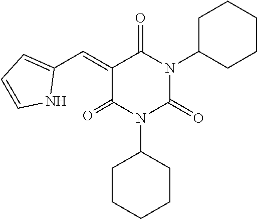 [SMILES: O=C1C(=Cc2ccc[nH]2)C(=O)N(C2CCCCC2)C(=O)N1C1CCCCC1] | N/A |
| 15 | 5-((1H-pyrrol-2- yl)methylene)-1,3- bis(3-(tert- butyl)phenyl)pyrimidine- 2,4,6(1H,3H,5H)- trione | 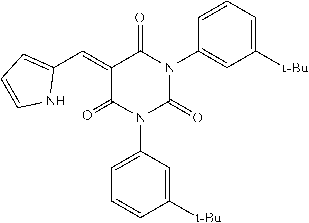 [SMILES: CC(C)(C)c1cccc(N2C(=O)C(=Cc3ccc[nH]3)C(=O)N(c3cccc(C(C)(C)C)c3)C2=O)c1] | N/A |
| 16 | 5-((1H-pyrrol-2- yl)methylene)-1-(3- methoxypropyl)-3- phenylpyrimidine- 2,4,6(1H,3H,5H)- trione | 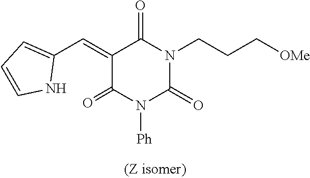 [SMILES: COCCCN1C(=O)/C(=C/c2ccc[nH]2)C(=O)N(c2ccccc2)C1=O] | 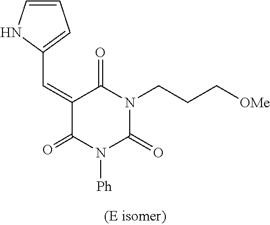 [SMILES: COCCCN1C(=O)/C(=C\c2ccc[nH]2)C(=O)N(c2ccccc2)C1=O] |
| 17 | 5-((4-(tert-butyl)- 1H-pyrrol-2- yl)methylene)-1,3- dimethylpyrimidine- 2,4,6(1H,3H,5H)- trione | 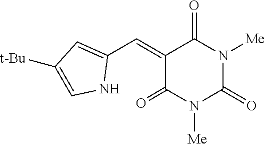 [SMILES: CN1C(=O)C(=Cc2cc(C(C)(C)C)c[nH]2)C(=O)N(C)C1=O] | N/A |
| 18 | 5-((3,5-dimethyl- 1H-pyrrol-2- yl)methylene)-1,3- dimethylpyrimidine- 2,4,6(1H,3H,5H)- trione | 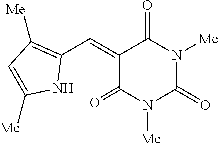 [SMILES: Cc1cc(C)c(C=C2C(=O)N(C)C(=O)N(C)C2=O)[nH]1] | N/A |
| 19 | 5-((3,5-dimethyl- 1H-pyrrol-2- yl)methylene)-1,3- diphenylpyrimidine- 2,4,6(1H,3H,5H)- trione | 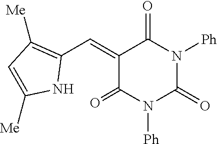 [SMILES: Cc1cc(C)c(C=C2C(=O)N(c3ccccc3)C(=O)N(c3ccccc3)C2=O)[nH]1] | N/A |
| 20 | 1,3-dicyclohexy1-5- ((3,5-dimethyl-1H- pyrrol-2- yl)methylene)pyrimidine- 2,4,6(1H,3H,5H)- trione | 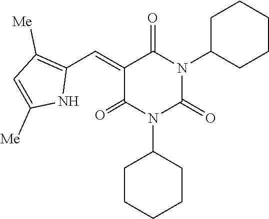 [SMILES: Cc1cc(C)c(C=C2C(=O)N(C3CCCCC3)C(=O)N(C3CCCCC3)C2=O)[nH]1] | N/A |
| 21 | 1,3-bis(3-(tert- butyl)phenyl)-5- ((3,5-dimethyl-1H- pyrrol-2- yl)methylene)pyrimidine- 2,4,6(1H,3H,5H)- trione | 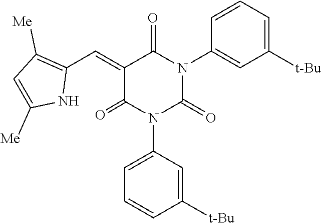 [SMILES: Cc1cc(C)c(C=C2C(=O)N(c3cccc(C(C)(C)C)c3)C(=O)N(c3cccc(C(C)(C)C)c3)C2=O)[nH]1] | N/A |
| 22 | 1-cyclohexyl-5- ((3,5-dimethyl-1H- pyrrol-2- yl)methylene)-3- phenylpyrimidine- 2,4,6(1H,3H,5H)- trione | 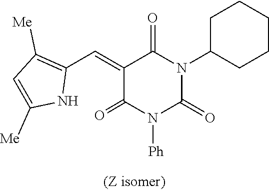 [SMILES: Cc1cc(C)c(/C=C2\C(=O)N(c3ccccc3)C(=O)N(C3CCCCC3)C2=O)[nH]1] | 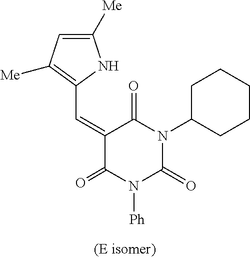 [SMILES: Cc1cc(C)c(/C=C2/C(=O)N(c3ccccc3)C(=O)N(C3CCCCC3)C2=O)[nH]1] |
| 23 | 5-((3,5-dimethyl- 1H-pyrrol-2- yl)methylene)-1-(3- methoxypropyl)-3- phenylpyrimidine- 2,4,6(1H,3H,5H)- trione | 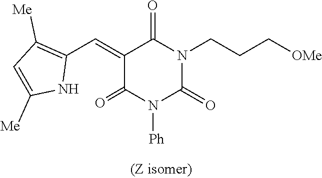 [SMILES: COCCCN1C(=O)/C(=C/c2[nH]c(C)cc2C)C(=O)N(c2ccccc2)C1=O] | 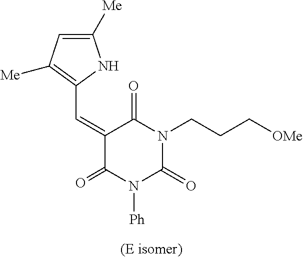 [SMILES: COCCCN1C(=O)/C(=C\c2[nH]c(C)cc2C)C(=O)N(c2ccccc2)C1=O] |
| 24 | 5-((4-(tert-butyl)- 3,5-dimethyl-1H- pyrrol-2- yl)methylene)-1,3- dimethylpyrimidine- 2,4,6(1H,3H,5H)- trione | 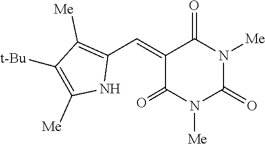 [SMILES: Cc1[nH]c(C=C2C(=O)N(C)C(=O)N(C)C2=O)c(C)c1C(C)(C)C] | N/A |
| 25 | ethyl 5-((1,3- dimethyl-2,4,6- trioxotetrahydropyrimidin- 5(2H)- ylidene)methyl)-2,4- dimethy1-1H- pyrrole-3- carboxylate | 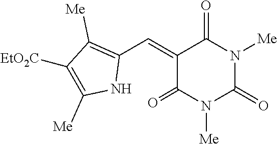 [SMILES: CCOC(=O)c1c(C)[nH]c(C=C2C(=O)N(C)C(=O)N(C)C2=O)c1C] | N/A |
| 26 | ethyl 2,4-dimethyl- 5-((2,4,6-trioxo-1,3- diphenyltetra- hydropyrimidin- 5(2H)- ylidene)methyl)-1H- pyrrole-3- carboxylate | 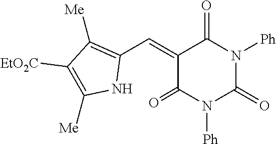 [SMILES: CCOC(=O)c1c(C)[nH]c(C=C2C(=O)N(c3ccccc3)C(=O)N(c3ccccc3)C2=O)c1C] | N/A |
| 27 | ethyl 5-((1,3- dimethyl-2,4,6- trioxotetra- hydropyrimidin- 5(2H)- ylidene)methyl)-1H- pyrrole-2- carboxylate | 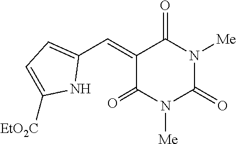 [SMILES: CCOC(=O)c1ccc(C=C2C(=O)N(C)C(=O)N(C)C2=O)[nH]1] | N/A |
| 28 | ethyl 5-((2,4,6- trioxo-1,3- diphenyltetra- hydropyrimidin- 5(2H)- ylidene)methyl)-1H- pyrrole-2- carboxylate | 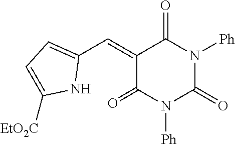 [SMILES: CCOC(=O)c1ccc(C=C2C(=O)N(c3ccccc3)C(=O)N(c3ccccc3)C2=O)[nH]1] | N/A |
| 29 | 1,3-dimethyl-5-((1- methyl-1H-pyrrol-2- yl)methylene)pyrimidine- 2,4,6(1H,3H,5H)- trione | 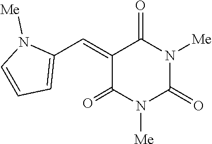 [SMILES: CN1C(=O)C(=Cc2cccn2C)C(=O)N(C)C1=O] | N/A |
| 30 | 5-((4-(tert-buty1)-1- methyl-1H-pyrrol-2- yl)methylene)-1,3- dimethylpyrimidine- 2,4,6(1H,3H,5H)- trione | 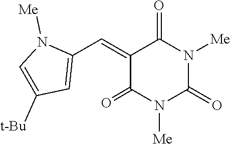 [SMILES: CN1C(=O)C(=Cc2cc(C(C)(C)C)cn2C)C(=O)N(C)C1=O] | N/A |
| 31 | 5-((4-(tert-butyl)-1- butyl-1H-pyrrol-2- yl)methylene)-1,3- dimethylpyrimidine- 2,4,6(1H,3H,5H)- trione | 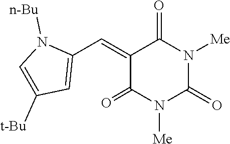 | N/A |
| 32 | ethyl 2-(4-(tert- butyl)-2-((1,3- dimethyl-2,4,6- trioxotetra- hydropyrimidin- 5(2H)- ylidene)methyl)-1H- pyrrol-1-yl)acetate | 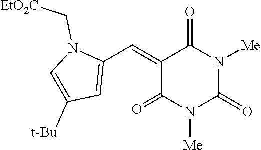 [SMILES: CCOC(=O)Cn1cc(C(C)(C)C)cc1C=C1C(=O)N(C)C(=O)N(C)C1=O] | N/A |
| 33 | 2-(4-(tert-butyl)-2- ((1,3-dimethyl- 2,4,6- trioxotetra- hydropyrimidin- 5(2H)- ylidene)methyl)-1H- pyrrol-1- yl)acetonitrile | 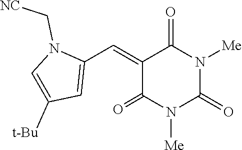 [SMILES: CN1C(=O)C(=Cc2cc(C(C)(C)C)cn2CC#N)C(=O)N(C)C1=O] | N/A |
| 34 | 5-((4-(tert-butyl)-1- (naphthalen-2- ylmethyl)-1H- pyrrol-2- yl)methylene)-1,3- dimethylpyrimidine- 2,4,6(1H,3H,5H)- trione | 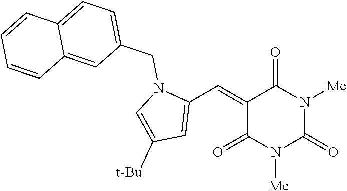 [SMILES: CN1C(=O)C(=Cc2cc(C(C)(C)C)cn2Cc2ccc3ccccc3c2)C(=O)N(C)C1=O] | N/A |
| 35 | ethyl 1-(cyanomethyl)-5- ((1,3-dimethyl- 2,4,6- trioxotetra- hydropyrimidin-5(2H)- ylidene)methyl)-2,4- dimethyl-1H- pyrrole-3- carboxylate | 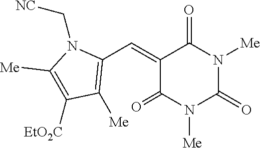 [SMILES: CCOC(=O)c1c(C)c(C=C2C(=O)N(C)C(=O)N(C)C2=O)n(CC#N)c1C] | N/A |
| 36 | ethyl 1-benzyl-5- ((1,3-dimethyl- 2,4,6- trioxotetra- hydropyrimidin-5(2H)- ylidene)methyl)-2,4- dimethyl-1H- pyrrole-3-carboxylate | 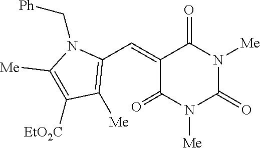 [SMILES: CCOC(=O)c1c(C)c(C=C2C(=O)N(C)C(=O)N(C)C2=O)n(Cc2ccccc2)c1C] | N/A |
| 37 | ethyl 1- (cyanomethyl)-5- ((1,3-dimethyl- 2,4,6- trioxotetra- hydropyrimidin-5(2H)- ylidene)methyl)-1H- pyrrole-2- carboxylate | 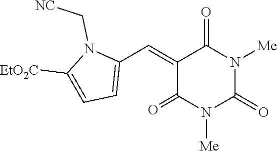 [SMILES: CCOC(=O)c1ccc(C=C2C(=O)N(C)C(=O)N(C)C2=O)n1CC#N] | N/A |
| 38 | ethyl 1- (cyanomethyl)-5- ((2,4,6-trioxo-1,3- diphenyltetra- hydropyrimidin-5(2H)- ylidene)methyl)-1H- pyrrole-2- carboxylate | 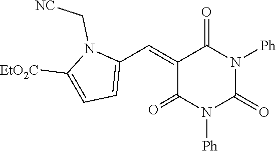 [SMILES: CCOC(=O)c1ccc(C=C2C(=O)N(c3ccccc3)C(=O)N(c3ccccc3)C2=O)n1CC#N] | N/A |
| 39 | ethyl 1-benzyl-5- ((1,3-dimethyl- 2,4,6- trioxotetra- hydropyrimidin-5(2H)- ylidene)methyl)-1H- pyrrole-2- carboxylate | 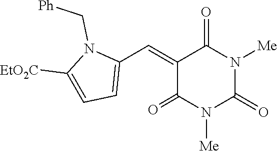 [SMILES: CCOC(=O)c1ccc(C=C2C(=O)N(C)C(=O)N(C)C2=O)n1Cc1ccccc1] | N/A |

| | | |
|---|---|---|
| 40 | 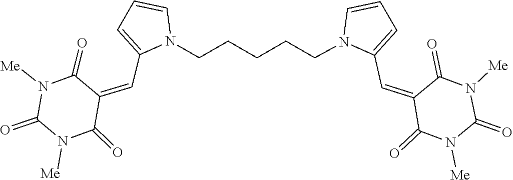 [SMILES: CN1C(=O)C(=Cc2cccn2CCCCCn2cccc2C=C2C(=O)N(C)C(=O)N(C)C2=O)C(=O)N(C)C1=O] | N/A |
| | 5,5′-((pentane-1,5-diylbis(1H-pyrrole-1,2-diyl))bis(methaneylylidene))bis(1,3- | |
| | dimethylpyrimidine-2,4,6(1H,3H,5H)-trione) | |

TABLE 2b
Representative Compounds of Formula III

| Cmpd | Cmpd Name and | Cmpd Name and Structure |
|---|---|---|
| No. | Structure (Isomer A) | (Isomer B) |
| 41 | 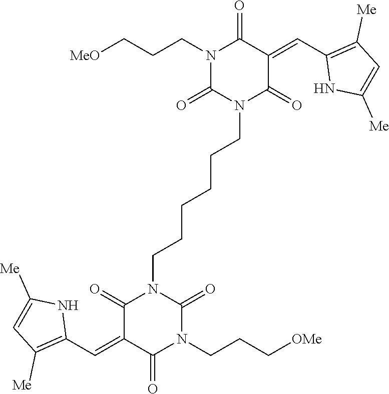 [SMILES: COCCCN1C(=O)/C(=C/c2[nH]c(C)cc2C)C(=O)N(CCCCCCN2C(=O)/C(=C\c3[nH]c(C)cc3C)C(=O)N(CCCOC)C2=O)C1=O] (5E,5′E)-3,3′-(hexane-1,6-diyl)bis(5-((3,5- dimethyl-1H-pyrrol-2-yl)methylene)-1-(3- methoxypropyl)pyrimidine-2,4,6(1H,3H,5H)-trione) | 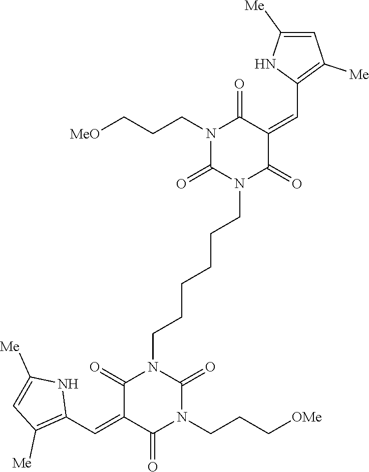 [SMILES: COCCCN1C(=O)/C(=C\c2[nH]c(C)cc2C)C(=O)N(CCCCCCN2C(=O)/C(=C\c3[nH]c(C)cc3C)C(=O)N(CCCOC)C2=O)C1=O] |
| | | (Z)-5-((3,5-dimethyl-1H- |
| | | pyrrol-2-yl)methylene)-1-(6- |
| | | ((E)-5-((3,5-dimethyl-1H- |
| | | pyrrol-2-yl)methylene)-3-(3- |
| | | methoxypropyl)-2,4,6- |
| | | trioxotetrahydropyrimidin- |
| | | 1(2H)-yl)hexyl)-3-(3- |
| | | methoxypropyl)pyrimidine- |
| | | 2,4,6(1H,3H,5H)-trione |
| 42 | 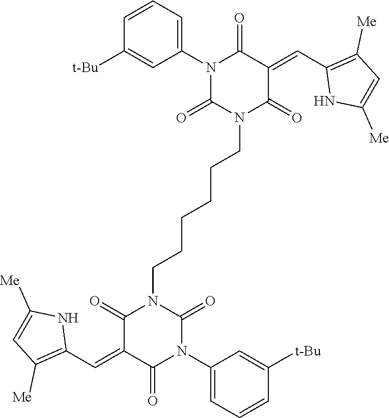 [SMILES: Cc1cc(C)c(/C=C2\C(=O)N(CCCCCCN3C(=O)/C(=C\c4[nH]c(C)cc4C)C(=O)N(c4cccc(C(C)(C)C)c4)C3=O)C(=O)N(c3cccc(C(C)(C)C)c3)C2=O)[nH]1] (5E,5′E)-3,3′-(hexane-1,6-diyl)bis(1-(3-(tert-butyl)phenyl)-5- ((3,5-dimethyl-1H-pyrrol-2-yl)methylene)pyrimidine-2,4,6 (1H,3H,5H)-trione) | 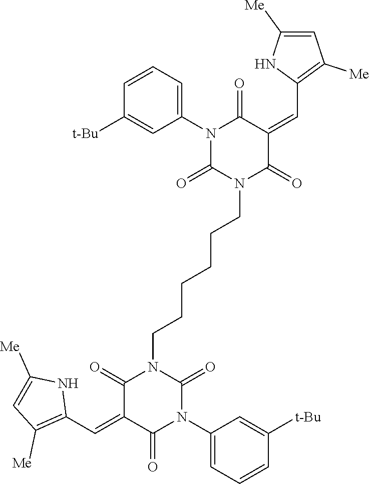 [SMILES: Cc1cc(C)c(/C=C2/C(=O)N(CCCCCCN3C(=O)/C(=C\c4[nH]c(C)cc4C)C(=O)N(c4cccc(C(C)(C)C)c4)C3=O)C(=O)N(c3cccc(C(C)(C)C)c3)C2=O)[nH]1] |
| | | (Z)-1-(3-(tert-butyl)phenyl)-3- |
| | | (6-((E)-3-(3-(tert- |
| | | butyl)phenyl)-5-((3,5- |
| | | dimethyl-1H-pyrrol-2- |
| | | yl)methylene)-2,4,6- |
| | | trioxotetrahydropyrimidin- |
| | | 1(2H)-yl)hexyl)-5-((3,5- |
| | | dimethyl-1H-pyrrol-2- |
| | | yl)methylene)pyrimidine- |
| | | 2,4,6(1H,3H,5H)-trione |

| Cmpd | Cmpd Name and |
|---|---|
| No. | Structure (Isomer C) |
| 41 | 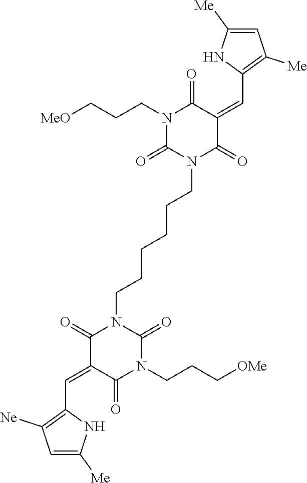 |
| | (5Z,5′Z)-3,3′-(hexane-1,6- |
| | diyl)bis(5-((3,5-dimethyl- |
| | 1H-pyrrol-2- |
| | yl)methylene)-1-(3- |
| | methoxypropyl)pyrimidine- |
| | 2,4,6(1H,3H,5H)-trione) |
| 42 | 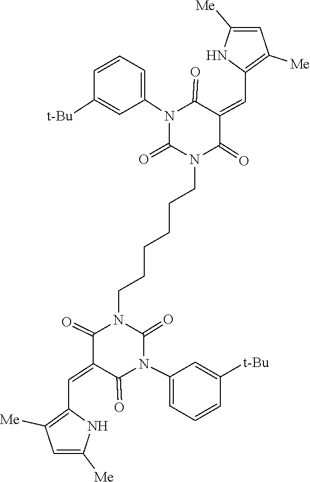 [SMILES: Cc1cc(C)c(/C=C2/C(=O)N(CCCCCCN3C(=O)/C(=C/c4[nH]c(C)cc4C)C(=O)N(c4cccc(C(C)(C)C)c4)C3=O)C(=O)N(c3cccc(C(C)(C)C)c3)C2=O)[nH]1] |
| | (5Z,5′Z)-3,3′-(hexane-1,6- |
| | diyl)bis(1-(3-(tert- |
| | butyl)phenyl)-5-((3,5- |
| | dimethyl-1H-pyrrol-2- |
| | yl)methylene)pyrimidine- |
| | 2,4,6(1H,3H,5H)-trione) |

In some aspects, the dyed article comprises a first dye according to Formula I and a minus-violet dye according to Formula II.

In some aspects, the first dye is bis(4-di(n-butyl)amino-2-methylphenyl)(4-di(n-butyl)aminophenyl)amminium tetrakis(pentafluorophenyl)borate and the minus-violet dye is diethyl 2,2′-((4-(2,2-dicyanovinyl)phenyl)azanediyl)diacetate.

In some aspects, the first dye is tris(4-di(n-butyl)aminophenyl)amminium tetrakis(pentafluorophenyl)borate and the minus-violet dye is diethyl 2,2′-((4-(2,2-dicyanovinyl)phenyl)azanediyl)diacetate.

In some aspects, the first dye is bis(4-di(n-butyl)amino-2-methylphenyl)(4-di(n-butyl)aminophenyl)amminium tetrakis(pentafluorophenyl)borate and the minus-violet dye is 2-(4-(diethylamino)benzylidene)malononitrile.

In some aspects, the first dye is tris(4-di(n-butyl)aminophenyl)amminium tetrakis(pentafluorophenyl)borate and the minus-violet dye is 2-(4-(diethylamino)benzylidene)malononitrile.

In some aspects, the first dye is tris(4-di(n-butyl)amino-2-methylphenyl)amminium tetrakis(pentafluorophenyl)borate and the minus-violet dye is 2-((4-(2,2-dicyanovinyl)-3-methylphenyl)(ethyl)amino)ethyl phenylcarbamate.

In some aspects, the first dye is bis(4-di(n-butyl)amino-2-methylphenyl)(4-di(n-butyl)aminophenyl)amminium tetrakis(pentafluorophenyl)borate and the minus-violet dye is 2-((4-(2,2-dicyanovinyl)-3-methylphenyl)(ethyl)amino)ethyl phenylcarbamate.

In some aspects, the first dye according to Formula I and the minus-violet dye according to Formula II are present in the dyed article in a molar ratio of from about 4:1 to about 1:20. In some aspects, the first dye and the minus-violet dye are present in the dyed article in a molar ratio of from about 1:8 to about 8:1, from about 1:4 to about 4:1, from about 1:1 to about 1:8, or from about 1:4 to about 1:10.

In some aspects, the first dye according to Formula I and the minus-violet dye according to Formula II are present in the dyed article in a molar ratio of about 1:10. In some aspects, the first dye and the minus-violet dye are present in the dyed article in a molar ratio of about 1:1, about 1:4, about 1:6, about 1:8, about 1:12, about 1:15, or about 1:20.

In some aspects, the dyed article comprises a first dye according to Formula I and a minus-violet dye according to Formula III.

In some aspects, the first dye is tris(4-di(n-butyl)amino-2-methylphenyl)amminium tetrakis(pentafluorophenyl)borate and the minus-violet dye is 5-((1H-pyrrol-2-yl)methylene)-1,3-dimethylpyrimidine-2,4,6(1H,3H,5H)-trione.

In some aspects, the first dye is bis(4-di(n-butyl)amino-2-methylphenyl)(4-di(n-butyl)aminophenyl)amminium tetrakis(pentafluorophenyl)borate and the minus-violet dye is 5-((1H-pyrrol-2-yl)methylene)-1,3-dimethylpyrimidine-2,4,6(1H,3H,5H)-trione.

In some aspects, the first dye is tris(4-di(n-butyl)amino-2-methylphenyl)amminium tetrakis(pentafluorophenyl)borate and the minus-violet dye is 5-((3,5-dimethyl-1H-pyrrol-2-yl)methylene)-1,3-dimethylpyrimidine-2,4,6(1H,3H,5H)-trione.

In some aspects, the first dye is bis(4-di(n-butyl)amino-2-methylphenyl)(4-di(n-butyl)aminophenyl)amminium tetrakis(pentafluorophenyl)borate and the minus-violet dye is 5-((3,5-dimethyl-1H-pyrrol-2-yl)methylene)-1,3-dimethylpyrimidine-2,4,6(1H,3H,5H)-trione.

In some aspects, the first dye is tris(4-di(n-butyl)amino-2-methylphenyl)amminium tetrakis(pentafluorophenyl)borate and the minus-violet dye is 5-((4-(tert-butyl)-1-methyl-1H-pyrrol-2-yl)methylene)-1,3-dimethylpyrimidine-2,4,6(1H,3H,5H)-trione.

In some aspects, the first dye is bis(4-di(n-butyl)amino-2-methylphenyl)(4-di(n-butyl)aminophenyl)amminium tetrakis(pentafluorophenyl)borate and the minus-violet dye is 5-((4-(tert-butyl)-1-methyl-1H-pyrrol-2-yl)methylene)-1,3-dimethylpyrimidine-2,4,6(1H,3H,5H)-trione.

In some aspects, the first dye according to Formula I and the minus-violet dye according to Formula III are present in the dyed article in a molar ratio of from about 4:1 to about 1:20. In some aspects, the first dye and the minus-violet dye are present in the dyed article in a molar ratio of from about 1:8 to about 8:1, from about 1:4 to about 4:1, from about 1:1 to about 1:8, or from about 1:4 to about 1:10.

In some aspects, the first dye according to Formula I and the minus-violet dye according to Formula III are present in the dyed article in a molar ratio of about 1:10. In some aspects, the first dye and the minus-violet dye are present in the dyed article in a molar ratio of about 1:1, about 1:4, about 1:6, about 1:8, about 1:12, about 1:15, or about 1:20.1:1. In some aspects, the first dye and the minus-violet dye are present in the dyed article in a molar ratio of about 4:1, about 3:1, about 2:1, about 1:2, about 1:3, or about 1.4.

The dyed article may take any shape or form, e.g., a shape or form appropriate for protection. In some aspects, the dyed article is in the form of a shield, a lens, a window, a lid, a cover, a case, a plaque, a sheet, a film, clothing, a panel, and a curtain. In some aspects the dyed article is in the form of a lens. In some aspects, the dyed article is incorporated into eyewear.

The polymer resin may be any polymer resin that can be coated, cast, extruded, or molded into a shape or form appropriate for laser protection. Non-limiting examples of polymer resins include acrylic resins, styrenic resins, cellulosic resins, polyamide resins, polycarbonate resins, polyester resins, and polyurethane resins. In some aspects, the polymer resin may be crosslinked. In some aspects, the polymer resin can comprise a co-polymer.

In some aspects, the dyed articles disclosed herein are useful as protection against laser radiation. In some aspects the article can be a lid, a cover, a case, a plaque, a sheet, a film, a lens, a window, a panel, a curtain, and clothing. In some aspects, the dyed article can comprise a lens comprising the dye of Formula I and at least one minus-violet dye. The dye of Formula I and at least one minus-violet dye can be incorporated into the lens in any acceptable manner that results in protection from near infrared light, e.g., from a laser, in the range of about 900 nm to about 1100 nm. In some aspects, the lens can be incorporated into eyewear, such as general-purpose eyewear, special-purpose eyewear, sunglasses, shields, face-shields (including eye-shields), eyewear incorporated into a head worn support (such as visors for helmets), visors, driving glasses, sporting glasses, goggles, vision-correcting eyewear, prescription and non-prescription eyeglasses, color vision deficiency eyewear, indoor eyewear, outdoor eyewear, contrast-enhancing eyewear, chroma-enhancing eyewear, color-enhancing eyewear, color-altering eyewear, gaming eyewear, eyewear designed for another purpose, or eyewear designed for a combination of purposes. In certain aspects, the lens can comprise an optical filter comprising the dye of Formula I and at least one minus-violet dye. In some aspects, the optical filter comprising the dye of Formula I and at least one minus-violet dye can be incorporated into a lens having any desired curvature, including, for example, cylindrical, plano, spherical or toroidal. In some aspects, the lens can include one or more functional components, such as, for example, layers, coatings, or laminates. Examples of functional components include color enhancement filters, chroma enhancement filters, laser attenuation filter, electrochromic filters, photoelectrochromic filters, polarizing filter, variable attenuation filters, anti-reflection coatings, interference stacks, hard coatings, flash mirrors, anti-static coatings, anti-fog coatings, blue cut dye layers, deep red absorbing dye layers, and broadly absorbing dye layers, other functional layers, or a combination of functional layers. In some aspects, the lens can include a lens body and the optical filter comprising the dye of Formula I and at least one minus-violet dye.

In some aspects, a lens including a lens body and an optical filter comprising the dye of Formula I and at least one minus-violet dye within and/or outside of the lens body can be configured to attenuate visible light in one or more spectral bands. In aspects in which the optical filter comprising the dye of Formula I and at least one minus-violet dye is within the lens body, the optical filter comprising the dye of Formula I and at least one minus-violet dye can constitute the lens body, or the optical filter comprising the dye of Formula I and at least one minus-violet dye and additional components can constitute the lens body.

In some aspects, the optical filter comprising the dye of Formula I and at least one minus-violet dye is at least partially incorporated into the lens body. For example, and in some aspects, the lens body can be impregnated with, loaded with, or otherwise comprise one or more dyes of Formula I, and one of more dyes of Formula II, such as any of the compounds provided in Table 1, one or more dyes of Formula III, such as any of the compounds provided in Table 2a or Table 2b, or a combination thereof. In some aspects, the lens body can be impregnated with, loaded with, or otherwise comprise one or more dyes of Formula I and one or more dyes of Formula II. In some aspects, the lens body can be impregnated with, loaded with, or otherwise comprise one or more dyes of Formula I and one or more dyes of Formula III.

In another aspect, the dyed article comprising a dye of Formula I and at least one minus-violet dye selectively blocks near infrared light within a spectral band of wavelengths ranging from about 850 nm to about 900 nm, from about 850 to about 950 nm, from about 850 nm to about 1000 nm, from about 850 nm to about 1050 nm, from about 850 to about 1100 nm, from about 850 to about 1150 nm, from about 900 to about 950 nm, from about 900 nm to about 1000 nm, from about 900 nm to about 1050 nm, from about 900 to about 1100 nm, from about 900 to about 1150 nm, from about 950 nm to about 1000 nm, from about 950 nm to about 1050 nm, from about 950 to about 1100 nm, from about 950 to about 1150 nm, from about 1000 nm to about 1050 nm, from about 1000 to about 1100 nm, from about 1000 to about 1150 nm, from about 1050 to about 1100 nm, from about 1050 to about 1150 nm, or from about 1100 nm to about 1150 nm.

In some aspects, the article comprising the dye of Formula I and at least one minus-violet dye further comprises one or more additional dyes. In some aspects, the one or more additional dyes is a UV absorbing dye or a color-balancing dye.

In another aspect, the optical filter is at least partially incorporated into a lens coating, an adhering layer, a polarizing layer, a photochromic layer, an anti-reflection layer, other functional layer, or is at least partially incorporated into a combination of coatings and layers.

In some aspects, the optical filter comprising the dye of Formula I and at least one minus-violet dye further comprises a polymeric material.

In some aspects, the dye of Formula I and at least one minus-violet dye are at least partially incorporated into the polymeric material.

In some aspects, the dye of Formula I is tris(4-di(n-butyl)amino-2-methylphenyl)amminium tetrakis(pentafluorophenyl)borate or bis(4-di(n-butyl)amino-2-methylphenyl)(4-di(n-butyl)aminophenyl)amminium tetrakis(pentafluorophenyl)borate.

In some aspects, the minus-violet dye is a dye of Formula II. In some aspects, the dye of Formula II is: diethyl 2,2′-((4-(2,2-dicyanovinyl)phenyl)azanediyl)diacetate, 2-(4-(diethylamino)benzylidene)malononitrile, or 2-((4-(2,2-dicyanovinyl)-3-methylphenyl)(ethyl)amino)ethyl phenylcarbamate.

In some aspects, the minus-violet dye is a dye of Formula III. In some aspects, the dye of Formula III is: 5-((1H-pyrrol-2-yl)methylene)-1,3-dimethylpyrimidine-2,4,6(1H,3H,5H)-trione, 5-((3,5-dimethyl-1H-pyrrol-2-yl)methylene)-1,3-dimethylpyrimidine-2,4,6(1H,3H,5H)-trione, or 5-((4-(tert-butyl)-1-methyl-1H-pyrrol-2-yl)methylene)-1,3-dimethylpyrimidine-2,4,6(1H,3H,5H)-trione.

In some aspects, the dyed article comprising the dye of Formula I and at least one minus-violet dye has an infrared peak optical density (OD) of between about 2 and about 12 OD; about 3 and about 11 OD; about 4 and about 10 OD; about 5 and about 9 OD; about 6 and about 8 OD; about 2 and about 6 OD; or about 6 and about 12 OD.

In some aspects, the dyed article comprising the dye of Formula I and at least one minus-violet dye has an infrared peak optical density (OD) of about 2, about 3, about 4, about 5, about 6, about 7, about 8, about 9, about 10, about 11, or about 12.

In some aspects, the dyed article comprising dye of Formula I and at least one minus-violet dye has an internal visual luminous transmission of no more than about 94%, no more than about 93%, no more than about 92%, no more than about 91%, no more than about 90%, no more than about 89%, no more than about 88%, or no more than about 85%. In some aspects, the internal visual luminous transmission can be measured using the ANSI Z87 standard.

FIG. 1 illustrates a perspective view of articles 102 a, 102 b that comprise the optical filter comprising a dye of Formula I and at least one minus-violet dye, according to some aspects. Eyewear 100 includes the pair of lenses 102 a, 102 b and can be of any type, including general-purpose eyewear, special-purpose eyewear, sunglasses, eyeshields, eyewear incorporated into headworn support (such as visors for helmets), visors, driving glasses, sporting glasses, goggles, vision-correcting eyewear, prescription and non-prescription eyeglasses, color vision deficiency eyewear, indoor eyewear, outdoor eyewear, contrast-enhancing eyewear, chroma-enhancing eyewear, color-enhancing eyewear, color-altering eyewear, gaming eyewear, eyewear designed for another purpose, or eyewear designed for a combination of purposes. In some aspects, lenses and frames of many other shapes and configurations may be used for eyewear 100. For example, eyewear 100 can have a single, unitary lens, such as in a goggle or visor and such lens comprise the optical filter comprising a dye of Formula I and at least one minus-violet dye. It should be noted that eyewear 100 shown in FIG. 1 is not drawn to scale but is drawn to more easily illustrate certain aspects of eyewear 100.

In some aspects, a lens can comprise a lens body and an optical filter comprising a dye of Formula I and at least one minus-violet dye.

In another embodiment, the optical filter can be the lens body. In another embodiment, the optical filter can be partially incorporated into the lens body.

In some aspects, the dye of Formula I and at least one minus-violet dye can each, independently, be present in the lens in a range of about 0.0002% to about 6%; about 0.002% to about 6%; about 0.02% to about 6%; about 0.2% to about 6%; about 0.0002% to about 5%; about 0.2% to about 4%; about 0.2% to about 3%; or about 0.2% to about 2% by weight.

Weight percent is calculated based on [i] the total weight of a particular dye incorporated into the lens relative to [ii] the total weight of the lens.

In some aspects, the article comprising the dye of Formula I and at least one minus-violet dye has a thickness from about 0.05 mm to about 40 mm; from about 0.05 to about 20 mm; from about 0.05 to about 10 mm; from about 0.05 to about 5 mm; from about 0.05 mm to about 1 mm; from about 0.1 to about 15 mm; from about 1 mm to about 10 mm; from about 2 mm to about 8 mm; from about 3 mm to about 6 mm; from about 10 mm to about 40 mm; from about 15 mm to about 40 mm; from about 20 mm to about 40 mm; from about 30 mm to about 40 mm; from about 15 mm to about 35 mm; or from about 20 mm to about 30 mm.

In some aspects, the article comprising the dye of Formula I, at least one minus-violet dye, and one or more additional dyes has a thickness from about 0.05 mm to about 40 mm; from about 0.05 to about 20 mm; from about 0.05 to about 10 mm; from about 0.05 to about 5 mm; from about 0.05 mm to about 1 mm; from about 0.1 to about 15 mm; from about 1 mm to about 10 mm; from about 2 mm to about 8 mm; from about 3 mm to about 6 mm; from about 10 mm to about 40 mm; from about 15 mm to about 40 mm; from about 20 mm to about 40 mm; from about 30 mm to about 40 mm; from about 15 mm to about 35 mm; or from about 20 mm to about 30 mm.

Lenses 102 a, 102 b can be implemented in any headworn support (i.e., a headworn article that can support one or more lenses in the wearer's field of view). For example, other headworn supports can include, but are not limited to, helmets, face masks, balaclavas, and breaching shields. The lenses 102 a and 102 b can be corrective lenses or non-corrective lenses and can be made of any of a variety of optical materials including glass and/or plastics, such as, for example, acrylics or polycarbonates. The lenses can have various shapes. For example, the lenses 102 a, 102 b can be flat, have 1 axis of curvature, 2 axes of curvature, or more than 2 axes of curvature, the lenses 102 a, 102 b can be cylindrical, parabolic, spherical, flat, or elliptical, or any other shape such as a meniscus or catenoid. When worn, the lenses 102 a, 102 b can extend across the wearer's normal straight ahead line of sight, and can extend substantially across the wearer's peripheral zones of vision. As used herein, the wearer's normal line of sight shall refer to a line projecting straight ahead of the wearer's eye, with substantially no angular deviation in either the vertical or horizontal planes. In some aspects, the lenses 102 a, 102 b extend across a portion of the wearer's normal straight ahead line of sight.

The outside surface of lenses 102 a or 102 b can conform to a shape having a smooth, continuous surface having a constant horizontal radius (sphere or cylinder) or progressive curve (ellipse, toroid or ovoid) or other aspheric shape in either the horizontal or vertical planes. The geometric shape of other aspects can be generally cylindrical, having curvature in one axis and no curvature in a second axis. The lenses 102 a, 102 b can have a curvature in one or more dimensions. For example, the lenses 102 a, 102 b can be curved along a horizontal axis. As another example, lenses 102 a, 102 b can be characterized in a horizontal plane by a generally arcuate shape, extending from a medial edge throughout at least a portion of the wearer's range of vision to a lateral edge. In some aspects, the lenses 102 a, 102 b are substantially linear (not curved) along a vertical axis. In some aspects, the lenses 102 a, 102 b have a first radius of curvature in one region, a second radius of curvature in a second region, and transition sites disposed on either side of the first and second regions. The transition sites can be a coincidence point along the lenses 102 a, 102 b where the radius of curvature of the lenses 102 a, 102 b transitions from the first to the second radius of curvature, and vice versa. In some aspects, lenses 102 a, 102 b can have a third radius of curvature in a parallel direction, a perpendicular direction, or some other direction. In some aspects, the lenses 102 a, 102 b can lie on a common circle. The right and left lenses in a high-wrap eyeglass can be canted such that the medial edge of each lens will fall outside of the common circle and the lateral edges will fall inside of the common circle. Providing curvature in the lenses 102 a, 102 b can result in various advantageous optical qualities for the wearer, including reducing the prismatic shift of light rays passing through the lenses 102 a, 102 b, and providing an optical correction.

A variety of lens configurations in both horizontal and vertical planes are possible. Thus, for example, either the outer or the inner or both surfaces of the lens 102 a or 102 b of some aspects can generally conform to a spherical shape or to a right circular cylinder. Alternatively either the outer or the inner or both surfaces of the lens can conform to a frustoconical shape, a toroid, an elliptic cylinder, an ellipsoid, an ellipsoid of revolution, a sphere or any of a number of other three dimensional shapes. Regardless of the particular vertical or horizontal curvature of one surface, however, the other surface can be chosen such as to minimize one or more of power, prism, and astigmatism of the lens in the mounted and as-worn orientation.

The lenses 102 a, 102 b can be linear (not curved) along a vertical plane (e.g., cylindrical or frustoconical lens geometry). In some aspects, the lenses 102 a, 102 b can be aligned substantially parallel with the vertical axis such that the line of sight is substantially normal to the anterior surface and the posterior surface of the lenses 102 a, 102 b. In some aspects, the lenses 102 a, 102 b are angled downward such that a line normal to the lens is offset from the straight ahead normal line of sight by an angle D. The angle (of offset can be greater than about 0° and/or less than about 30°, or greater than about 700 and/or less than about 20°, or about 15°, although other angles Φ outside of these ranges can also be used. Various cylindrically shaped lenses can be used. The anterior surface and/or the posterior surface of the lenses 102 a, 102 b can conform to the surface of a right circular cylinder such that the radius of curvature along the horizontal axis is substantially uniform. An elliptical cylinder can be used to provide lenses that have non-uniform curvature in the horizontal direction. For example, a lens can be more curved near its lateral edge than its medial edge. In some aspects, an oblique (non-right) cylinder can be used, for example, to provide a lens that is angled in the vertical direction.

In some aspects, the eyewear 100 incorporates canted lenses 102 a, 102 b mounted in a position rotated laterally relative to conventional centrally oriented dual lens mountings. A canted lens can be conceived as having an orientation, relative to the wearer's head, which would be achieved by starting with conventional dual lens eyewear having centrally oriented lenses and bending the frame inwardly at the temples to wrap around the side of the head. When the eyewear 100 is worn, a lateral edge of the lens wraps significantly around and comes in close proximity to the wearer's temple to provide significant lateral eye coverage.

A degree of wrap may be desirable for aesthetic styling reasons, for lateral protection of the eyes from flying debris, or for interception of peripheral light. Wrap can be attained by utilizing lenses of tight horizontal curvature (high base), such as cylindrical or spherical lenses, and/or by mounting each lens in a position which is canted laterally and rearwardly relative to centrally oriented dual lenses. Similarly, a high degree of rake or vertical tilting may be desirable for aesthetic reasons and for intercepting light, wind, dust or other debris from below the wearer's eyes. In general, “rake” will be understood to describe the condition of a lens, in the as-worn orientation, for which the normal line of sight strikes a vertical tangent to the lens 102 a or 102 b at a non-perpendicular angle.

The lenses 102 a, 102 b can be provided with anterior and posterior surfaces and a thickness therebetween, which can be variable along the horizontal direction, vertical direction, or combination of directions. In some aspects, the lenses 102 a, 102 b can have a varying thickness along the horizontal or vertical axis, or along some other direction. In some aspects, the thickness of the lenses 102 a, 102 b tapers smoothly, though not necessarily linearly, from a maximum thickness proximate a medial edge to a relatively lesser thickness at a lateral edge. The lenses 102 a, 102 b can have a tapering thickness along the horizontal axis and can be decentered for optical correction. In some aspects, the lenses 102 a, 102 b can have a thickness configured to provide an optical correction. For example, the thickness of the lenses 102 a, 102 b can taper from a thickest point at a central point of the lenses 102 a, 102 b approaching lateral segments of the lenses 102 a, 102 b. In some aspects, the average thickness of the lenses 102 a, 102 b in the lateral segments can be less than the average thickness of the lenses 102 a, 102 b in the central zone. In some aspects, the thickness of the lenses 102 a, 102 b in at least one point in the central zone can be greater than the thickness of the lenses 102 a, 102 b at any point within at least one of the lateral segments.

In some aspects, the lenses 102 a, 102 b can be finished, as opposed to semi-finished, with the lenses 102 a, 102 b being contoured to modify the focal power. In some aspects, the lenses 102 a, 102 b can be semi-finished so that the lenses 102 a, 102 b can be capable of being machined, at some time following manufacture, to modify their focal power. In some aspects, the lenses 102 a, 102 b can have optical power and can be prescription lenses configured to correct for near-sighted or far-sighted vision. The lenses 102 a, 102 b can have cylindrical characteristics to correct for astigmatism.

The eyewear 100 can include a mounting frame 104 configured to support the lenses 102 a, 102 b. The mounting frame 104 can include orbitals that partially or completely surround the lenses 102 a, 102 b. Referring to FIG. 1, it should be noted that the particular mounting frame 104 is not essential to the aspect disclosed herein. The frame 104 can be of varying configurations and designs, and the illustrated aspect shown in FIG. 1 is provided as examples only. As illustrated, the frame 104 can include a top frame portion and a pair of ear stems 106 a, 106 b that are connected to opposing ends of the top frame portion. Further, the lenses 102 a, 102 b can be mounted to the frame 104 with an upper edge of the lens 102 a or 102 b extending along or within a lens groove and being secured to the frame 104. For example, the upper edge of the lens 102 a or 102 b can be formed in a pattern, such as a jagged or non-linear edge, and apertures or other shapes around which the frame 104 can be injection molded or fastened in order to secure the lens 102 a or 102 b to the frame 104. Further, the lenses 102 a, 102 b can be removably attachable to the frame 104 by means of a slot with inter-fitting projections or other attachment structure formed in the lenses 102 a, 102 b and/or the frame 104.

It is also contemplated that the lenses 102 a, 102 b can be secured along a lower edge of the frame 104. Various other configurations can also be utilized. Such configurations can include the direct attachment of the ear stems 106 a, 106 b to the lenses 102 a, 102 b without any frame, or other configurations that can reduce the overall weight, size, or profile of the eyeglasses. In addition, various materials can be utilized in the manufacture of the frame 104, such as metals, composites, or relatively rigid, molded thermoplastic materials which are well known in the art, and which can be transparent or available in a variety of colors. Indeed, the mounting frame 104 can be fabricated according to various configurations and designs as desired. In some aspects, the frame 104 is configured to retain a unitary lens that is placed in front of both eyes when the eyewear is worn. Eyewear (e.g., goggles) can also be provided that include a unitary lens that is placed in front of both eyes when the eyewear is worn. The unitary lens having features similar to the lenses 102 a, 102 b can be implemented in other types of headworn supports such as, but not limited to, helmets, face masks, balaclavas, and breaching shields. The disclosures herein throughout concerning lenses 102 a, 102 b apply likewise to a unitary lens article.

In some aspects, the ear stems 106 a, 106 b can be pivotably attached to the frame 104. In some aspects, the ear stems 106 a, 106 b attach directly to the lenses 102 a, 102 b. The ear stems 106 a, 106 b can be configured to support the eyewear 100 when worn by a user. For example, the ear stems 106 a, 106 b can be configured to rest on the ears of the user. In some aspects, the eyewear 100 includes a flexible band used to secure the eyewear 100 in front of the user's eyes in place of ear stems 106 a, 106 b.

In some aspects of the lenses 102 a and 102 b that includes the optical filter comprising the dye of Formula I and at least one minus-violet dye, can comprise a lens body 108 and a lens component 110, as illustrated in FIG. 1A. The lens body 108 can have an inner surface facing the eye and an outer surface opposite the inner surface. The inner surface and/or the outer surface of the lens body 108 can be curved (e.g., convex or concave). In some aspects, the inner and/or the outer surface of the lens body 108 can be planar. The lens component 110 can be substantially permanently affixed to the lens body 108, or the lens component 110 can be configured to be separable from the lens body 108. The lens component 110 can be attached to the inner or outer surface of the lens body 108. In some aspects, the lens component 110 can be configured to be removable such that a user, manufacturer, or retailer can apply, remove, or change the lens component 110 after manufacture of the eyewear 100. In this way, a variety of functional elements can be introduced into the eyewear 100 increasing the possible utility of the eyewear 100 because the eyewear can be altered to provide functionality suitable for different occasions. In some aspects, the lens component 110 includes a laminate, a coating, a flexible material, an inflexible material, an insert molded component, a chip, a gel layer, a liquid layer, an air gap, a filter, or any combination of components.

The lens body 108 that incorporates the optical filter comprising the dye of Formula I and at least one minus-violet dye can be formed of polymer, polycarbonate (or PC), allyl diglycol carbonate monomer (being sold under the brand name CR-39®), glass, polyamide, polyurethane, polyethylene, polyimide, polyethylene terephthalate (or PET), biaxially-oriented polyethylene terephthalate polyester film (or BoPET, with one such polyester film sold under the brand name MYLAR®), acrylic (polymethyl methacrylate or PMMA), a polymeric material, a co-polymer, a doped material, any other suitable material, or any combination of materials.

The lens body 108 can be rigid and other layers of the lens can conform to the shape of the lens body 108 such that the lens body 108 dictates the shape of the lens 102 a or 102 b. The lens body 108 can be symmetrical across a vertical axis of symmetry, symmetrical across a horizontal axis of symmetry, symmetrical across another axis, or asymmetrical. In some aspects, the front and back surfaces of the lens body 108 can conform to the surfaces of respective cylinders that have a common center point and different radii. In some aspects, the lens body can have a front and back surfaces that conform to the surfaces of respective cylinders that have center points offset from each other, such that the thickness of the lens body 108 tapers from a thicker central portion to thinner end portions. The surfaces of the lens body 108 can conform to other shapes, as discussed herein, such as a sphere, toroid, ellipsoid, asphere, plano, frustoconical, and the like. In some aspects, a thermoforming process, a molding process, a casting process, a lamination process, an extrusion process, an adhering process, and/or another suitable process can be used to attach the lens component 110 to the lens body 108 having a shape described herein.

The lens body 108 can be contoured during initial formation to have an optical magnification characteristic that modifies the focal power of the lens 102 a or 102 b. In some aspects, the lens body 108 can be machined after initial formation to modify the focal power of the lens 102 a or 102 b. The lens body 108 can provide a substantial amount of the optical power and magnification characteristics to the lens 102 a or 102 b. In some aspects, the lens body 108 provides the majority of the optical power and magnification characteristics. Apportioning the majority of optical power and magnification to the lens body 108 can permit selection of lens body 108 materials and lens body 108 formation techniques that provide improved lens 102 a, 102 b optical power and magnification characteristics, without adversely affecting selection of lens component 110 materials and formation techniques.

In some aspects, the lens body 108 can be injection molded, although other processes can be used to form the shape of the lens blank body, such as thermoforming, casting, or machining. In some aspects, the lens body 108 is injection molded and includes a relatively rigid and optically acceptable material such as polycarbonate. The curvature of the lens body 108 would thus be incorporated into a molded lens blank. A lens blank can include the desired curvature and taper in its as-molded condition. One or two or more lens bodies of the desired shape can then be cut from the optically appropriate portion of the lens blank as is understood in the art. In some aspects, the frame 104 is provided with a slot or other attachment structure that cooperates with the molded and cut shape of the lens body 108 and lens component 110 to minimize deviation from, and even improve retention of its intended shape. In some aspects, the lens body 108 can be stamped or cut from flat sheet stock and then bent into the curved configuration using a process such as thermoforming. This curved configuration can then be maintained by the use of a relatively rigid, curved frame 104, or by heating the curved sheet to retain its curved configuration.

The lens component 110 can be attached to the lens body 108, for example, through a thermally-cured adhesive layer, a UV-cured adhesive layer, electrostatic adhesion, pressure sensitive adhesives, or any combination of these. Examples of bonding technologies that can be suitable for attaching the lens component 110 to the lens body 108 include thermal welding, fusing, pressure sensitive adhesives, polyurethane adhesives, electrostatic attraction, thermoforming, other types of adhesives, materials curable by ultraviolet light, thermally curable materials, radiation-curable materials, other bonding methods, other bonding materials, and combinations of methods and/or materials. In some aspects, any technique suitable for affixing the lens component 110 to the lens body 108 can be used. Some aspects of a lens 102 a or 102 b includes a lens body 108 and a lens component 110 that are bonded together. In some aspects, the lens component 110 and the lens body 108 can be integrally connected to each other and can be adhesively bonded together.

The lens component 110 can include a single layer or multiple layers. The lens component 110 can have one or more layers in single or multiple layer form that can be coated with a hard coat or a primer. For example, the lens component 110 can be a single layer of polycarbonate, PET, polyethylene, acrylic, polyamide, polyurethane, polyimide, BoPET, another film material, or a combination of materials. As another example, the lens component can include multiple layers of film, where each film layer includes polycarbonate, PET, polyethylene, acrylic, polyamide, polyurethane, polyimide, BoPET, another film material, or a combination of materials.

Each of the lens component 110 and/or lens body 108 can include one or more layers that serve various functions within the lenses 102 a, 102 b. In some aspects, one or more layers in the lens component 110 and/or the lens body 108 can provide optical properties to the lenses 102 a, 102 b such as optical filtering, polarization, photochromism, electrochromism, photoelectrochromism and/or partial reflection of incoming visible light, chroma enhancement, color enhancement, color alteration, or any combination of these. In some aspects, one or more layers within the lens component 110 and/or the lens body 108 can provide mechanical protection to the lenses 102 a, 102 b or other layers within the lens component 110, reduce stresses within the lens component 110, or improve bonding or adhesion among the layers in the lens component 110 and/or between the lens component 110 and the lens body 108. In some aspects, the lens component 110 and/or the lens body 108 can include layers that provide additional functionality to the lenses 102 a, 102 b such as, for example, anti-reflection functionality, anti-static functionality, anti-fog functionality, scratch resistance, mechanical durability, hydrophobic functionality, reflective functionality, darkening functionality, aesthetic functionality including tinting, or any combination of these.

Accordingly some aspects of the lens body 108 and/or lens component 110 can include a polarizing layer configured to provide polarization, one or more adhesive layers, a photochromic layer, an electrochromic layer configured to provide electrochromism, a photoelectrochomic layer, reflective layer configured to provide a partial reflection of incoming visible light, a hard coat, a flash mirror, a liquid-containing layer, an antireflection layer, a mirror layer, an interference stack, chroma enhancing dyes, an index-matching layer, a scratch resistant coating, a hydrophobic coating, an absorption layer configured to provide a partial or complete absorption of infrared light, a color enhancement layer, a color alteration layer, an anti-static coating, an anti-fog functional layer, chroma enhancement dyes, color enhancement elements, a darkening functional layer, an aesthetic functional layer including tinting, laser attenuation filters, trichoic filters, violet edge filter, UV filter, IR filter, glass layers, hybrid glass-plastic layers, anti-reflective coatings, contrast enhancement elements, a liquid-containing layer, a gel containing layer, a refractive index matching layer, thermal insulation layer, electrical insulation layer, electrical conducting layer, neutral density filter, other lens elements, or a combination of lens components. In some aspects, the optical filter comprising the dye of Formula I and at least one minus-violet dye is at least partially incorporated into a lens body and/or lens component or one or more functional layers. In some aspects, the optical filter comprising the dye of Formula I and at least one minus-violet dye is at least partially incorporated into lens body 108 and/or lens component 110 or one or more functional layers (e.g. a lens coating, an adhering layer, a polarizing layer, a photochromic layer, an anti-reflection layer, or is at least partially incorporated into a combination of coatings and layers). In some aspects, the process of forming the lens body can include forming a chroma enhancement wafer, and forming a lens substrate over the chroma enhancement wafer. By way of example and not limitation, the process of forming a chroma enhancement wafer can include injection molding or casting a wafer that includes one or more wavelength filtering materials. By way of example and not limitation, the process of forming the lens body over the wavelength chroma enhancement wafer can include placing the chroma enhancement wafer in a mold cavity and molding an optically transparent material, such as resin, over one or more surfaces of the wavelength filtering wafer in the mold cavity. As a result, after the optically transparent material (e.g., resin) is cooled down and hardened, the lens body can conform to the wavelength filtering wafer. It is noted that the above described embodiments for forming the lens body are exemplary and not limiting. Various implementations for forming the lens body are described, for example, in U.S. Patent Publication. No. 2017/0075143, which is incorporated by reference herein in its entirety.

As an example, the lens component 110 can include one or more layers that can serve to thermally insulate the lens component 110 such that it can be used in high temperature molding processes without subjecting the certain functional layers to temperatures sufficient to significantly degrade their optical performance. In some aspects, the lens component 110 can serve as a thermally isolating element or vehicle that can incorporate functional elements that can be degraded if subjected to high temperature manufacturing processes. As such, the lens component 110 can be used to incorporate these types of functional elements into lenses that otherwise are formed and/or manufactured using high temperature processes. As another example, the lens component 110 can include a substrate with one or more functional coatings deposited thereon. The functional coatings can include elements that would be degraded or whose performance would be altered if subjected to high temperatures, such as certain chroma enhancement dyes. The lens component 110 could then be bonded to the lens body 108 using a UV-cured adhesive, thus thermally isolating the lens component 110 and the included functional layers from the high temperature processes associated with the manufacture of the lens body 108.

In certain aspects, lens 102 a or 102 b that includes the optical filter comprising the dye of Formula I and at least one minus-violet dye can also incorporate additional functionality. The lens component 110 or the lens body 108 can include layers or elements that serve to tint the lens 102 a, 102 b. Tinting can be added to a lens element in different ways. In some aspects, color can be deposited on the lens element using a vapor or liquid source. The color can coat the lens element or it can penetrate into the element, and/or can be applied using a sublimation process. In some aspects, color can be added to a material used to make the lens element, such as adding powdered color or plastic pellets to material that is extruded, injection molded, or otherwise molded into a lens element. In some aspects where liquids are used, the color can be added by a dip process. In such aspects, a gradient tint or bi-gradient tint can be achieved through the dip process. In certain aspects, a liquid coloring technique can be used to tint one or more lens elements. For example, liquid dye can be added to the polymer during an injection molding process.

In some aspects, the lens 102 can comprise an optical filter system comprising an optical filter comprising the dye of Formula I and at least one minus-violet dye with variable optical characteristics (also referred to as a variable optical filter) including a variable filter component 114 and an optical filter with fixed optical characteristics (also referred to as a static filter) including a static filter component 116, as illustrated in FIG. 1B and as described in U.S. Pat. No. 10,073,282.

In some aspects, the method of manufacturing a lens can include forming a lens having an optical filter comprising the dye of Formula I and at least one minus-violet dye configured to attenuate visible light in a plurality of spectral bands. Each of the plurality of spectral bands can include an absorbance peak with a spectral bandwidth, a maximum absorbance, and an integrated absorptance peak area within the spectral bandwidth. An attenuation factor of the absorbance peak in each of the plurality of spectral bands can be greater than or equal to about 0.8 and less than 1. In some aspects, a lens can be formed by forming a lens body and forming a lens coating over the lens body. At least a portion of the optical filter can be incorporated into the lens body or the lens coating. In some aspects, the lens coating can include an interference coating. In some aspects, the lens can include a UV absorption layer or a layer that includes UV absorption outside of the optical filter layer. Such a layer can decrease bleaching of the optical filter. In addition, UV absorbing agents can be disposed in any lens component or combination of lens components. In some aspects, a lens body can be formed by a method including forming a plurality of lens body elements and coupling the lens body elements to one another using one or more adhering layers. A polarizing film can be disposed between two or more of the plurality of lens body elements. In some aspects, the polarizing film can be insert molded within the lens body. In some aspects, the lens can include one or more components that substantially absorb ultraviolet radiation, including near ultraviolet radiation, as described in U.S. Patent Publication No. No. 2022/0107511 which is incorporated by reference herein in its entirety.

In certain aspects, the dye of Formula I and at least one minus-violet dye can be added to a molten resin before the resin is injected into a mold cavity to form the lens body. By way of example and not limitation, the optically transparent material can include molten resin, polycarbonate (PC), allyl diglycol carbonate monomer (being sold under the brand name CR-39®), a resin layer (e.g., MR-8@), glass, polyamide, polyurethane, polyethylene, polyureas, polyamide (PA), polyethylene terephthalate (PET), biaxially-oriented polyethylene terephthalate polyester film (BoPET, with one such polyester film sold under the brand name MYLAR®), acrylic (polymethyl methacrylate or PMMA), triacetate cellulose (TAC), a polymeric material, a co-polymer, a doped material, any other suitable material, or any combination thereof as described in U.S. Patent Publication No. 2021/0157170 which is incorporated by reference herein in its entirety.

In some aspects, the process of forming the lens body can include forming a lens substrate, and forming a chroma enhancement layer over the lens substrate. By way of example and not limitation, a forming process of the lens substrate can include applying an injection molding process, a thermoforming process, a casting process, or a machining process on the optically transparent material described above, as described in U.S. Patent Publication No. 2021/0157170. Other examples of forming the lens body having chroma enhancement are disclosed in U.S. Patent Publication. No. 2017/0075143 (noted and incorporated by reference above) and U.S. Patent Publication. No. 2017/0102558, entitled “Eyewear with multiple functional layers,” which is also incorporated herein by reference in its entirety.

### Processes of Preparing Dyed Articles

The present disclosure also provides processes of preparing the dyed articles disclosed herein, comprising coating, casting, extruding, or molding the polymer resin, the first dye, and the minus-violet dye.

In some aspects, the process comprises mixing the polymer resin, the first dye, and the minus-violet dye, e.g., for about 30 minutes to about 90 minutes, for about 15 minutes to about 90 minutes, for about 15 minutes to about 60 minutes, for about 30 minutes to about 60 minutes, or for about 60 minutes to about 90 minutes.

In some aspects, the process comprises mixing the polymer resin, the first dye, and the minus-violet dye with a radical initiator. Non-limiting examples of radical initiators include azo compounds, e.g., azobis(isobutyronitrile) (AIBN), organic peroxides, e.g., di-tert-butyl peroxide, benzoyl peroxide, and methyl ethyl ketone peroxide, and inorganic peroxides, e.g., peroxidisulfate salts.

In some aspects, the process comprises heating the polymer resin, the first dye, and the minus-violet dye, e.g., to a temperature of from about 60° C. to about 120° C., from about 30° C. to about 60° C., from about 30° C. to about 90° C., from about 30° C. to about 120° C., from about 60° C. to about 90° C., from about 90° C. to about 120° C., from about 100° C. to about 200° C., from about 150° C. to about 250° C., or from about 200° C. to about 300° C.

### Minus-Violet Dyes

In as much as the present application provides articles comprising a dye of Formula I in combination with at least one dye according to Formula II and/or Formula III, the present disclosure also contemplates the minus-violet dyes described herein per se, that is, in the absence of a dye according to Formula I. Thus, and in some aspects, the present disclosure provides a dye according to Formula II:

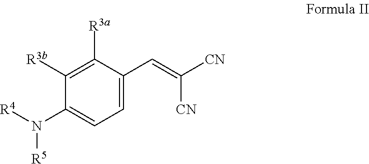

In certain aspects, R^{3a} and R^{3b} can each, independently, be H, C₁-C₄ alkyl, C₁-C₄ alkoxy, phenoxy, C₁-C₄ alkylthio, hydroxyl, or halo;
R⁴ and R⁵ can each, independently, be C₁-C₆ alkyl, C₁-C₆ haloalkyl, C₁-C₆ cyanoalkyl, C₆-C₁₀ aryl, C₁-C₆ alkylene-C(═O)OR^{4a}, C₁-C₆ alkylene-C(═O)R^{4a}, or C₁-C₆ alkylene-OC(═O)NR^{4a}R^{4b}; or
R⁴ and R⁵ can be taken together with the nitrogen atom to which they are attached to form an optionally substituted 4- to 7-membered heterocycle;
R^{4a} can, independently at each occurrence, be C₁-C₆ alkyl or C₆-C₁₀ aryl; and
R^{4b} can, independently at each occurrence, be H or C₁-C₄ alkyl.

In another aspect, R^{3a} can be H, methyl, methoxy, ethyloxy, phenoxy, hydroxyl, fluoro, chloro, or bromo;
R^{3b} can be H; and
R⁴ and R⁵ can each, independently, be methyl, ethyl, n-butyl, phenyl, 3-cyanopropyl, —CH₂C(═O)OCH₂CH₃, —CH₂CH₂C(═O)CH₃ or —CH₂CH₂OC(═O)NH(C₆-C₁₀ aryl); or
R⁴ and R⁵ can be taken together with the nitrogen atom to which they are attached to form a pyrrolidinyl group.

In some aspects, R^{3a} can be H;
R^{3b} can be H; and
R⁴ and R⁵ can each, independently, be methyl, ethyl, or —CH₂C(═O)OCH₂CH₃; or
R⁴ and R⁵ can be taken together with the nitrogen atom to which they are attached to form a pyrrolidinyl group.

In some aspects, R^{3a} can be methyl;
R^{3b} can be H; and
R⁴ and R⁵ can each be methyl; or
R⁴ can be ethyl and R⁵ can be —CH₂CH₂OC(═O)NHPh.

In some aspects, R^{3a} can be methoxy;
R^{3b} can be H; and
R⁴ and R⁵ can each, independently, be 3-cyanopropyl or —CH₂C(═O)OCH₂CH₃.

In some aspects, R^{3a} can be ethoxy;
R^{3b} can be H; and
R⁴ and R⁵ can each be ethyl.

In some aspects, R^{3a} can be phenoxy;
R^{3b} can be H; and
R⁴ and R⁵ can each be ethyl.

In some aspects, R^{3a} can be fluoro;
R^{3b} can be H; and
R⁴ and R⁵ can each be —CH₂C(═O)OCH₂CH₃.

In certain aspects, the minus-violet dye of Formula II can be a compound as set forth in Table 1, above.

The present disclosure also provides minus-violet dyes according to Formula III. Dyes according to Formula III can have either E or Z geometry, or can be a mixture of compounds having E and Z geometry:

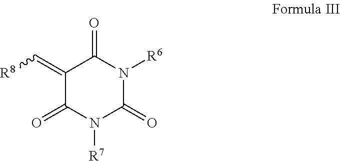

In some aspects, R⁶ can be H, C₁-C₆ alkyl, —(CH₂)ₙO(CH₂)ₘCH₃, C₃-C₁₂ cycloalkyl, C₆-C₁₀ aryl, or C₆-C₁₀ arylene-C₁-C₄ alkyl;
R⁷ can be H, C₁-C₆ alkyl, —(CH₂)ₙO(CH₂)ₘCH₃, C₃-C₁₂ cycloalkyl, C₆-C₁₀ aryl, C₆-C₁₀ arylene-C₁-C₄ alkyl, or C₁-C₁₂ alkylene-R¹²;
n at each occurrence can, independently, be an integer from 1 to 6;
m at each occurrence can, independently, be an integer from 0 to 3;
R⁸ can be

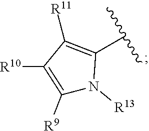

R⁹, R¹⁰, and R¹¹ can each, independently, be C₁-C₆ alkyl, C₃-C₁₂ cycloalkyl, C₆-C₁₀ aryl, or C₆-C₁₀ arylene-C₁-C₄ alkyl;
R¹³ can be H, C₁-C₆ alkyl, C₁-C₆ haloalkyl, C₁-C₆ cyanoalkyl, C₁-C₆ alkylene-C₆-C₁₀ aryl, C₁-C₆ alkylene-OC(═O)R¹⁴, or C₁-C₁₂ alkylene-R¹⁵;
R¹² can be

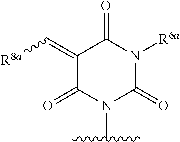

provided that when R⁷ is C₁-C₁₂ alkylene-R¹², R^{8a} is identical to R¹ and R^{6a} is identical to R⁶;
R¹⁴ can be C₁-C₆ alkyl; and
R¹ can be

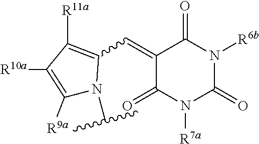

provided that when R¹³ is C₁-C₁₂ alkylene-R¹⁵, R^{9a} is identical to R⁹, R^{10a} is identical to R¹⁰, R^{11a} is identical to R¹¹, R^{6b} is identical to R⁶, and R^{7a} is identical to R⁷.

In some aspects, R⁶ can be methyl, 3-methoxypropyl, cyclohexyl, phenyl, or 3-tert-butylphenyl;
R⁷ can be methyl, 3-methoxypropyl, cyclohexyl, phenyl, 3-tert-butylphenyl, or hexylene-R¹²;
R⁹ can be H, methyl, tert-butyl, or —CH₂C(═O)OCH₂CH₃;
R¹⁰ can be H, tert-butyl, or —CH₂C(═O)OCH₂CH₃;
R¹¹ can be H or methyl; and
R¹³ can be H, methyl, n-butyl, cyanomethyl, —CH₂C(═O)OCH₂CH₃, benzyl, 2-napthalenylmethyl, or hexylene-R⁵.

In some aspects, R⁶ and R⁷ can each be methyl, cyclohexyl, phenyl, or 3-tert-butylphenyl.

In some aspects, R⁶ can be 3-methoxypropyl and R⁷ can be phenyl.

In some aspects, R⁶ can be cyclohexyl and R⁷ can be phenyl.

In some aspects, R⁶ can be 3-methoxypropyl or 3-tert-butylphenyl and R⁷ can be hexylene-R¹².

In some aspects, R⁸ can be:

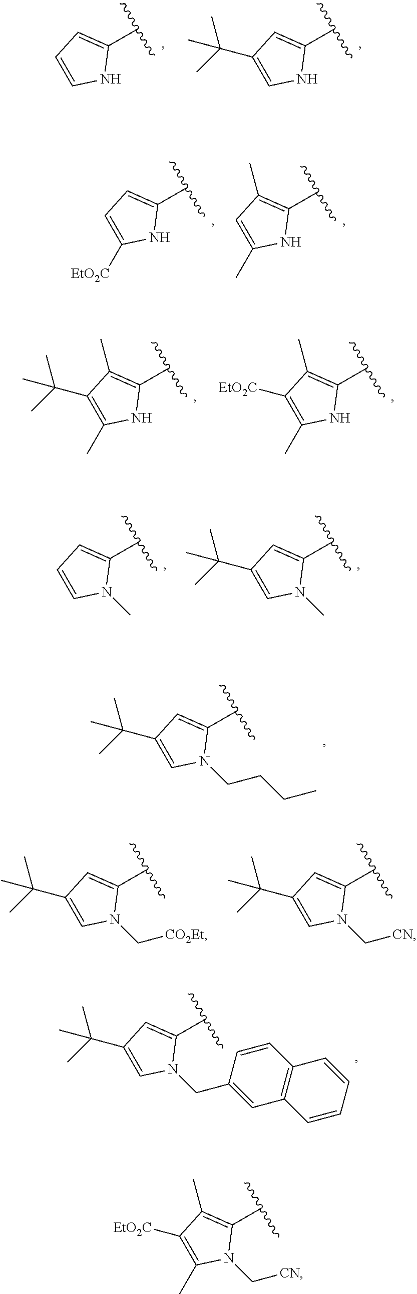

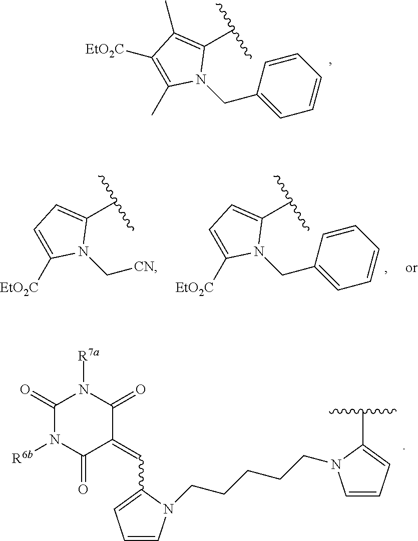

As is apparent from the present disclosure, certain compounds of Formula III can exhibit geometric isomerism, that is, certain compounds have double bonds that can have either “E” or “Z” geometry. If the geometry of a compound disclosed herein is not specified, it is to be understood that the compound is a mixture of E and Z geometric isomers. In some aspects, the compound is a mixture having a ratio of E/Z geometric isomers of from about 1:99 to about 99:1; from about 20:80 to about 80:20; from about 25:75 to about 75:25; from about 40:60 to about 60:40; or about 50:50.

In certain aspects, the minus-violet dye of Formula III can be a compound as set forth in Table 2a and Table 2b, above.

In another aspect, the present disclosure also encompasses intermediates suitable for preparing the compounds according to Formula III, such as compounds according to Formula VIIa:

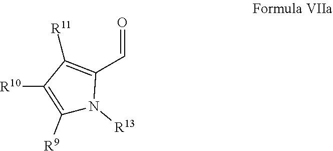

wherein
R⁶ is selected from the group consisting of H, C₁-C₆ alkyl, —(CH₂)ₙO(CH₂)ₘCH₃, C₃-C₁₂ cycloalkyl, phenyl, and phenylene-C₁-C₄ alkyl;
R⁷ is selected from the group consisting of H, C₁-C₆ alkyl, —(CH₂)ₙO(CH₂)ₘCH₃, C₃-C₁₂ cycloalkyl, phenyl, phenylene-C₁-C₄ alkyl, and C₁-C₁₂ alkylene-R¹²;
n at each occurrence is independently an integer from 1 to 6;
m at each occurrence is independently an integer from 0 to 3;

R⁸ is

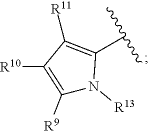

R⁹, R¹⁰, and R¹¹ are each independently selected from the group consisting of C₁-C₆ alkyl, C₃-C₁₂ cycloalkyl, phenyl, and phenylene-C₁-C₄ alkyl;
R¹³ is selected from the group consisting of H, C₁-C₆ alkyl, C₁-C₆ haloalkyl, C₁-C₆ cyanoalkyl, C₁-C₆ alkylene-C₆-C₁₀ aryl, C₁-C₆ alkylene-OC(═O)R¹⁴, and C₁-C₁₂ alkylene-R¹⁵;
R¹² is

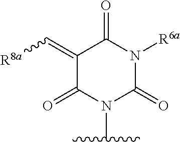

provided that when R⁷ is C₁-C₁₂ alkylene-R¹², R^{8a} is identical to R¹ and R^{6a} is identical to R⁶;
R¹⁴ is C₁-C₆ alkyl; and
R¹⁵ is

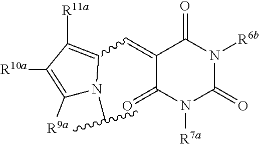

provided that when R¹³ is C₁-C₁₂ alkylene-R¹, R^{9a} is identical to R⁹, R^{10a} is identical to R¹⁰, R^{11a} is identical to R¹¹, R^{6b is} identical to R⁶, and R^{7a} is identical to R⁷.

In some aspects, the compound of Formula VIIa is a compound of Table 4, below.

TABLE 4
Representative Compounds of Formula VIIa.

| Cmpd | | |
|---|---|---|
| No. | Cmpd name | Structure |
| 43 | 1-methyl-1H-pyrrole-2- carbaldehyde | 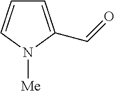 |
| 44 | 4-(tert-butyl)-1-methyl- 1H-pyrrole-2- carbaldehyde | 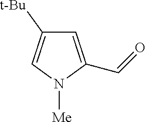 [SMILES: Cn1cc(C(C)(C)C)cc1C=O] |
| 45 | 4-(tert-butyl)-1-butyl- 1H-pyrrole-2- carbaldehyde | 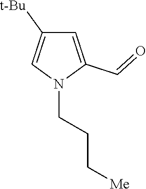 [SMILES: CCCCn1cc(C(C)(C)C)cc1C=O] |
| 46 | 4-(tert-butyl)-1- (naphthalen-2-ylmethyl)- 1H-pyrrole-2- carbaldehyde | 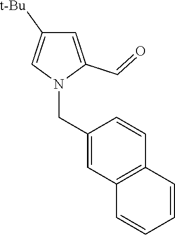 [SMILES: CC(C)(C)c1cc(C=O)n(Cc2ccc3ccccc3c2)c1] |
| 47 | ethyl 2-(4-(tert-butyl)-2- formyl-1H-pyrrol-1- yl)acetate | 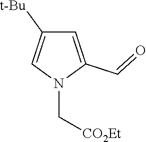 [SMILES: CCOC(=O)Cn1cc(C(C)(C)C)cc1C=O] |
| 48 | 2-(4-(tert-butyl)-2- formyl-1H-pyrrol-1- yl)acetonitrile | 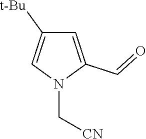 [SMILES: CC(C)(C)c1cc(C=O)n(CC#N)c1] |
| 49 | ethyl 1-(cyanomethyl)-5- formyl-2,4-dimethyl-1H- pyrrole-3-carboxylate | 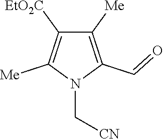 [SMILES: CCOC(=O)c1c(C)c(C=O)n(CC#N)c1C] |
| 50 | ethyl 1-benzyl-5-formyl- 2,4-dimethyl-1H-pyrrole- 3-carboxylate | 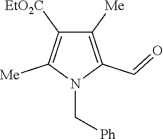 [SMILES: CCOC(=O)c1c(C)c(C=O)n(Cc2ccccc2)c1C] |
| 51 | ethyl 1-(cyanomethyl)-5- formyl-1H-pyrrole-2- carboxylate | 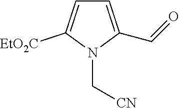 [SMILES: CCOC(=O)c1ccc(C=O)n1CC#N] |
| 52 | ethyl 1-benzyl-5-formyl- 1H-pyrrole-2- carboxylate | 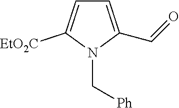 [SMILES: CCOC(=O)c1ccc(C=O)n1Cc1ccccc1] |
| 53 | 4-(tert-butyl)-3,5- dimethyl-1H-pyrrole-2- carbaldehyde | 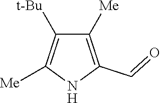 [SMILES: Cc1[nH]c(C=O)c(C)c1C(C)(C)C] |

In another aspect, the present disclosure also encompasses intermediates suitable for preparing the compounds according to Formula III, such as compounds according to Formula IX:

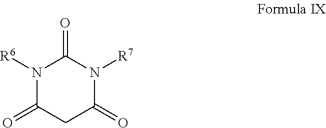

wherein
R⁶ is selected from the group consisting of H, C₁-C₆ alkyl, —(CH₂)ₙO(CH₂)ₘCH₃, C₃-C₁₂ cycloalkyl, phenyl, and phenylene-C₁-C₄ alkyl;
R⁷ is selected from the group consisting of H, C₁-C₆ alkyl, —(CH₂)ₙO(CH₂)ₘCH₃, C₃-C₁₂ cycloalkyl, phenyl, phenylene-C₁-C₄ alkyl, and C₁-C₁₂ alkylene-R¹²;
n at each occurrence is independently an integer from 1 to 6;
m at each occurrence is independently an integer from 0 to 3;
R⁸ is

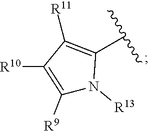

R⁹, R¹⁰, and R¹¹ are each independently selected from the group consisting of C₁-C₆ alkyl, C₃-C₁₂ cycloalkyl, phenyl, and phenylene-C₁-C₄ alkyl;
R¹³ is selected from the group consisting of H, C₁-C₆ alkyl, C₁-C₆ haloalkyl, C₁-C₆ cyanoalkyl, C₁-C₆ alkylene-C₆-C₁₀ aryl, C₁-C₆ alkylene-OC(═O)R¹⁴, and C₁-C₁₂ alkylene-R¹⁵;
R¹² is

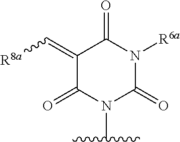

provided that when R⁷ is C₁-C₁₂ alkylene-R¹², R^{8a} is identical to R⁸ and R^{6a} is identical to R⁶;
R¹⁴ is C₁-C₆ alkyl; and
R¹⁵ is

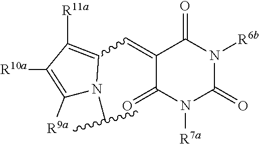

provided that when R¹³ is C₁-C₁₂ alkylene-R, R^{9a} is identical to R⁹, R^{10a} is identical to R¹⁰, R^{11a} is identical to R¹¹, R^{6b} is identical to R⁶, and R^{7a} is identical to R⁷.

In some aspects, the compound of Formula IX is a compound of Table 5, below.

TABLE 5
Representative Compounds of Formula IX

| Cmpd | | |
|---|---|---|
| No. | Cmpd name | Structure |
| 59 | 1,3-diphenylpyrimidine- 2,4,6(1H,3H,5H)-trione | 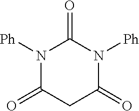 [SMILES: O=C1CC(=O)N(c2ccccc2)C(=O)N1c1ccccc1] |
| 60 | 1,3-bis(3-(tert- butyl)phenyl)pyrimidine- 2,4,6(1H,3H,5H)-trione | 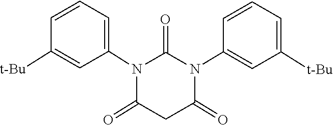 |
| 61 | 1,3-dicyclohexylpyrimidine- 2,4,6(1H,3H,5H)-trione | 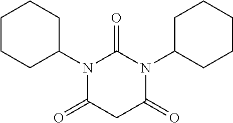 [SMILES: O=C1CC(=O)N(C2CCCCC2)C(=O)N1C1CCCCC1] |
| 62 | 1-cyclohexyl-3-phenylpyrimidine- 2,4,6(1H,3H,5H)-trione | 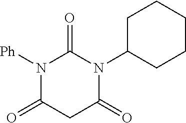 [SMILES: O=C1CC(=O)N(C2CCCCC2)C(=O)N1c1ccccc1] |
| 63 | 1-(3-methoxypropyl)-3- phenylpyrimidine-2,4,6(1H,3H,5H)- trione | 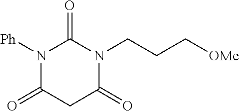 [SMILES: COCCCN1C(=O)CC(=O)N(c2ccccc2)C1=O] |

| | |
|---|---|
| 64 | 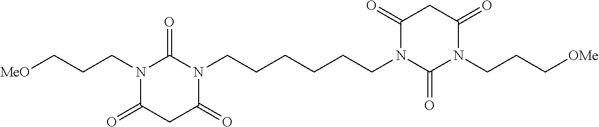 [SMILES: COCCCN1C(=O)CC(=O)N(CCCCCCN2C(=O)CC(=O)N(CCCOC)C2=O)C1=O] |
| | 3,3′-(hexane-1,6-diyl)bis(1-(3-methoxypropyl)pyrimidine- |
| | 2,4,6(1H,3H,5H)-trione) |
| 65 | 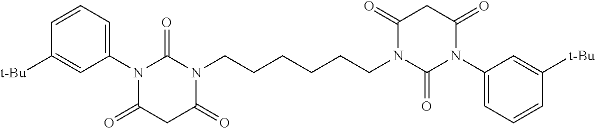 [SMILES: CC(C)(C)c1cccc(N2C(=O)CC(=O)N(CCCCCCN3C(=O)CC(=O)N(c4cccc(C(C)(C)C)c4)C3=O)C2=O)c1] |
| | 3,3′-(hexane-1,6-diyl)bis(1-(3-(tert-butyl)phenyl)pyrimidine- |
| | 2,4,6(1H,3H,5H)-trione) |

In another aspect, the present disclosure also encompasses intermediates suitable for preparing the compounds according to Formula III, such as compounds according to Formula X:

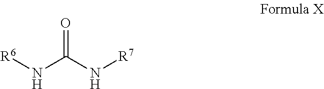

wherein
R⁶ is selected from the group consisting of H, C₁-C₆ alkyl, —(CH₂)ₙO(CH₂)ₘCH₃, C₃-C₁₂ cycloalkyl, phenyl, and phenylene-C₁-C₄ alkyl;
R⁷ is selected from the group consisting of H, C₁-C₆ alkyl, —(CH₂)ₙO(CH₂)ₘCH₃, C₃-C₁₂ cycloalkyl, phenyl, and phenylene-C₁-C₄ alkyl;
n at each occurrence is independently an integer from 1 to 6; and
m at each occurrence is independently an integer from 0 to 3.

In some aspects, the compound of Formula X is a compound of Table 6, below.

TABLE 6
Representative Compounds of Formula X

| Cmpd | | |
|---|---|---|
| No. | Cmpd name | Structure |
| 54 | 1,3-diphenylurea | 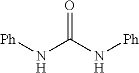 [SMILES: O=C(Nc1ccccc1)Nc1ccccc1] |
| 55 | 1,3-bis(3-(tert- butyl)phenyl)urea | 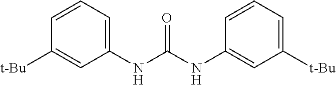 [SMILES: CC(C)(C)c1cccc(NC(=O)Nc2cccc(C(C)(C)C)c2)c1] |
| 56 | 1,3-dicyclohexylurea | 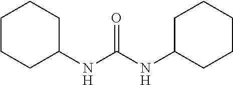 [SMILES: O=C(NC1CCCCC1)NC1CCCCC1] |
| 57 | 1-cyclohexyl-3-phenylurea | 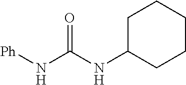 [SMILES: O=C(Nc1ccccc1)NC1CCCCC1] |
| 58 | 1-(3-methoxypropyl)-3- phenylurea | 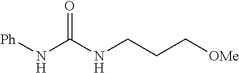 [SMILES: COCCCNC(=O)Nc1ccccc1] |

### Methods of Making Minus-Violet Dyes

The present disclosure also provides methods of making a compound of Formula II. In certain aspects, the method comprises reacting a compound of Formula IV with malononitrile to provide a compound of Formula II, such as in Scheme 1, below.

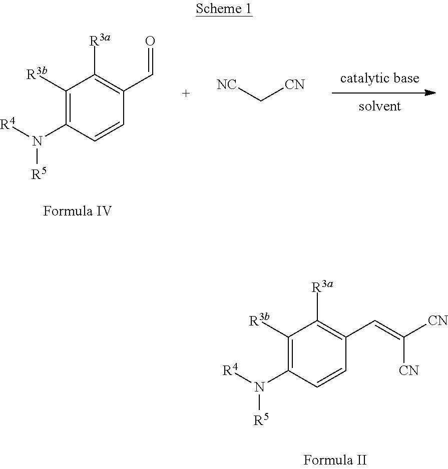

In some aspects of the reaction for preparing compounds of Formula II, each of the R groups specified in Scheme 1 has the same meaning as specified elsewhere herein. In some aspects of the reaction for preparing compounds of Formula II, R^{3a} and R^{3b} can each, independently, be H, C₁-C₄ alkyl, C₁-C₄ alkoxy, phenoxy, hydroxyl, or halo;
R⁴ and R⁵ can each, independently, be C₁-C₆ alkyl, C₁-C₆ haloalkyl, C₁-C₆ cyanoalkyl, phenyl, C₁-C₆ alkylene-C(═O)OR^{4a}, C₁-C₆ alkylene-C(═O)R^{4a}, or C₁-C₆ alkylene-OC(═O)NR^{4a}R^{4b}; or
R⁴ and R⁵ can be taken together with the nitrogen atom to which they are attached to form an optionally substituted 4- to 7-membered heterocycle;
R^{4a} can each, independently, be C₁-C₆ alkyl or phenyl; and
R^{4b} can independently at each occurrence be H or C₁-C₄ alkyl.

In some aspects of the reaction for preparing compounds of Formula II, R^{3a} can be H, methyl, methoxy, ethyloxy, phenoxy, hydroxyl, fluoro, or bromo;
R^{3b} can be H; and
R⁴ and R⁵ can each, independently be methyl, ethyl, n-butyl, phenyl, 3-cyanopropyl, —CH₂C(═O)OCH₂CH₃, —CH₂CH₂C(═O)CH₃ or —CH₂CH₂OC(═O)NHPh; or
R⁴ and R⁵ can be taken together with the nitrogen atom to which they are attached to form a pyrrolidinyl group.

In some aspects, the reaction of the compound of Formula IV with malononitrile can take place in a solvent selected from the group consisting of methanol, ethanol, chloroform, dichloromethane, ethyl acetate, hexane, cyclohexyl methyl ether, and toluene. In particular aspects, the solvent is ethanol.

In some aspects, the reaction of the compound of Formula IV with malononitrile takes place in the presence of a catalytic amount of base. In certain aspects, the base is selected from the group consisting of piperidine and pyridine. In other aspects, the base used in the reaction of the compound of Formula IV with malononitrile is piperidine.

In some aspects, the reaction of the compound of Formula IV with malononitrile is performed at a temperature of about 40° C. to about 60° C., for example about 40° C., about 45° C., about 50° C., about 55° C., or about 60° C.

In some aspects, the method of making the dye of Formula II further comprises making a compound of Formula IV. In some aspects, the method of making the compound of Formula IV comprises reacting a compound of Formula V with an acid chloride, e.g., POCl₃, and formamide in a Vilsmeier-Haack reaction to provide a compound of Formula IV, e.g., as shown in Scheme 2.

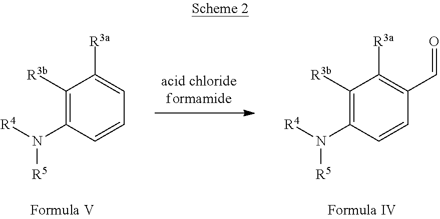

In some aspects of the reaction for preparing compounds of Formula IV, each of the R groups specified in Scheme 2 has the same meaning as specified elsewhere herein. In some aspects of the reaction for preparing compounds of Formula IV, R^{3a} and R^{3b} can each, independently, be H, C₁-C₄ alkyl, C₁-C₄ alkoxy, phenoxy, hydroxyl, or halo;
R⁴ and R⁵ can each, independently, be C₁-C₆ alkyl, C₁-C₆ haloalkyl, C₁-C₆ cyanoalkyl, phenyl, C₁-C₆ alkylene-C(═O)OR^{4a}, C₁-C₆ alkylene-C(═O)R^{4a}, or C₁-C₆ alkylene-OC(═O)NR^{4a}R^{4b}; or
R⁴ and R⁵ can be taken together with the nitrogen atom to which they are attached to form an optionally substituted 4- to 7-membered heterocycle;
R^{4a} can each, independently, be C₁-C₆ alkyl or phenyl; and
R^{4b} can independently at each occurrence be H or C₁-C₄ alkyl.

In some aspects of the reaction for preparing compounds of Formula IV, R^{3a} can be H, methyl, methoxy, ethyloxy, phenoxy, hydroxyl, fluoro, or bromo;
R^{3b} can be H; and
R⁴ and R⁵ can each, independently be methyl, ethyl, n-butyl, phenyl, 3-cyanopropyl, —CH₂C(═O)OCH₂CH₃, —CH₂CH₂C(═O)CH₃ or —CH₂CH₂OC(═O)NHPh; or
R⁴ and R⁵ can be taken together with the nitrogen atom to which they are attached to form a pyrrolidinyl group.

In some aspects, reacting a compound of Formula V with an acid chloride in a Vilsmeier-Haack reaction to provide a compound of Formula IV can take place in a solvent selected from the group consisting of N,N-dimethylformamide, dichloromethane, and chloroform. In particular aspects, the solvent is N,N-dimethylformamide.

In some aspects, reacting a compound of Formula V with an acid chloride and formamide in a Vilsmeier-Haack reaction to provide a compound of Formula IV is performed at a temperature of about 20° C. to about 80° C., for example about 20° C., about 25° C., about 30° C., about 35° C., about 40° C., about 45° C., about 50° C., about 55° C., about 60° C., about 65° C., about 70° C., about 75° C., or about 80° C.

In some aspects of reacting a compound of Formula V with an acid chloride in a Vilsmeier-Haack reaction to provide a compound of Formula IV, the acid chloride is POCl₃, SOCl₂, or oxalyl chloride. In some aspects, the acid chloride is POCl₃.

In some aspects, the method of making the dye of Formula II further comprises making a compound of Formula V. In certain aspects, the method of making the compound of Formula V comprises reacting a compound of Formula VI with an alkylating agent, e.g., an alkyl halide, in the presence of a base, and optionally in the presence of a catalytic amount of KI, to provide a compound of Formula V, such as in Scheme 3, below.

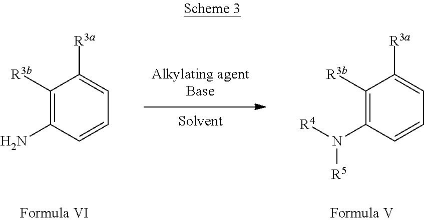

In some aspects of the reaction for preparing compounds of Formula V, each of the R groups specified in Scheme 3 has the same meaning as specified elsewhere herein.

In some aspects of the reaction for preparing compounds of Formula V, the alkylating agent can have the formula R⁴—X, R⁵—X, or X—C₁-C₆ alkyl-X wherein each X can be a leaving group such as halo, e.g., chloro, bromo, or iodo; mesylate, or tosylate. In some aspects, each X is chloro, bromo, or iodo.

In some aspects of the reaction for preparing compounds of Formula V, R⁴ is equivalent to R⁵.

In some aspects of the reaction for preparing compounds of Formula V, R⁴ is not equivalent to R⁵, and the reaction is performed sequentially by adding i) about one molar equivalent of a first alkylating agent having the formula R⁴—X followed by ii) about one molar equivalent of a second alkylating agent having the R⁵—X.

In some aspects of the reaction for preparing compounds of Formula V, R^{3a} and R^{3b} can each, independently, be H, C₁-C₄ alkyl, C₁-C₄ alkoxy, phenoxy, hydroxyl, or halo;
R⁴ and R⁵ can each, independently, be C₁-C₆ alkyl, C₁-C₆ haloalkyl, C₁-C₆ cyanoalkyl, phenyl, C₁-C₆ alkylene-C(═O)OR^{4a}, C₁-C₆ alkylene-C(═O)R^{4a}, or C₁-C₆ alkylene-OC(═O)NR^{4a}R^{4b}; or
when the alkylating agent is X—C₁-C₆ alkyl-X, R⁴ and R⁵ can be taken together with the nitrogen atom to which they are attached to form an optionally substituted 4- to 7-membered heterocycle;
R^{4a} can each, independently, be C₁-C₆ alkyl or phenyl; and
R^{4b} can independently at each occurrence be H or C₁-C₄ alkyl.

In some aspects of the reaction for preparing compounds of Formula V, R^{3a} can be H, methyl, methoxy, ethyloxy, phenoxy, hydroxyl, fluoro, or bromo;
R^{3b} can be H; and
R⁴ and R⁵ can each, independently be methyl, ethyl, n-butyl, phenyl, 3-cyanopropyl, —CH₂C(═O)OCH₂CH₃, —CH₂CH₂C(═O)CH₃ or —CH₂CH₂OC(═O)NHPh; or
when the alkylating agent is X—C₄ alkyl-X, R⁴ and R⁵ can be taken together with the nitrogen atom to which they are attached to form a pyrrolidinyl group.

In some aspects, the reaction for preparing compounds of Formula V can take place in the presence of a base. In certain aspects, the base can be a carbonate, e.g., potassium carbonate (K₂CO₃), an amine, e.g., triethylamine, or a hydride, e.g., sodium hydride.

In some aspects, the reaction for preparing compounds of Formula V can take place in the presence of potassium iodide (KI).

In some aspects, the reaction for preparing compounds of Formula V can take place in a solvent selected from the group consisting of acetonitrile, N,N-dimethylformamide, dimethylsulfoxide, and tetrahydrofuran. In some aspects, the reaction for preparing compounds of Formula V can take place in N,N-dimethylformamide.

The present disclosure also provides methods of making a compound of Formula III. In certain aspects, the method comprises reacting a compound of Formula VII with a compound of Formula IX to provide a compound of Formula III, such as in Scheme 4, below.

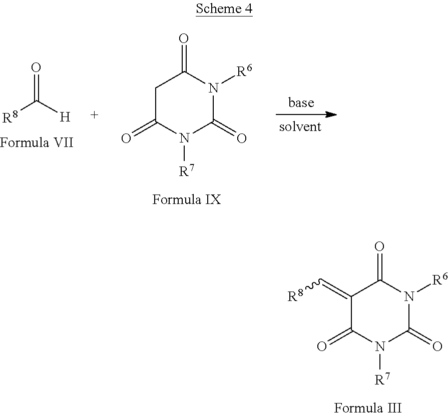

In some aspects of the reaction for preparing compounds of Formula III, each of the R groups specified in Scheme 4 has the same meaning as specified elsewhere herein. In some aspects of the reaction for preparing compounds of Formula III, R⁶ can be H, C₁-C₆ alkyl, —(CH₂)ₙO(CH₂)ₘCH₃, C₃-C₁₂ cycloalkyl, phenyl, or phenylene-C₁-C₄ alkyl;
R⁷ can be H, C₁-C₆ alkyl, —(CH₂)ₙO(CH₂)ₘCH₃, C₃-C₁₂ cycloalkyl, phenyl, phenylene-C₁-C₄ alkyl, or C₁-C₁₂ alkylene-R¹²;
n at each occurrence can be an integer from 1 to 6;
m at each occurrence can be an integer from 0 to 3;
R⁸ can be

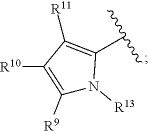

R⁹, R¹⁰, and R¹¹ can each, independently be C₁-C₆ alkyl, C₃-C₁₂ cycloalkyl, phenyl, or phenylene-C₁-C₄ alkyl;
R¹³ can be H, C₁-C₆ alkyl, C₁-C₆ haloalkyl, C₁-C₆ cyanoalkyl, C₁-C₆ alkylene-C₆-C₁₀ aryl, C₁-C₆ alkylene-OC(═O)R¹⁴, or C₁-C₁₂ alkylene-R¹⁵;
R¹² can be

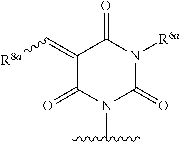

provided that when R⁷ is C₁-C₁₂ alkylene-R¹², R^{8a} is identical to R¹ and R^{6a} is identical to R⁶;
R¹⁴ can be C₁-C₆ alkyl; and
R⁵ can be

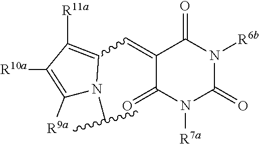

provided that when R¹³ is C₁-C₁₂ alkylene-R¹⁵, R^{9a} is identical to R⁹, R^{10a} is identical to R¹⁰, R^{10a} is identical to R¹¹, R^{6b} is identical to R⁶, and R^{7a} is identical to R⁷.

In some aspects of the reaction for preparing compounds of Formula III, R⁶ can be methyl, 3-methoxypropyl, cyclohexyl, phenyl, or 3-tert-butylphenyl;
R⁷ can be methyl, 3-methoxypropyl, cyclohexyl, phenyl, 3-tert-butylphenyl, or hexylene-R¹²;
R⁹ can be H, methyl, tert-butyl, or —CH₂C(═O)OCH₂CH₃;
R¹⁰ can be H, tert-butyl, or —CH₂C(═O)OCH₂CH₃; R¹¹ can be H or methyl; and
R¹³ can be H, methyl, n-butyl, cyanomethyl, —CH₂C(═O)OCH₂CH₃, benzyl, 2-napthalenylmethyl, or hexylene-R¹.

In some aspects, the reaction for preparing compounds of Formula III can take place in the presence of a catalytic amount of base. In certain aspects, the base is selected from the group consisting of piperidine and pyridine. In other aspects, the base used in the reaction for preparing compounds of Formula III can be piperidine.

In some aspects, the reaction for preparing compounds of Formula III can take place in a solvent selected from the group consisting of methanol, ethanol, dichloromethane, chloroform, ethyl acetate, cyclopentyl methyl ether, and toluene. In particular aspects, the solvent is ethanol.

In some aspects, the reaction for preparing compounds of Formula III can be performed at a temperature of about 20° C. to about 60° C., for example about 20° C., about 25° C., about 30° C., about 35° C., about 40° C., about 45° C., about 50° C., about 55° C., or about 60° C.

In some aspects, the method of making a compound of Formula III further comprises making a compound of Formula VII, e.g., a compound of Formula VIIa. In certain aspects, the method comprises reacting a 2-formylpyrrole derivative, e.g., a compound of Formula VIIb, with an alkyl halide in the presence of a base and, optionally, in the presence of KI, to provide a compound of Formula VIIa, such as in Scheme 5, below.

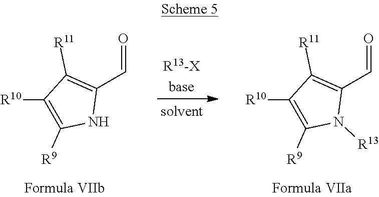

In some aspects of the reaction for preparing compounds of Formula VIIa, each of the R groups specified in Scheme 5 has the same meaning as specified elsewhere herein. For the avoidance of doubt, Formula VIIa is the same as Formula VII, except that R⁸ has been drawn expressly.

In some aspects of the reaction for preparing compounds of Formula VIIa, X can be a leaving group such as halo, e.g., chloro, bromo, or iodo; mesylate, or toslyate. In some aspects, X is chloro, bromo, or iodo.

In some aspects, the reaction for preparing compounds of Formula VIIa can be performed at a temperature of about 40° C. to about 80° C., for example about 40° C., about 45° C., about 50° C., about 55° C., about 60° C., about 65° C., about 70° C., about 75° C., or about 80° C.

In some aspects of the reaction for preparing compounds of Formula VIIa, R⁶ can be H, C₁-C₆ alkyl, —(CH₂)ₙO(CH₂)ₘCH₃, C₃-C₁₂ cycloalkyl, phenyl, or phenylene-C₁-C₄ alkyl;
R⁷ can be H, C₁-C₆ alkyl, —(CH₂)ₙO(CH₂)ₘCH₃, C₃-C₁₂ cycloalkyl, phenyl, phenylene-C₁-C₄ alkyl, or C₁-C₁₂ alkylene-R¹²;
n at each occurrence can be an integer from 1 to 6;
m at each occurrence can be an integer from 0 to 3;
R⁹, R¹⁰, and R¹¹ can each, independently be C₁-C₆ alkyl, C₃-C₁₂ cycloalkyl, phenyl, or phenylene-C₁-C₄ alkyl;
R¹³ can be H, C₁-C₆ alkyl, C₁-C₆ haloalkyl, C₁-C₆ cyanoalkyl, C₁-C₆ alkylene-C₆-C₁₀ aryl, C₁-C₆ alkylene-OC(═O)R¹⁴, or C₁-C₁₂ alkylene-R¹¹;
R¹² can be

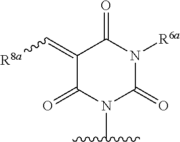

provided that when R⁷ is C₁-C₁₂ alkylene-R¹², R^{8a} is identical to R¹ and R^{6a} is identical to R⁶;
R¹⁴ can be C₁-C₆ alkyl; and
R¹⁵ can be

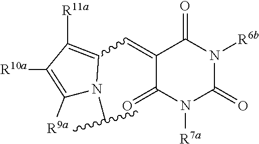

provided that when R¹³ is C₁-C₁₂ alkylene-R¹⁵, R^{9a} is identical to R⁹, R^{10a} is identical to R¹⁰, R^{11a} is identical to R¹¹, R^{6b} is identical to R⁶, and R^{7a} is identical to R⁷.

In some aspects of the reaction for preparing compounds of Formula VIIa, R⁶ can be methyl, 3-methoxypropyl, cyclohexyl, phenyl, or 3-tert-butylphenyl;
R⁷ can be methyl, 3-methoxypropyl, cyclohexyl, phenyl, 3-tert-butylphenyl, or hexylene-R¹²;
R⁹ can be H, methyl, tert-butyl, or —CH₂C(═O)OCH₂CH₃;
R¹⁰ can be H, tert-butyl, or —CH₂C(═O)OCH₂CH₃; R¹¹ can be H or methyl; and
R¹³ can be H, methyl, n-butyl, cyanomethyl, —CH₂C(═O)OCH₂CH₃, benzyl, 2-napthalenylmethyl, or hexylene-R¹.

In some aspects, the reaction for preparing compounds of Formula VIIa can take place in the presence of base. In certain aspects, the base can be a carbonate, e.g., potassium carbonate (K₂CO₃), an amine, e.g., triethylamine, or a hydride, e.g., sodium hydride.

In some aspects, the reaction for preparing compounds of Formula VIIa can take place in the presence of potassium iodide (KI).

In some aspects, the reaction for preparing compounds of Formula VIIa can take place in a solvent selected from the group consisting of acetonitrile, N,N-dimethylformamide, dimethylsulfoxide, and tetrahydrofuran. In some aspects, the reaction for preparing compounds of Formula VIIa can take place in acetonitrile.

In some aspects, the method of making the dye of Formula III further comprises making a compound of Formula IX. In certain aspects, the method of making the compound of Formula IX comprises reacting a urea derivative, e.g., a compound of Formula X, with malonyl chloride, such as in Scheme 6, below.

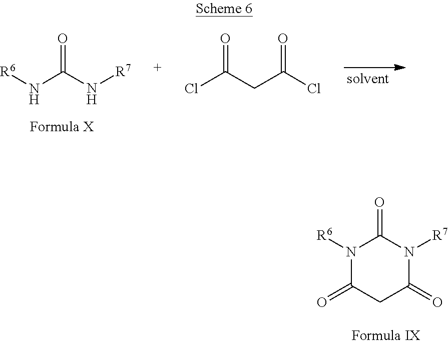

In some aspects of the reaction for preparing compounds of Formula IX, each of the R groups specified in Scheme 6 has the same meaning as specified elsewhere herein. In some aspects of the reaction for preparing compounds of Formula IX, R⁶ can be H, C₁-C₆ alkyl, —(CH₂)ₙO(CH₂)ₘCH₃, C₃-C₁₂ cycloalkyl, phenyl, or phenylene-C₁-C₄ alkyl;
R⁷ can be H, C₁-C₆ alkyl, —(CH₂)ₙO(CH₂)ₘCH₃, C₃-C₁₂ cycloalkyl, phenyl, phenylene-C₁-C₄ alkyl, or C₁-C₁₂ alkylene-R¹²;
n at each occurrence can be an integer from 1 to 6;
m at each occurrence can be an integer from 0 to 3;
R⁸ can be

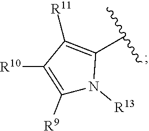

R⁹, R¹⁰, and R¹¹ are can each, independently, be C₁-C₆ alkyl, C₃-C₁₂ cycloalkyl, phenyl, or phenylene-C₁-C₄ alkyl;
R¹³ can be H, C₁-C₆ alkyl, C₁-C₆ haloalkyl, C₁-C₆ cyanoalkyl, C₁-C₆ alkylene-C₆-C₁₀ aryl, C₁-C₆ alkylene-OC(═O)R¹⁴, or C₁-C₁₂ alkylene-R¹¹;
R¹² can be

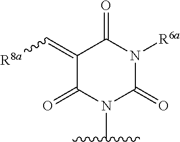

provided that when R⁷ is C₁-C₁₂ alkylene-R¹², R^{8a} is identical to R¹ and R^{6a} is identical to R⁶;
R¹⁴ can be C₁-C₆ alkyl; and
R¹⁵ can be

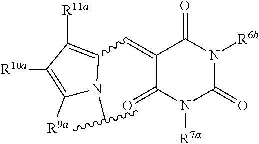

provided that when R¹³ is C₁-C₁₂ alkylene-R¹⁵, R^{9a} is identical to R⁹, R^{10a} is identical to R¹⁰, R^{1la} is identical to R¹¹, R^{6b} is identical to R⁶, and R^{7a} is identical to R⁷.

In some aspects of the reaction for preparing compounds of Formula IX, R⁶ can be methyl, 3-methoxypropyl, cyclohexyl, phenyl, or 3-tert-butylphenyl;
R⁷ can be methyl, 3-methoxypropyl, cyclohexyl, phenyl, 3-tert-butylphenyl, or hexylene-R¹²;
R⁹ can be H, methyl, tert-butyl, or —CH₂C(═O)OCH₂CH₃;
R¹⁰ can be H, tert-butyl, or —CH₂C(═O)OCH₂CH₃;
R¹¹ can be H or methyl; and
R¹³ can be H, methyl, n-butyl, cyanomethyl, —CH₂C(═O)OCH₂CH₃, benzyl, 2-napthalenylmethyl, or hexylene-R¹.

In some aspects, the reaction for preparing compounds of Formula IX can take place in a solvent selected from the group consisting of acetonitrile, N,N-dimethylformamide, dichloromethane, dimethylsulfoxide, and tetrahydrofuran. In some aspects, the reaction for preparing compounds of Formula IX can take place in chloroform.

In some aspects, the method of making the dye of Formula III further comprises making a compound of Formula X. In certain aspects, the method of making the compound of Formula X comprises reacting primary amines or anilines with carbonyl diimidazole, such as in Scheme 7, below, or reacting primary amines or anilines, e.g., a compound of Formula XI, with an isocyanate derivative, e.g., a compound of Formula XII, such as in Scheme 8, below.

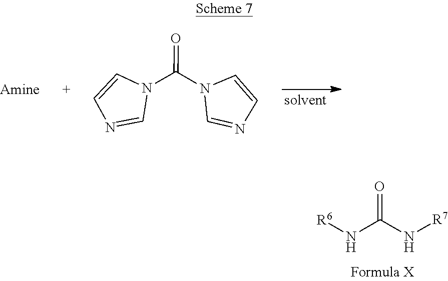

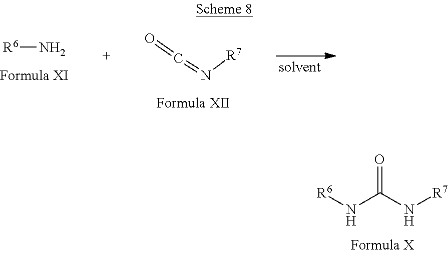

In some aspects of the reaction for preparing compounds of Formula X, each of the R groups specified in Schemes 7 and 8 has the same meaning as specified elsewhere herein.

In some aspects of the reaction for preparing compounds of Formula X, the amine specified as a reagent in Scheme 7 can have the formula R⁶—NH₂ or R⁷—NH₂. In some aspects, when the amine is R⁶—NH₂ or R⁷—NH₂, R⁶ and R⁷ in Formula X are equivalent.

In some aspects of the reaction for preparing compounds of Formula X, R⁶ can be H, C₁-C₆ alkyl, —(CH₂)ₙO(CH₂)ₘCH₃, C₃-C₁₂ cycloalkyl, phenyl, or phenylene-C₁-C₄ alkyl;
R⁷ can be H, C₁-C₆ alkyl, —(CH₂)ₙO(CH₂)ₘCH₃, C₃-C₁₂ cycloalkyl, phenyl, phenylene-C₁-C₄ alkyl, or C₁-C₁₂ alkylene-R¹²;
n at each occurrence can be an integer from 1 to 6;
m at each occurrence can be an integer from 0 to 3;
R⁸ can be

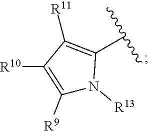

R⁹, R¹⁰, and R¹¹ can each, independently be C₁-C₆ alkyl, C₃-C₁₂ cycloalkyl, phenyl, or phenylene-C₁-C₄ alkyl;
R¹³ can be H, C₁-C₆ alkyl, C₁-C₆ haloalkyl, C₁-C₆ cyanoalkyl, C₁-C₆ alkylene-C₆-C₁₀ aryl, C₁-C₆ alkylene-OC(═O)R¹⁴, or C₁-C₁₂ alkylene-R¹⁵;
R¹² can be

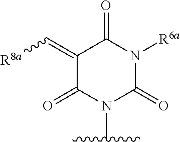

provided that when R⁷ is C₁-C₁₂ alkylene-R¹², R^{8a} is identical to R⁸ and R^{6a} is identical to R⁶;
R¹⁴ can be C₁-C₆ alkyl; and
R¹⁵ can be

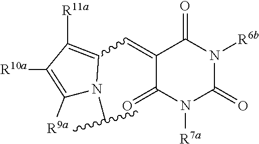

provided that when R¹³ is C₁-C₁₂ alkylene-R¹⁵, R^{9a} is identical to R⁹, R^{10a} is identical to R¹⁰, R^{11a} is identical to R¹¹, R^{6b} is identical to R⁶, and R^{7a} is identical to R⁷.

In some aspects, the reaction for preparing compounds of Formula X can take place in a solvent selected from the group consisting of acetonitrile, N,N-dimethylformamide, dichloromethane, dimethylsulfoxide, tetrahydrofuran, and cyclopentyl methyl ether (CPME). In some aspects, the reaction for preparing compounds of Formula X can take place in dichloromethane or CPME.

### EXAMPLES

The examples presented below is provided for the purpose of illustration only and the aspects described herein should in no way be construed as being limited to these examples. Rather, the aspects should be construed to encompass any and all variations which become evident as a result of the teaching provided herein.

### Example 1: Synthesis of Compounds of Formula II

### General Procedure A: Synthesis of Compounds of Formula IV

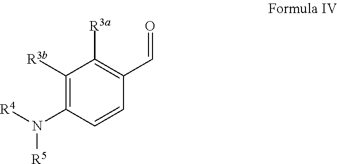

Aminobenzaldehyde derivatives of Formula IV, including 4-dimethylaminobenzaldeyde, 4-diethylaminobenzaldeyde, and 4-(1-pyrrolidino)benzaldehyde, were purchased from commercial sources such as Sigma-Aldrich or TCI. Additional aldehydes of Formula IV were prepared from commercially available starting materials using Routes A, B, or C, as described below. Commercially available aniline derivatives were alkylated and subsequently underwent formylation via the Vilsmeier-Haack reaction to provide the desired dialkylaminobenzaldehyde intermediates (Route A). Alternatively, 4-(diethylamino)salicylaldehyde was alkylated (Route B, via nucleophilic displacement of an alkyl iodide) or arylated (Route C, via Cu-catalyzed C—O coupling of an aryl iodide) to provide two aldehyde intermediates.

### Route A: Alkylation and Vilsmeier-Haack Reaction

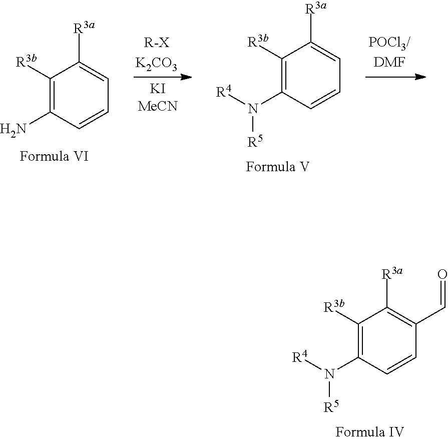

Routes B and C: Functionalization of 4-(diethylamino)salicylaldehyde

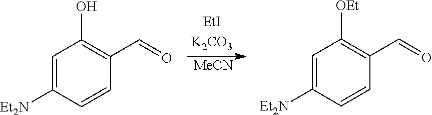

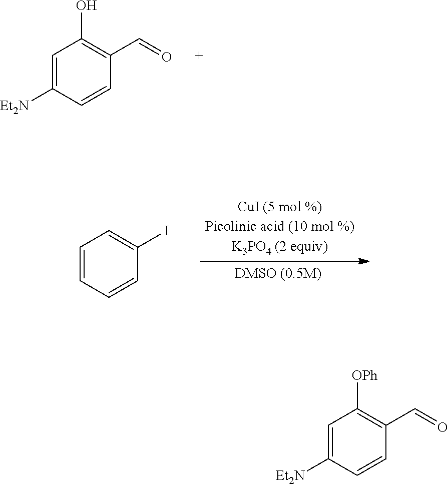

### General Procedure B: Synthesis of Compounds of Formula II

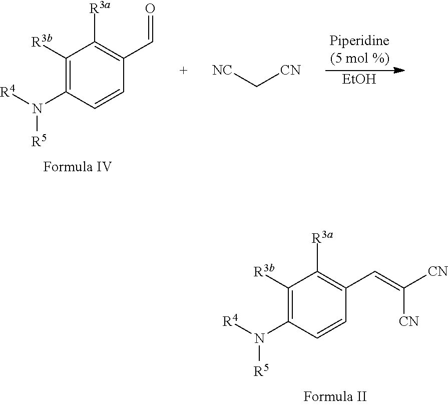

To a solution of malononitrile (1.0 to 1.2 equiv) in EtOH (0.5 M), warmed at 40 to 50° C. to dissolve malononitrile, added an aminobenzaldehyde derivative (e.g., of Formula IV) (1.0 equiv). A catalytic amount of piperidine (about 5 mol %) was added to the reaction. Typically, a yellow suspension rapidly formed. Heating was removed, and the reaction was stirred until full conversion of aldehyde was indicated by TLC and UV-vis spectroscopy. Reaction times were 1 h to 24 h. Typically, the dye products were isolated in high yield via vacuum filtration of the reaction mixture, washing the filter cake with EtOH and hexanes. In some cases, the crude solid was obtained via vacuum filtration, dissolved in CH₂Cl₂, and filtered through a silica plug. The filtrate was concentrated by rotary evaporation, suspended in EtOH, and collected via vacuum filtration to provide the desired product. Characterization data for the representative compounds are reported in Table 7.

TABLE 7
Representative compounds of Formula II prepared using general procedure.

| Cmpd | | | |
|---|---|---|---|
| No | Cmpd Name | Structure and Chemical Name | Characterization |
| 1 | 2-(4- (dimethylamino) benzylidene) malononitrile | 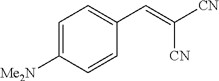 [SMILES: CN(C)c1ccc(C=C(C#N)C#N)cc1] | UV-vis (CH₂Cl₂): λₘₐₓ = 432.1 nm, FWHM = 45.5 nm. ¹H NMR (CDCl₃): 7.82 (d, |
| | | | 2H), 7.47 (s, 1H), |
| | | | 6.69 (d, 2H), 3.14 |
| | | | (s, 6H). |
| 2 | 2-(4- (diethylamino) benzylidene) malononitrile | 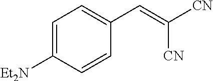 | UV-vis (CH₂Cl₂): λₘₐₓ = 438.1 nm, FWHM = 43.3 nm, ε_{g} = 275.0 L/gm-cm. ¹H NMR |
| | | | (CDCl₃): 7.79 (d, |
| | | | 2H), 7.43 (s, 1H), |
| | | | 6.67 (d, 2H), 3.47 |
| | | | (quart, 4H), 1.24 |
| | | | (t, 3H). |
| 3 | 2-(4-(pyrrolidin- 1- yl)benzylidene) malononitrile | 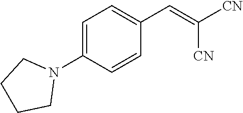 [SMILES: N#CC(C#N)=Cc1ccc(N2CCCC2)cc1] | UV-vis (CH₂Cl₂): λₘₐₓ = 439.5 nm, FWHM = 44.6 nm. ¹H NMR (CDCl₃): 7.80 (d, 2H), 7.44 (s, 1H), 6.56 (d, 2H), 3.44 |
| | | | (m, 4H), 2.08 (m, |
| | | | 4H). |
| 4 | 2-(4- (dimethylamino)- 2- methylbenzylidene) malononitrile | 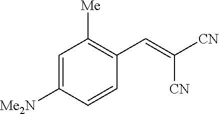 [SMILES: Cc1cc(N(C)C)ccc1C=C(C#N)C#N] | UV-vis (CH₂Cl₂): λₘₐₓ = 442.9 nm, FWHM = 46.7 nm. ¹H NMR (CDCl₃): 8.32 (d, 1H), 7.78 (s, 1H), 6.59 (dd, 1H), |
| | | | 6.47 (d, 1H), 3.14 |
| | | | (s, 3H), 2.40 (s, |
| | | | 3H). |
| 5 | 2-(4- (diethylamino)-2- ethoxybenzylidene) malononitrile | 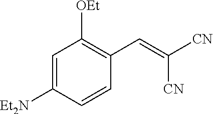 | UV-vis (CH₂Cl₂): λₘₐₓ = 444.0 nm, FWHM = 44.3 nm. ¹H NMR (CDCl₃): 8.24 (d, 1H), 8.05 (s, 1H), 6.33 (dd, 1H), |
| | | | 5.98 (d, 1H), 4.06 |
| | | | (quart, 2H), 3.45 |
| | | | (quart, 4H), 1.47 |
| | | | (t, 3H), 1.24 (t, |
| | | | 6H). |
| 6 | 2-(4- (diethylamino)-2- phenoxybenzylidene) malononitrile | 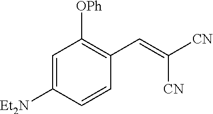 | UV-vis (CH₂Cl₂): λₘₐₓ = 439.4 nm, FWHM =43.2 nm. |
| 7 | diethyl 2,2′-((4- (2,2- dicyanovinyl) phenyl)azanediyl) diacetate | 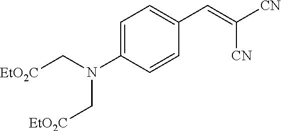 [SMILES: CCOC(=O)CN(CC(=O)OCC)c1ccc(C=C(C#N)C#N)cc1] | UV-vis (CH₂Cl₂): λₘₐₓ = 409.1 nm, FWHM = 48.4 nm. ¹H NMR (CDCl₃): 7.84 (d, 2H), 7.53 (s, 1H), 6.65 (s, 1H), 4.25 (quart, 4H), 4.21 |
| | | | (s, 4H), 1.30 (t, |
| | | | 6H) |
| 8 | diethyl 2,2′-((4- (2,2- dicyanovinyl)-3- methoxyphenyl) azanediyl)diacetate | 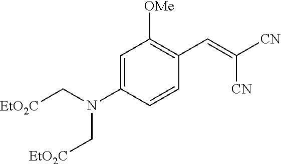 [SMILES: CCOC(=O)CN(CC(=O)OCC)c1ccc(C=C(C#N)C#N)c(OC)c1] | UV-vis (CH₂Cl₂): λₘₐₓ = 419.0 nm, FWHM = 51.4 nm. |
| 9 | diethyl 2,2′-((4- (2,2- dicyanovinyl)-3- fluorophenyl) azanediyl)diacetate | 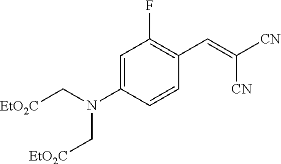 [SMILES: CCOC(=O)CN(CC(=O)OCC)c1ccc(C=C(C#N)C#N)c(F)c1] | UV-vis (CH₂Cl₂): λₘₐₓ = 405.6 nm, FWHM = 48.4 nm. |
| 10 | 2-(4-(bis(3- cyanopropyl)amino)- 2- methoxybenzylidene) malononitrile | 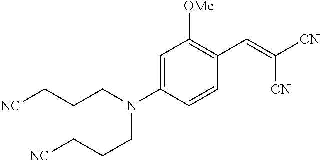 [SMILES: COc1cc(N(CCCC#N)CCCC#N)ccc1C=C(C#N)C#N] | UV-vis (CH₂Cl₂): λₘₐₓ = 429.6 nm, FWHM = 49.8 nm. |
| 11 | 2-((4-(2,2- dicyanovinyl)-3- methylphenyl) (ethyl)amino)ethyl phenylcarbamate | 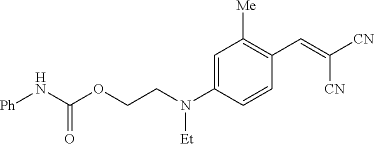 [SMILES: CCN(CCOC(=O)Nc1ccccc1)c1ccc(C=C(C#N)C#N)c(C)c1] | UV-vis (CH₂Cl₂): λₘₐₓ = 441.2 nm, FWHM = 47.1 nm, HWHM = 17.0 nm. ¹H NMR (CDCl₃): 8.31 (d, 1H), 7.77 (s, 1H), 7.28-7.39 (m, |
| | | | 4H), 7.10 (m, |
| | | | 1H), 6.67 (dd, |
| | | | 1H), 6.56 (d, 1H), |
| | | | 6.53 (br s, 1H), |
| | | | 4.35 (t, 2H), 3.72 |
| | | | (t, 2H), 3.53 |
| | | | (quart, 2H), 2.37 |
| | | | (s, 3H), 1.25 (t, |
| | | | 3H). |

### Example 2: Synthesis of Compounds of Formula III

### General Procedure C: Synthesis of Compounds of Formula VIa

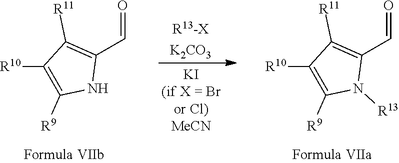

Pyrrole-substituted aldehyde derivatives of Formula VIIb including 2-formylpyrrole, 4-(tert-butyl)-1H-pyrrole-2-carbaldehyde, 3,5-dimethyl-1H-pyrrole-2-carbaldehyde, ethyl 5-formyl-2,4-dimethyl-1H-pyrrole-3-carboxylate, 5-formyl-2,4-dimethyl-1H-pyrrole-3-carboxylic acid, ethyl 5-formyl-1H-pyrrole-2-carboxylate, and N-(2-(diethylamino)ethyl)-5-formyl-2,4-dimethyl-1H-pyrrole-3-carboxamide were purchased from commercial sources such as Ambeed, Sigma-Aldrich, and TCI. Additional aldehydes of Formula VIIa were prepared from commercially available starting materials using the procedure described below. Characterization of representative compounds is summarized in Table 8.

To a round-bottom flask, added 2-formylpyrrole derivative (1 equiv), dry MeCN (0.3 M), oven-dried K₂CO₃ (3 equiv), alkyl halide (1.2 to 4.0 equiv), and KI (0.5 equiv if electrophile was alkyl bromide or chloride). Refluxed the mixture with vigorous stirring. Monitored reaction by TLC and ¹H NMR. Upon completion, the reaction was cooled. Reaction was diluted with EtOAc and H₂O, extracting the product into EtOAc (3×). The organic layers were combined, dried with MgSO₄, filtered, and concentrated by rotary evaporation. In some cases, the product could be precipitated from EtOH/hexanes and isolated via vacuum filtration. In most cases, the product was filtered through a silica plug, washing initial with hexanes to remove low polarity impurity before eluting product with CH₂C₁₂ or EtOAc.

TABLE 8
Representative compounds of Formula VIIa prepared.

| Cmpd | | | |
|---|---|---|---|
| No. | Cmpd name | Structure | Characterization |
| 43 | 1-methyl-1H-pyrrole-2- carbaldehyde | 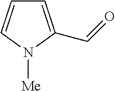 | Isolated 270 mg (84% yield) using iodomethane. ¹H NMR (CDCl₃): 9.55 (s, 1H), 6.92 (dd, 1H), 6.88 (br s, 1H), 6.21 (dd, 1H), 3.96 (s, 3H). |
| 44 | 4-(tert-butyl)-1-methyl- 1H-pyrrole-2- carbaldehyde | 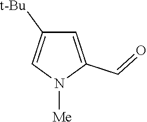 [SMILES: Cn1cc(C(C)(C)C)cc1C=O] | Isolated 548 mg (98% yield) using iodomethane. ¹H NMR (CDCl₃): 9.48 (s, 1H), 6.80 (m, 1H), 6.72 (s, 1H), 3.91 (s, 3H), 1.25 (s, 9H). |
| 45 | 4-(tert-butyl)-1-butyl- 1H-pyrrole-2- carbaldehyde | 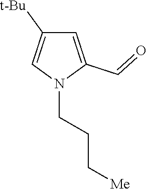 [SMILES: CCCCn1cc(C(C)(C)C)cc1C=O] | Isolated 231 mg (84% yield) using iodobutane. ¹H NMR (CDCl₃): 9.46 (s, 1H), 6.80 (s, 1H), 6.78 (s, 1H), 4.24 (t, 2H), 1.72 (quint, 2H), 1.33 (quint, 2H), 1.25 (s, 9H), 0.93 (t, 3H). |
| 46 | 4-(tert-butyl)-1- (naphthalen-2- ylmethyl)-1H-pyrrole- 2-carbaldehyde | 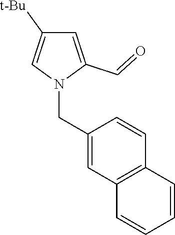 [SMILES: CC(C)(C)c1cc(C=O)n(Cc2ccc3ccccc3c2)c1] | Isolated 82 mg (31% yield) using 2- (chloromethyl)naphthalene. ¹H NMR (CDCl₃): 9.53 (s, 1H), 7.75-7.85 (m, 3H), 7.58 (s, 1H), 7.43-7.51 (m, 2H), 7.30 (d, 1H), 6.89 (s, 1H), 6.86 (s, 1H), 5.68 (s, 2H), 1.25 (s, 9H). |
| 47 | ethyl 2-(4-(tert-butyl)- 2-formyl-1H-pyrrol-1- yl)acetate | 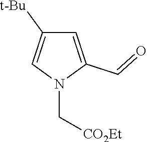 [SMILES: CCOC(=O)Cn1cc(C(C)(C)C)cc1C=O] | Isolated 389 mg (87% yield) using ethyl bromoacetate. ¹H NMR (CDCl₃): 9.46 (s, 1H), 6.87 (s, 1H), 6.74 (s, 1H), 4.99 (s, 2H), 4.15-4.30 (m, 2H), 1.28-1.32 (m, 3H), 1.26 (s, 9H). |
| 48 | 2-(4-(tert-butyl)-2- formyl-1H-pyrrol-1- yl)acetonitrile | 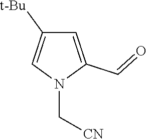 [SMILES: CC(C)(C)c1cc(C=O)n(CC#N)c1] | Isolated 72 mg (29% yield) using bromoacetonitrile. ¹H NMR (CDCl₃): 9.52 (s, 1H), 6.87-6.92 (m, 2H), 5.33 (s, 2H), 1.26 (s, 9H). |
| 49 | ethyl 1-(cyanomethyl)- 5-formyl-2,4-dimethyl- 1H-pyrrole-3- carboxylate | 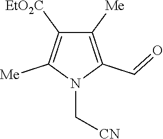 [SMILES: CCOC(=O)c1c(C)c(C=O)n(CC#N)c1C] | Isolated 125 mg (75% yield) using bromoacetonitrile. ¹H NMR (CDCl₃): 9.77 (s, 1H), 5.48 (s, 2H), 4.33 (quart, 2H), 2.65 (s, 3H), 2.54 (s, 3H), 1.38 (t, 3H). |
| 50 | ethyl 1-benzyl-5- formyl-2,4-dimethyl- 1H-pyrrole-3- carboxylate | 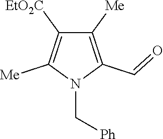 [SMILES: CCOC(=O)c1c(C)c(C=O)n(Cc2ccccc2)c1C] | Isolated 95 mg (43% yield) using benzyl bromide. ¹H NMR (CDCl₃): 9.79 (s, 1H), 7.18-7.35 (m, 3H - CDCl₃ overlap), 6.93-7.02 (m, 2H), 5.69 (s, 2H), 4.33 (quart, 2H), 2.59 (s, 3H), 2.49 (s, 3H), 1.38 (t, 3H). |
| 51 | ethyl 1-(cyanomethyl)- 5-formyl-1H-pyrrole-2- carboxylate | 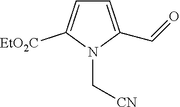 [SMILES: CCOC(=O)c1ccc(C=O)n1CC#N] | Isolated 157 mg (>99% yield) using bromoacetonitrile. ¹H NMR (CDCl₃): 9.74 (s, 1H), 7.05 (d, 1H), 7.00 (d, 1H), 5.92 (s, 2H), 4.40 (quart, 2H), 1.40 (t, 3H). |
| 52 | ethyl 1-benzyl-5- formyl-1H-pyrrole-2- carboxylate | 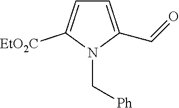 [SMILES: CCOC(=O)c1ccc(C=O)n1Cc1ccccc1] | Isolated 154 mg (85% yield) using benzyl bromide. ¹H NMR (CDCl₃): 9.73 (s, 1H), 7.17-7.43 (3H), 7.00-7.08 (m, 3H), 6.95-6.98 (m, 1H), 6.12 (s, 2H), 4.29 (quart, 2H), 1.32 (t, 3H). |
| 53 | 4-(tert-butyl)-3,5- dimethyl-1H-pyrrole-2- carbaldehyde | 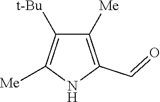 [SMILES: Cc1[nH]c(C=O)c(C)c1C(C)(C)C] | Isolated 762 mg (26% yield) via Vilsmeier-Haack reaction of 3-(tert- butyl)-2,4-dimethyl-1H-pyrrole with POCl₃/DMF. ¹H NMR (CDCl₃): 9.52 (s, 1H), 8.87 (br s, 1H), 2.43 (s, 3H), 2.39 (s, 3H), 1.36 (s, 9H). |

### General Syntheses of Compounds of Formula X

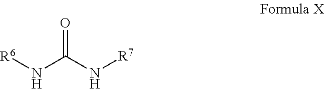

Ureas of the Formula X could be used as intermediates for the synthesis of barbituric acids. Symmetric ureas could be synthesized by reaction of primary amines or anilines with carbonyl diimidazole. Non-symmetric ureas can be synthesized by reaction of primary amines or anilines with isocyanate derivatives. Procedures for the preparation of symmetric (general procedure D) and non-symmetric (general procedure E) ureas are described below. Representative intermediates are summarized in Table 9.

### General Procedure D

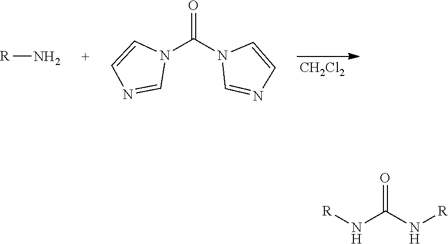

To a round bottom flask, added CDI (1.0 equiv) and CH₂C₁₂ (0.60 M). Then added primary amine (2.1 equiv). Stirred at rt for 2 to 18 h. The crude reaction mixture was concentrated by rotary evaporation, typically providing a solid. The crude solid was suspended in EtOH and collected by vacuum filtration, washing the solid with hexanes to provide product. Products were characterized (melting point or ¹H NMR).

### General Procedure E

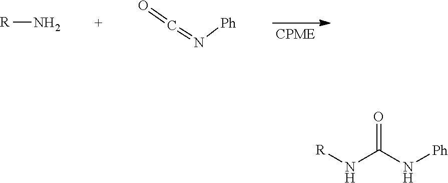

To a vial, added phenyl isocyanate (1 equiv). Dissolved in cyclopentyl methyl ether (CPME, 1.0 M). Then added primary amine (1.5 equiv). Stirred at rt. Monitored consumption of phenyl isocyanate by TLC. Upon completion, if a precipitate had formed, the reaction mixture was treated with EtOH, the resulting suspension was collected via vacuum filtration, and the solid was washed with hexanes to provide the desired product. If a precipitate did not form, the reaction mixture was concentrated by rotary evaporation. The crude mixture was then triturated with hexanes to provide the desired product.

TABLE 9
Representative compounds of Formula X prepared.

| Cmpd | | | |
|---|---|---|---|
| No. | Cmpd name | Structure | Characterization |
| 54 | 1,3-diphenylurea | 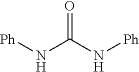 [SMILES: O=C(Nc1ccccc1)Nc1ccccc1] | Isolated 6.06 g (93% yield). Melting point: 240° C. |
| 55 | 1,3-bis(3-(tert- butyl)phenyl)urea | 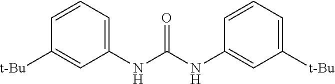 [SMILES: CC(C)(C)c1cccc(NC(=O)Nc2cccc(C(C)(C)C)c2)c1] | Isolated 877 mg (54% yield). ¹H NMR (CDCl₃): 7.32 (s, 2H), 7.28 (t, 2H), 7.14-7.23 (m, 2H), 6.62 (br s, 2H), 1.31 (s, 18H). |
| 56 | 1,3-dicyclohexylurea | 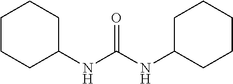 [SMILES: O=C(NC1CCCCC1)NC1CCCCC1] | Isolated 675 mg (60% yield). ¹H NMR (CDCl₃): 4.50 (m, 2H), 3.48 (m, 2H), 1.93 (m, 4H), 1.69 (m, 4H), 1.60 (m, 2H), 1.34 |
| | | | (m, 4H), 1.11 (m, 6H). |
| 57 | 1-cyclohexyl-3- phenylurea | 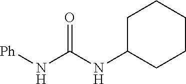 [SMILES: O=C(Nc1ccccc1)NC1CCCCC1] | Isolated 586 mg (64% yield). ¹H NMR (CDCl₃): 7.26-7.31 (m, 4H), 7.06 (m, 1H), 6.69 (br s, 1H), 4.92 (br s, 1H), |
| | | | 3.65 (m, 1H), 1.94 (m, |
| | | | 2H), 1.52-171 (m, 3H), |
| | | | 1.33 (m, 2H), 1.10 (m, |
| | | | 3H). |
| 58 | 1-(3-methoxypropyl)- 3-phenylurea | 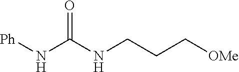 [SMILES: COCCCNC(=O)Nc1ccccc1] | Isolated 1.00 g (96% yield). ¹H NMR (CDCl₃): 7.29-7.37 (m, 4H), 7.11 (m, 1H), 7.01 (br s, |
| | | | 1H), 5.65 (br s, 1H), |
| | | | 3.51 (m, 2H), 3.41 (m, |
| | | | 2H), 3.33 (m, 3H), 1.84 |
| | | | (m, 2H). |

### Synthesis of Compounds of Formula IX

Barbituric acids of Formula IX were used as intermediates for the synthesis of dyes of formula III. N,N-dimethylbarbituric acid was purchased from commercial vendor Sigma-Aldrich. Additional monomeric barbituric acids of Formula IX were prepared from isolated ureas shown in Table 5 using the following general procedure F. Dimeric barbituric acids were prepared via procedure G. Table 10 summarizes monomeric and dimeric barbituric acids so prepared.

### General Procedure F

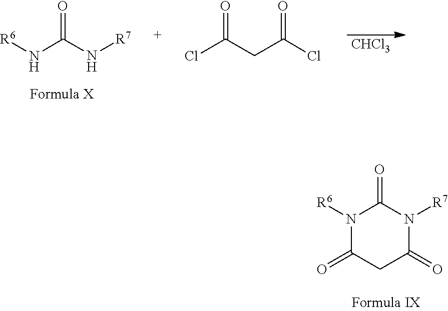

To a vial, added urea (1 equiv) and dry CHCl₃ (0.12 to 0.20 M). Then treated with malonyl chloride (1.05 equiv). Heated the mixture at 50° C. Monitored reaction conversion by TLC. If necessary, added additional malonyl chloride (0.05 equiv at a time) until full conversion was observed. Upon completion, added MeOH to quench excess malonyl chloride. Concentrated reaction mixture by rotary evaporation. Suspension in MeOH/hexanes mixture, filtered by vacuum filtration, washed the solid with hexanes, and dried under vacuum. Products were characterized by ¹H NMR.

Alternatively, dimeric barbituric acid intermediates could be prepared via the treatment of bis(urea) intermediates—generated in situ via reaction of primary amines or anilines with commercially available diisocyanates—with malonyl dichloride. A procedure for the one-pot, two-step synthesis of dimeric barbituric acids is shown below.

### Procedure G

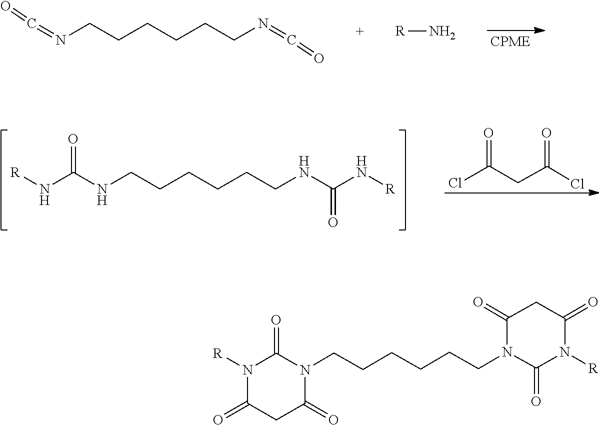

To a vial, added hexamethylene diisocyanate (1 equiv, liquid, added by mass) and CPME (0.2 M). Added amine (2 equiv). Typically, suspension rapidly formed. Stirred with heating at 85° C. After 3 h, cool to rt. Added CHCl₃ (about equal volume as CPME) to improve solubility of bis(urea) intermediate. Added malonyl chloride (2.1 equiv). Heated mixture at 60° C. overnight. Quenched reaction with EtOH. Stripped mixture to viscous oil. Confirmed formation of product by ¹H NMR. Used product as crude mixture without further purification.

TABLE 10
Representative compounds of Formula IX prepared.

| Cmpd | | | |
|---|---|---|---|
| No. | Cmpd name | Structure | Characterization |
| 59 | 1,3-diphenylpyrimidine- 2,4,6(1H,3H,5H)-trione | 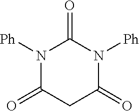 [SMILES: O=C1CC(=O)N(c2ccccc2)C(=O)N1c1ccccc1] | Isolated 5.18 g (78% yield). ¹H NMR (CDCl₃): 7.42-7.58 (m, 8H), 7.26-7.28 (m, 2H), 4.05 (s, 2H). |
| 60 | 1,3-bis(3-(tert- butyl)phenyl)pyrimidine- 2,4,6(1H,3H,5H)-trione | 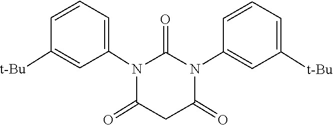 | Isolated 420 mg (91% yied). ¹H NMR (CDCl₃): 7.38-7.39 (m, 4H), 7.24 (s, 2H), 7.08 (d, 2H), 4.05 (s, 2H), 1.33 (s, 18H). |
| 61 | 1,3- dicyclohexylpyrimidine- 2,4,6(1H,3H,5H)-trione | 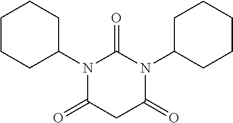 [SMILES: O=C1CC(=O)N(C2CCCCC2)C(=O)N1C1CCCCC1] | Isolated 489 mg (75% yield). ¹H NMR (CDCl₃): 4.59 (m, 2H), 3.60 (s, 2H), 2.25 (m, 4H), 1.83 (m, 4H), 1.63 (m, 8H), 1.27 (m, 6H). |
| 62 | 1-cyclohexyl-3- phenylpyrimidine- 2,4,6(1H,3H,5H)-trione | 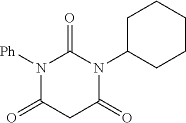 [SMILES: O=C1CC(=O)N(C2CCCCC2)C(=O)N1c1ccccc1] | Isolated 619 mg (>99% yield). ¹H NMR (CDCl₃): 7.41-7.52 (m, 3H), 7.19 (d, 2H), 4.66 (m, 1H), 3.83 (s, 2H), 2.27 (quart, 2H), 1.60-1.88 (m, 3H), 1.34 (quart, 2H), 1.18 (m, 1H). |
| 63 | 1-(3-methoxypropyl)-3- phenylpyrimidine- 2,4,6(1H,3H,5H)-trione | 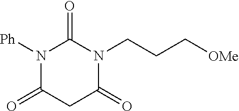 [SMILES: COCCCN1C(=O)CC(=O)N(c2ccccc2)C1=O] | Isolated 1.10 g (99% yield). ¹H NMR (CDCl₃): 7.43-7.54 (m, 3H), 7.20 (d, 2H), 4.06 (t, 2H), 3.84 (s, 2H), 3.46 (t, 2H), 3.30 (s, 3H), 1.93 (quint, 2H). |

| | | |
|---|---|---|
| 64 | 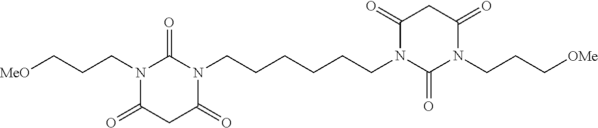 [SMILES: COCCCN1C(=O)CC(=O)N(CCCCCCN2C(=O)CC(=O)N(CCCOC)C2=O)C1=O] 3,3′-(hexane-1,6-diyl)bis(1-(3-methoxypropyl)pyrimidine-2,4,6(1H,3H,5H)-trione) | Isolated 1.43 g (>100% yield, crude). Used without further purification. ¹H NMR (CDCl₃): 3.99 (t, 4H), 3.85 (t, 4H), 3.64 (s, 4H), 3.43 (t, 4H), 3.28 (s, 6H), 1.87 (m, 4H), 1.26 (m, 4H). |
| 65 | 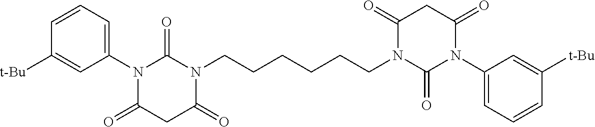 [SMILES: CC(C)(C)c1cccc(N2C(=O)CC(=O)N(CCCCCCN3C(=O)CC(=O)N(c4cccc(C(C)(C)C)c4)C3=O)C2=O)c1] 3,3′-(hexane-1,6-diyl)bis(1-(3-(tert-butyl)phenyl)pyrimidine-2,4,6(1H,3H,5H)-trione) | Isolated 1.24 g (>100% yield, crude). Used without further purification. ¹H NMR (CDCl₃): 7.38-7.50 (m, 4H), 7.16 (s, 2H), 6.99 (d, 2H), 3.90 (t, 3H), 3.81 (s, 4H), 1.65 (m, 4H), 1.31-1.35 (m, |
| | | 22H). |

### General Procedure H. Synthesis of Compounds of Formula III

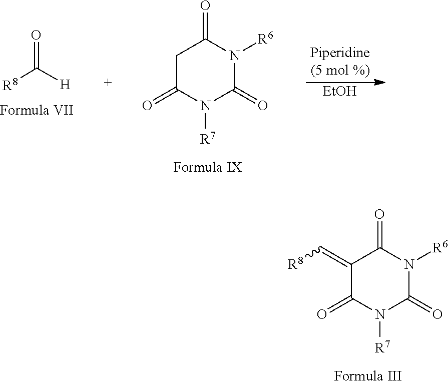

To a mixture of pyrrole-substituted aldehyde (e.g., a compound of Formula VII) (1 equiv) in EtOH (0.5 M), added barbituric acid (e.g., a compound of Formula IX) (1.0 to 1.2 equiv). A catalytic amount of piperidine (about 5 mol %) was added. The mixture was heated at 50° C., and reaction progress was monitored by TLC and UV-vis spectroscopy for consumption of starting material. Upon completion, the product was isolated by various standard methods. In most cases, the product precipitated from the reaction mixture and could be isolated by vacuum filtration. If a precipitate was not formed, the product may be precipitated by suspension in EtOH/hexanes. If a precipitate could not be obtained, the product could be purified via silica chromatography to provide the desired product. Characterization data for the representative compounds are reported in Table 11.

TABLE 11
Representative compounds of Formula III prepared using General Procedure H.

| Cmpd | | | |
|---|---|---|---|
| No. | Cmpd Name | Structure | Characterization |
| 12 | 5-((1H-pyrrol-2- yl)methylene)-1,3- dimethylpyrimidine- 2,4,6(1H,3H,5H)-trione | 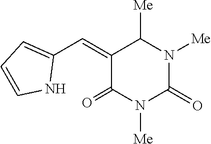 [SMILES: CC1/C(=C/c2ccc[nH]2)C(=O)N(C)C(=O)N1C] | UV-vis (CH₂Cl₂): λₘₐₓ = 408.4 nm, FWHM = 37.2 nm, HWHM = 11.8 nm, ε_{g} = 221.3 L/g-cm. ¹H NMR (CDCl₃): 13.28 (br s, 1H), 8.35 (s, 1H), 7.41 (br s, 1H), 7.15 (m, 1H), 6.55 (m, 1H), 3.43 (s, 3H), 3.41 (s, 3H). Melting point: 152 ° C. |
| 13 | 5-((1H-pyrrol-2- yl)methylene)-1,3- diphenylpyrimidine- 2,4,6(1H,3H,5H)-trione | 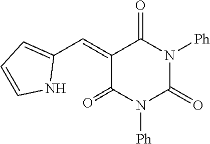 [SMILES: O=C1C(=Cc2ccc[nH]2)C(=O)N(c2ccccc2)C(=O)N1c1ccccc1] | UV-vis (CH₂Cl₂): λₘₐₓ = 412.4 nm, FWHM = 36.9 nm, HWHM = 12.6 nm. ¹H NMR (CDCl₃): 13.14 (br s, 1H), 8.45 (s, 1H), 7.28-7.56 (m, 12H), 6.55 (m, 1H). |
| 14 | 5-((1H-pyrrol-2- yl)methylene)-1,3- dicyclohexylpyrimidine- 2,4,6(1H,3H,5H)-trione | 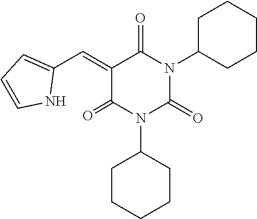 [SMILES: O=C1C(=Cc2ccc[nH]2)C(=O)N(C2CCCCC2)C(=O)N1C1CCCCC1] | UV-vis (CH₂Cl₂): λₘₐₓ = 407.5 nm, FWHM = 39.7 nm, HWHM = 12.6 nm. ¹H NMR (CDCl₃): 13.20 (br s, 1H), 8.30 (s, 1H), 7.37 (br s, 1H), 7.09 (m, 1H), 6.51 (m, 1H), 4.77 (m, 2H), 2.38 (m, 4H), 1.85 (m, 4H), 1.68 (m, 6H), 1.20-1.44 (m, 6H). |
| 15 | 5-((1H-pyrrol-2- yl)methylene)-1,3-bis(3- (tert- butyl)phenyl)pyrimidine- 2,4,6(1H,3H,5H)-trione | 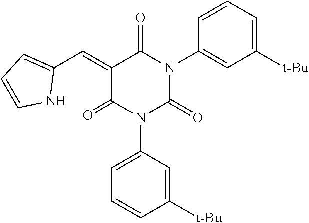 [SMILES: CC(C)(C)c1cccc(N2C(=O)C(=Cc3ccc[nH]3)C(=O)N(c3cccc(C(C)(C)C)c3)C2=O)c1] | UV-vis (CH₂Cl₂): λₘₐₓ = 411.8 nm, FWHM = 34.5 nm, HWHM = 11.1 nm. ¹H NMR (CDCl₃): 13.17 (br s, 1H), 8.46 (s, 1H), 7.28-7.53 (m, 7H), 7.10- 7.19 (m, 3H), 6.54 (m, 1H), 1.35 (s, 9H), 1.34 (s, 9H). |
| 16 | 5-((1H-pyrrol-2- yl)methylene)-1-(3- methoxypropyl)-3- phenylpyrimidine- 2,4,6(1H,3H,5H)-trione | 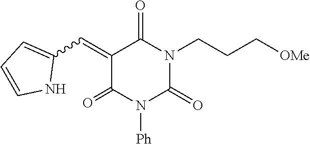 [SMILES: COCCCN1C(=O)C(=Cc2ccc[nH]2)C(=O)N(c2ccccc2)C1=O] | UV-vis (CH₂Cl₂): λₘₐₓ = 410.3 nm, FWHM = 36.2 nm, HWHM = 11.7 nm. ¹H NMR (CDCl₃): 13.35 (br s, 1H), 8.36 (s, 1H), 7.50 (t, 2H), 7.40-7.46 (m, 2H), 7.24 (m, 1H), 7.15 (m, 1H), 4.16 (t, 2H), 3.50 (t, 2H), 3.34 |
| | | | (s, 3H). |
| 17 | 5-((4-(tert-butyl)-1H- pyrrol-2-yl)methylene)- 1,3-dimethylpyrimidine- 2,4,6(1H,3H,5H)-trione | 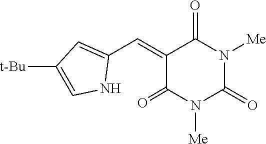 [SMILES: CN1C(=O)C(=Cc2cc(C(C)(C)C)c[nH]2)C(=O)N(C)C1=O] | UV-vis (CH₂Cl₂): λₘₐₓ = 420.9 nm, FWHM = 35.4 nm, HWHM = 11.6 nm, ε_{g} = 196.5 L/g-cm. ¹H NMR (CDCl₃): 13.18 (br s, 1H), 8.27 (s, 1H), 7.30 (s, 1H), 6.99 (m, 1H), 3.42 (s, 3H), 3.40 (s, 3H), 1.30 (s, 9H). |
| 18 | 5-((3,5-dimethyl-1H- pyrrol-2-yl)methylene)- 1,3-dimethylpyrimidine- 2,4,6(1H,3H,5H)-trione | 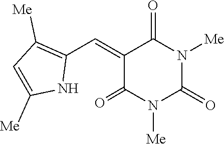 [SMILES: Cc1cc(C)c(C=C2C(=O)N(C)C(=O)N(C)C2=O)[nH]1] | UV-vis (CH₂Cl₂): λₘₐₓ = 427.3 nm, FWHM = 27.1 nm, HWHM = 8.7 nm, ε_{g} = 279.3 L/g-cm. ¹H NMR (CDCl₃): 13.24 (br s, 1H), 8.26 (s, 1H), 6.17 (s, 1H), 3.42 (s, 3H), 3.40 (s, 3H), 2.44 (s, 3H), 2.38 (s, 3H). |
| 19 | 5-((3,5-dimethyl-1H- pyrrol-2-yl)methylene)- 1,3-diphenylpyrimidine- 2,4,6(1H,3H,5H)-trione | 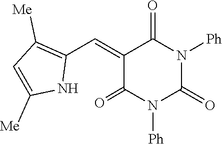 [SMILES: Cc1cc(C)c(C=C2C(=O)N(c3ccccc3)C(=O)N(c3ccccc3)C2=O)[nH]1] | UV-vis (CH₂Cl₂): λₘₐₓ = 428.9 nm, FWHM = 25.6 nm, HWHM = 8.2 nm. ¹H NMR (CDCl₃): 12.97 (br s, 1H), 8.36 (s, 1H), 7.29-7.57 (m, 10H), 6.17 (s, 1H), 2.36 (s, 6H). |
| 20 | 1,3-dicyclohexyl-5-((3,5- dimethyl-1H-pyrrol-2- yl)methylene)pyrimidine- 2,4,6(1H,3H,5H)-trione | 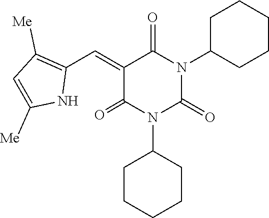 [SMILES: Cc1cc(C)c(C=C2C(=O)N(C3CCCCC3)C(=O)N(C3CCCCC3)C2=O)[nH]1] | UV-vis (CH₂Cl₂): λₘₐₓ = 427.8 nm, FWHM = 29.5 nm, HWHM = 9.5 nm. MS (APCI+): 398.3 m/z. |
| 21 | 1,3-bis(3-(tert- butyl)phenyl)-5-((3,5- dimethyl-1H-pyrrol-2- yl)methylene)pyrimidine- 2,4,6(1H,3H,5H)-trione | 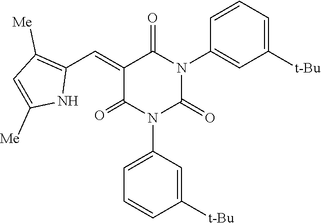 [SMILES: Cc1cc(C)c(C=C2C(=O)N(c3cccc(C(C)(C)C)c3)C(=O)N(c3cccc(C(C)(C)C)c3)C2=O)[nH]1] | UV-vis (CH₂Cl₂): λₘₐₓ = 429.1 nm, FWHM = 25.9 nm, HWHM = 8.3 nm. ¹H NMR (CDCl₃): 12.98 (br s, 1H), 8.37 (s, 1H), 7.37-7.50 (m, 4H), 7.34 (s, 1H), 7.30 (s, 1H), 7.18 (d, 1H), 7.13 (d, 1H), 2.34-2.38 (m, 6H), 1.36 (s, 9H), 1.33 (s, 9H). |
| 22 | 1-cyclohexyl-5-((3,5- dimethyl-1H-pyrrol-2- yl)methylene)-3- phenylpyrimidine- 2,4,6(1H,3H,5H)-trione | 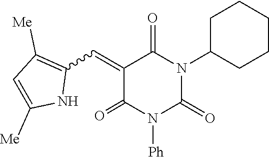 [SMILES: Cc1cc(C)c(C=C2C(=O)N(c3ccccc3)C(=O)N(C3CCCCC3)C2=O)[nH]1] | UV-vis (CH₂Cl₂): λₘₐₓ = 428.7 nm, FWHM = 27.3 nm, HWHM = 8.8 nm. ¹H NMR (CDCl₃): 13.14/12.94 (two br s, 1H total), 8.35/8.28 (two br s, 1H total), 7.24-7.57 (m, 5H), 6.17/6.14 (two m, 1H total), 4.84 (m, |
| | | | 1H), 2.26-2.50 (m, 8H), |
| | | | 1.18-1.89 (m, 8H). |
| 23 | 5-((3,5-dimethyl-1H- pyrrol-2-yl)methylene)- 1-(3-methoxypropyl)-3- phenylpyrimidine- 2,4,6(1H,3H,5H)-trione | 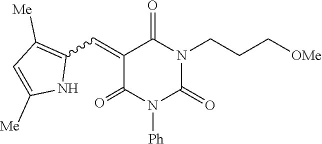 [SMILES: COCCCN1C(=O)C(=Cc2[nH]c(C)cc2C)C(=O)N(c2ccccc2)C1=O] | UV-vis (CH₂Cl₂): λₘₐₓ = 428.6 nm, FWHM = 26.4 nm, HWHM = 8.6 nm. ¹H NMR (CDCl₃): 12.94 (br s, 1H), 8.34 (s, 1H), 7.54 (t, 2H), 7.47 (t, 1H), 7.29 (d, 2H), 6.15 (s, 1H), 4.12 (t, 2H), 3.49 (t, 2H), 3.33 (s, |
| | | | 3H), 2.39 (s, 3H), 2.33 |
| | | | (s, 3H), 1.99 (quint, 2H). |
| 24 | 5-((4-(tert-butyl)-3,5- dimethyl-1H-pyrrol-2- yl)methylene)-1,3- dimethylpyrimidine- 2,4,6(1H,3H,5H)-trione | 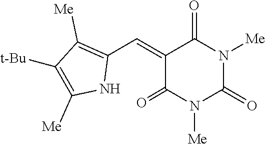 [SMILES: Cc1[nH]c(C=C2C(=O)N(C)C(=O)N(C)C2=O)c(C)c1C(C)(C)C] | UV-vis (CH₂Cl₂): λₘₐₓ = 436.6 nm, FWHM = 28.8 nm, HWHM = 8.9 nm, ε_{g} = 157.5 L/g-cm. ¹H NMR (CDCl₃): 13.54 (br s, 1H), 8.32 (s, 1H), 3.41 (s, 3H), 3.40 (s, 3H), 2.57 (s, 3H), 2.47 (s, 3H), 1.40 (s, 9H). |
| 25 | ethyl 5-((1,3-dimethyl- 2,4,6- trioxotetrahydropyrimidin- 5(2H)-ylidene)methyl)- 2,4-dimethyl-1H-pyrrole- 3-carboxylate | 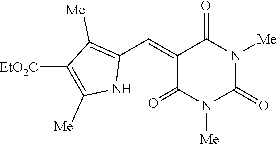 [SMILES: CCOC(=O)c1c(C)[nH]c(C=C2C(=O)N(C)C(=O)N(C)C2=O)c1C] | UV-vis (CH₂Cl₂): λₘₐₓ = 424.3 nm, FWHM = 33.7 nm, HWHM = 10.9 nm. ¹H NMR (CDCl₃): 13.51 (br s, 1H), 8.42 (s, 1H), 4.33 (quart, 2H), 3.42 (s, 3H), 3.41 (s, 3H), 2.67 (s, 3H), 2.60 (s, 3H), 1.39 (t, 3H). |
| 26 | ethyl 2,4-dimethyl-5- ((2,4,6-trioxo-1,3- diphenyltetrahydropyrimidin- 5(2H)- ylidene)methyl)-1H- pyrrole-3-carboxylate | 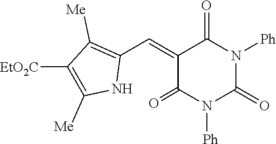 [SMILES: CCOC(=O)c1c(C)[nH]c(C=C2C(=O)N(c3ccccc3)C(=O)N(c3ccccc3)C2=O)c1C] | UV-vis (CH₂Cl₂): λₘₐₓ = 427.1 nm, FWHM = 30.4 nm, HWHM = 10.4 nm. ¹H NMR (CDCl₃): 13.21 (br s, 1H), 8.54 (s, 1H), 7.29-7.58 (m, 10H), 4.33 (quart, 2H), 2.60 (s, 6H), 1.38 (t, 3H). |
| 27 | ethyl 5-((1,3-dimethyl- 2,4,6- trioxotetrahydropyrimidin- 5(2H)-ylidene)methyl)- 1H-pyrrole-2-carboxylate | 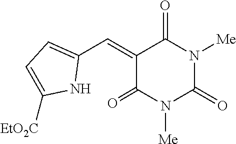 [SMILES: CCOC(=O)c1ccc(C=C2C(=O)N(C)C(=O)N(C)C2=O)[nH]1] | UV-vis (CH₂Cl₂): λₘₐₓ = 410.2 nm, FWHM = 48.9 nm, HWHM = 13.8 nm. ¹H NMR (CDCl₃): 13.50 (br s, 1H), 8.33 (s, 1H), 7.00-7.06 (m, 2H), 4.43 (quart, 2H), 3.45 (s, 3H), 3.41 (s, 3H), 1.42 (t, 3H). |
| 28 | ethyl 5-((2,4,6-trioxo- 1,3- diphenyltetrahydropyrimidin- 5(2H)- ylidene)methyl)-1H- pyrrole-2-carboxylate | 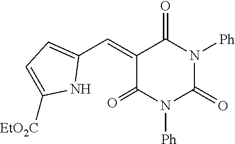 [SMILES: CCOC(=O)c1ccc(C=C2C(=O)N(c3ccccc3)C(=O)N(c3ccccc3)C2=O)[nH]1] | UV-vis (CH₂Cl₂): λₘₐₓ = 415.4 nm, FWHM = 45.7 nm, HWHM = 12.4 nm. ¹H NMR (CDCl₃): 13.19 (br s, 1H), 8.45 (s, 1H), 7.41-7.55 (m, 6H), 7.32 (t, 4H), 7.06-7.10 (m, 1H), 7.00-7.04 (m, 1H), 4.37 (quart, 2H), 1.35 (t, 3H). |
| 29 | 1,3-dimethyl-5-((1- methyl-1H-pyrrol-2- yl)methylene)pyrimidine- 2,4,6(1H,3H,5H)-trione | 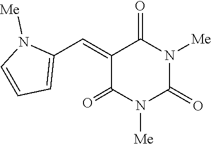 [SMILES: CN1C(=O)C(=Cc2cccn2C)C(=O)N(C)C1=O] | UV-vis (CH₂Cl₂): λₘₐₓ = 413.1 nm, FWHM = 40.1 nm, HWHM = 12.6 nm. ¹H NMR (CDCl₃): 8.61 (d, 1H), 8.46 (s, 1H), 7.21 (br s, 1H), 6.43 (dd, 1H), 3.90 (s, 3H), 3.41 (s, 3H), 3.40 (s, 3H). |
| 30 | 5-((4-(tert-butyl)-1- methyl-1H-pyrrol-2- yl)methylene)-1,3- dimethylpyrimidine- 2,4,6(1H,3H,5H)-trione | 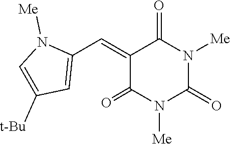 [SMILES: CN1C(=O)C(=Cc2cc(C(C)(C)C)cn2C)C(=O)N(C)C1=O] | UV-vis (CH₂Cl₂): λₘₐₓ = 425.0 nm, FWHM = 38.6 nm, HWHM = 11.9 nm, ε_{g} = 176.7 L/g-cm. ¹H NMR (CDCl₃): 8.48 (s, 1H), 8.40 (s, 1H), 7.11 (s, 1H), 3.86 (s, 3H), 3.41 (m, 6H), 1.30 (s, 9H). |
| 31 | 5-((4-(tert-butyl)-1-butyl- 1H-pyrrol-2- yl)methylene)-1,3- dimethylpyrimidine- 2,4,6(1H,3H,5H)-trione | 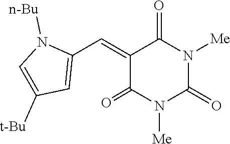 | UV-vis (CH₂Cl₂): λₘₐₓ = 425.8 nm, FWHM = 38.1 nm, HWHM = 11.9 nm, ε_{g} = 156.6 L/g-cm. ¹H NMR (CDCl₃): 8.49 (s, 1H), 8.43 (s, 1H), 7.15 (s, 1H), 4.16 (t, 2H), 3.41 (s, 6H), 1.78 (quint, 2H), 1.28- 1.38 (m, 11H), 0.95 (t, 3H). |
| 32 | ethyl 2-(4-(tert-butyl)-2- ((1,3-dimethyl-2,4,6- trioxotetrahydropyrimidin- 5(2H)-ylidene)methyl)- 1H-pyrrol-1-yl)acetate | 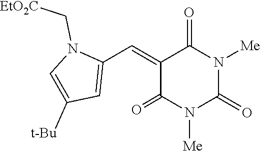 [SMILES: CCOC(=O)Cn1cc(C(C)(C)C)cc1C=C1C(=O)N(C)C(=O)N(C)C1=O] | UV-vis (CH₂Cl₂): λₘₐₓ = 420.8 nm, FWHM = 41.4 nm, HWHM = 13.0 nm. ¹H NMR (CDCl₃): 8.57 (s, 1H), 8.22 (s, 1H), 7.12 (s, 1H), 4.88 (s, 2H), 4.26 (quart, 2H), 3.41 (s, 3H), 3.39 (s, 3H), 1.25-1.33 (m, 12H). |
| 33 | 2-(4-(tert-butyl)-2-((1,3- dimethyl-2,4,6- trioxotetrahydropyrimidin- 5(2H)-ylidene)methyl)- 1H-pyrrol-1- yl)acetonitrile | 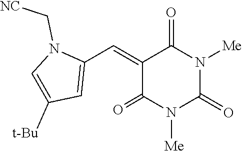 [SMILES: CN1C(=O)C(=Cc2cc(C(C)(C)C)cn2CC#N)C(=O)N(C)C1=O] | UV-vis (CH₂Cl₂): λₘₐₓ = 415.6 nm, FWHM = 45.1 nm, HWHM = 13.7 nm. ¹H NMR (CDCl₃): 8.55 (s, 1H), 8.28 (s, 1H), 7.18 (s, 1H), 5.07 (s, 2H), 3.42 (s, 6H), 1.39 (s, 9H). |
| 34 | 5-((4-(tert-butyl)-1- (naphthalen-2-ylmethyl)- 1H-pyrrol-2- yl)methylene)-1,3- dimethylpyrimidine- 2,4,6(1H,3H,5H)-trione | 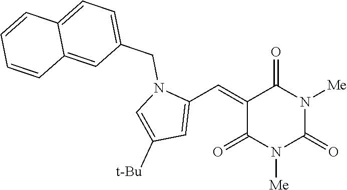 [SMILES: CN1C(=O)C(=Cc2cc(C(C)(C)C)cn2Cc2ccc3ccccc3c2)C(=O)N(C)C1=O] | UV-vis (CH₂Cl₂): λₘₐₓ = 424.8 nm, FWHM = 40.0 nm, HWHM = 12.4 nm. |
| 35 | ethyl 1-(cyanomethyl)-5- ((1,3-dimethyl-2,4,6- trioxotetrahydropyrimidin- 5(2H)-ylidene)methyl)- 2,4-dimethyl-1H-pyrrole- 3-carboxylate | 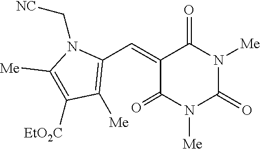 [SMILES: CCOC(=O)c1c(C)c(C=C2C(=O)N(C)C(=O)N(C)C2=O)n(CC#N)c1C] | UV-vis (CH₂Cl₂): λₘₐₓ = 428.2 nm, FWHM = 56.6 nm, HWHM = 23.9 nm. ¹H NMR (CDCl₃): 8.36 (s, 1H), 4.75 (s, 2H), 4.34 (quart, 2H), 3.43 (s, 3H), 3.34 (s, 3H), 2.78 (s, 3H), 2.39 (s, 3H), 1.38 (t, 3H). |
| 36 | ethyl 1-benzyl-5-((1,3- dimethyl-2,4,6- trioxotetrahydropyrimidin- 5(2H)-ylidene)methyl)- 2,4-dimethyl-1H-pyrrole- 3-carboxylate | 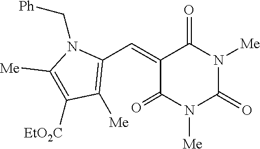 [SMILES: CCOC(=O)c1c(C)c(C=C2C(=O)N(C)C(=O)N(C)C2=O)n(Cc2ccccc2)c1C] | UV-vis (CH₂Cl₂): λₘₐₓ = 439.5 nm, FWHM = 55.9 nm, HWHM = 22.9 nm. ¹H NMR (CDCl₃) of D0835 (DH-4410-71- S1): 8.29 (s, 1H), 7.25- 7.33 (m, 3H), 6.87 (d, 2H), 5.18 (s, 2H), 4.31 (quart, 2H), 3.36 (s, 6H), |
| | | | 2.51 (s, 3H), 2.27 (d, |
| | | | 3H), 1.37 (t, 3H). |
| 37 | ethyl 1-(cyanomethyl)-5- ((1,3-dimethyl-2,4,6- trioxotetrahydropyrimidin- 5(2H)-ylidene)methyl)- 1H-pyrrole-2-carboxylate | 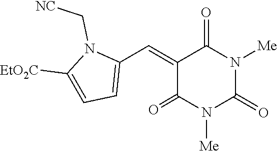 [SMILES: CCOC(=O)c1ccc(C=C2C(=O)N(C)C(=O)N(C)C2=O)n1CC#N] | UV-vis (CH₂Cl₂): λₘₐₓ = 392.4 nm, FWHM = 55.9 nm, HWHM = 26.4 nm. ¹H NMR (CDCl₃): 8.37- 8.42 (m, 2H), 7.16 (d, 1H), 5.75 (s, 2H), 4.41 (quart, 2H), 3.44 (s, 3H), 3.41 (s, 3H), 1.41 (t, 3H). |
| 38 | ethyl 1-(cyanomethyl)-5- ((2,4,6-trioxo-1,3- diphenyltetrahydropyrimidin- 5(2H)- ylidene)methyl)-1H- pyrrole-2-carboxylate | 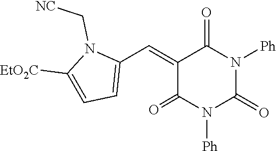 [SMILES: CCOC(=O)c1ccc(C=C2C(=O)N(c3ccccc3)C(=O)N(c3ccccc3)C2=O)n1CC#N] | UV-vis (CH₂Cl₂): λₘₐₓ = 396.6 nm, FWHM = 58.5 nm, HWHM = 28.0 nm. |
| 39 | ethyl 1-benzyl-5-((1,3- dimethyl-2,4,6- trioxotetrahydropyrimidin- 5(2H)-ylidene)methyl)- 1H-pyrrole-2-carboxylate | 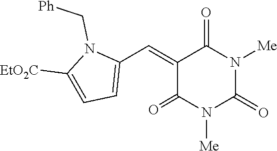 [SMILES: CCOC(=O)c1ccc(C=C2C(=O)N(C)C(=O)N(C)C2=O)n1Cc1ccccc1] | UV-vis (CH₂Cl₂): λₘₐₓ = 412.0 nm, FWHM = 52.5 nm, HWHM = 15.9 nm ¹H NMR (CDCl₃): 8.53 (s, 1H), 8.43 (d, 1H), 7.21-7.32 (m, 3H), 7.16 (d, 1H), 7.09 (d, 2H), 5.99 (s, 2H), 4.35 (quart, 2H) 3.34-3.41 (m, 6H), |
| | | | 1.37 (t, 3H). |

| | | |
|---|---|---|
| 40 | 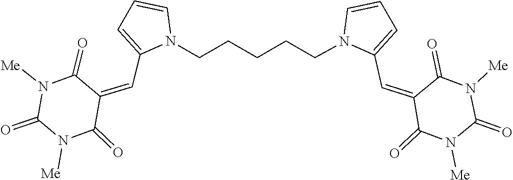 [SMILES: CN1C(=O)C(=Cc2cccn2CCCCCn2cccc2C=C2C(=O)N(C)C(=O)N(C)C2=O)C(=O)N(C)C1=O] | UV-vis (CH₂Cl₂): λₘₐₓ = 412.8 nm, FWHM = 43.3 nm, HWHM = 14.0 nm. ¹H NMR (CDCl₃): 8.61 (d, 2H), 8.41 (s, 2H), 7.21 (s, 2H), 6.43 (m, 2H), 4.18 (t, 4H), 3.41 (s, 12H), 1.82 (quint, 4H), 1.30 (m, 2H). |
| | 5,5′-((pentane-1,5-diylbis(1H-pyrrole-1,2- | |
| | diyl))bis(methaneylylidene))bis(1,3-dimethylpyrimidine- | |
| | 2,4,6(1H,3H,5H)-trione) | |
| 41 | 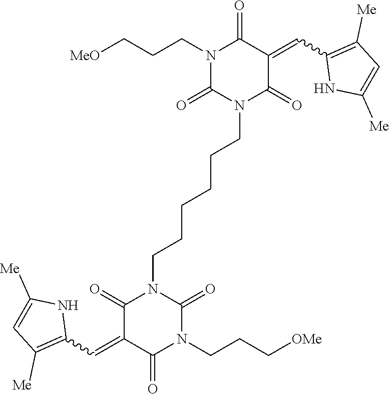 [SMILES: COCCCN1C(=O)C(=Cc2[nH]c(C)cc2C)C(=O)N(CCCCCCN2C(=O)C(=Cc3[nH]c(C)cc3C)C(=O)N(CCCOC)C2=O)C1=O] | UV-vis (CH₂Cl₂): λₘₐₓ = 428.4 nm, FWHM = 29.0 nm, HWHM = 8.7 nm. ¹H NMR (CDCl₃): 13.23 (s, 2H), 8.25 (s, 2H), 6.15 (s, 2H), 4.09 (t, 4H), 3.95 (t, 4H), 3.47 (t, 4H), 3.34 (s, 6H), 2.43 (s, 6H), 2.36 (s, 6H), 1.95 (quint, 4H), 1.66 (m, 4H), 1.41 (m, 4H). |
| | 3,3′-(hexane-1,6-diyl)bis(5-((3,5-dimethyl-1H-pyrrol-2- | |
| | yl)methylene)-1-(3-methoxypropyl)pyrimidine- | |
| | 2,4,6(1H,3H,5H)-trione) | |
| 42 | 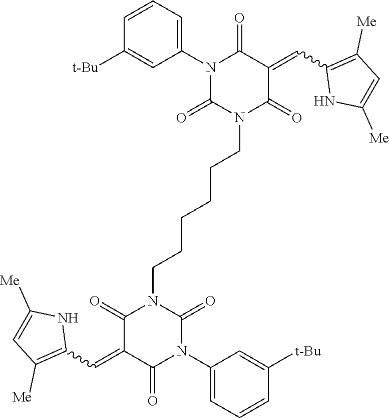 [SMILES: Cc1cc(C)c(C=C2C(=O)N(CCCCCCN3C(=O)C(=Cc4[nH]c(C)cc4C)C(=O)N(c4cccc(C(C)(C)C)c4)C3=O)C(=O)N(c3cccc(C(C)(C)C)c3)C2=O)[nH]1] | UV-vis (CH₂Cl₂): λₘₐₓ = 428.8 nm, FWHM = 27.8 nm, HWHM = 8.8 nm. ¹H NMR (CDCl₃): Mixture of isomers. 12.88-13.25 (two br s, 2H total), 8.25-8.34 (two s, 2H total), 7.36-7.53 (m, 4H), 7.20-7.26 (two s, 2H total), 7.00-7.13 (two d, 2H total), 6.11- 6.18 (two 2, 2H total), 4.00 (m, 4H), 2.28-2.48 (four s, 12H total), 1.71 (m, 4H), 1.43 (m, 4H), 1.32-1.37 (m, 18H). MS (APCI+): 813.9 m/z. |
| | 3,3′-(hexane-1,6-diyl)bis(1-(3-(tert-butyl)phenyl)-5- | |
| | ((3,5-dimethyl-1H-pyrrol-2-yl)methylene)pyrimidine- | |
| | 2,4,6(1H,3H,5H)-trione) | |

### Example 3: Preparation of PMMA Plaque Comprising tris(4-di(n-butyl)aminophenyl)amminium tetrakis(pentafluorophenyl)borate

To 48 gm of inhibitor-free methyl methacrylate (MMA) was added 100 by weight bis(2-ethylhexyl)phosphate and 0.0500 by weight azobis(isobutyronitrile) (AIBN). The resulting solution was heated at 80° C. with rapid mixing for 64 minutes, then quickly cooled to room temperature in a water bath to give a colorless and transparent thick syrup, to which was added the dye tris(4-di(n-butyl)aminophenyl)amminium tetrakis(pentafluorophenyl)b orate (a compound of Formula I).

The dye dissolved into the syrup by slow rotation at room temperature. A suitable casting cell was constructed from two 4 in.×4 in.×0.25 in. polished borosilicate glass plates held parallel to one other and separated by a continuous perimeter gasket 0.25 in. wide×0.1875 in. thick cut as a single piece from a sheet of Shore-10A high-temperature silicone rubber.

The cavity was filled with dyed casting syrup. The assembled cell was clamped with adjustable spring clamps possessing parallel non-slip pads providing 22.4 psi clamping force against the total gasket area or 5.25 psi across the entire cell face as it was thermally cured.

Initially, the clamped cell was immersed in a 75° C. circulating water bath, then brought to 77° C. over a period of 15 minutes. After 1 hour, the temperature was increased to 81° C., then to 83° C. one hour later. The temperature was further increased to 85° C. for an additional hour then the cell was transferred to a convection oven at 90° C. for 45 min. After cooling, a 4.3 mm thick optical quality dyed PMMA window was removed from the cell.

### Example 4: Preparation of PMMA Window Comprising tris(4-di(n-butyl)aminophenyl)amminium hexafluoroantimonate

The process of Example 3 was repeated but with tris(4-di(n-butyl)aminophenyl)amminium hexafluoroantimonate, i.e., an amminium dye comprised of a more traditional counterion (SbF₆⁻). The resulting article was a muddier color, had lower transmission, and had lower optical density than the part prepared with a (C₆F₅)₄B⁻ counterion, e.g., the part prepared in Example 3.

The process of Example 3 was repeated twice without bis(2-ethylhexyl)phosphate. A solid part was not obtained for either tris(4-di(n-butyl)aminophenyl)amminium tetrakis(pentafluorophenyl)borate or tris(4-di(n-butyl)aminophenyl)amminium hexafluoroantimonate.

It is to be appreciated that the Detailed Description section, and not the Summary and Abstract sections, is intended to be used to interpret the claims. The Summary and Abstract sections may set forth one or more but not all exemplary aspects of the present invention as contemplated by the inventor(s), and thus, are not intended to limit the present invention and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific aspects will so fully reveal the general nature of the invention that others can, by applying knowledge within the skill of the art, readily modify and/or adapt for various applications such specific aspects, without undue experimentation, without departing from the general concept of the present invention. Therefore, such adaptations and modifications are intended to be within the meaning and range of equivalents of the disclosed aspects, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary aspects, but should be defined only in accordance with the following claims and their equivalents.

What is claimed is:

1. A dyed article comprising a polymer resin and
a) a first dye that provides peak infrared absorption in the range of between about 900 nm and about 1100 nm in the resin, and
b) a minus-violet dye.

2. The dyed article of claim 1, wherein the first dye is a dye according to Formula I: 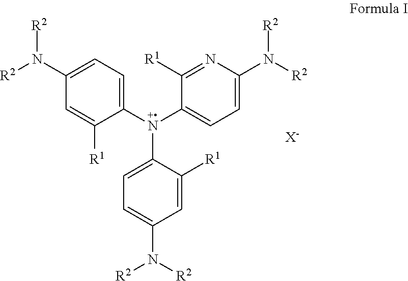
wherein each R¹ is independently at each occurrence H or C₁-C₄ alkyl;
each R² is independently at each occurrence selected from the group consisting of C₁-C₆ alkyl, C₁-C₆ haloalkyl, and C₁-C₆ cyanoalkyl; and
X⁻ is an anion.

3. The dyed article of claim 2, wherein each R¹ is H.

4. The dyed article of claim 2, wherein the first dye is

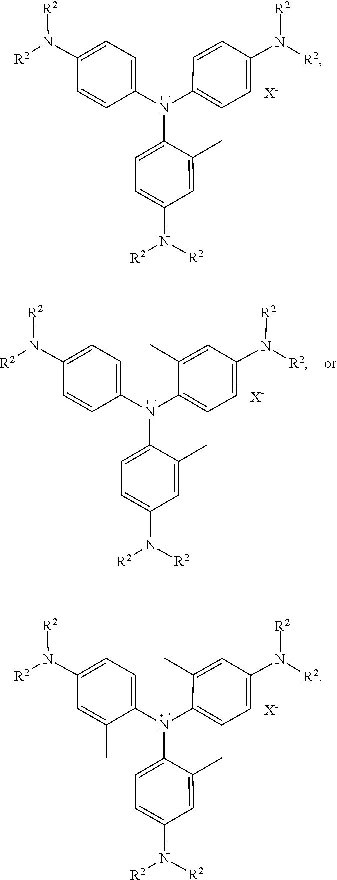

5. The dyed article of claim 2, wherein the anion is bis(alkylsulfonyl)amide having the formula [N(SO₂CF₃)₂]⁻.

6. The dyed article of claim 2, wherein the anion is a borate having the formula [BX^{c}₄]⁻, wherein X^{c} is selected from the group consisting of halo, C₁-C₄ alkyl, C₁-C₄ haloalkyl, and phenyl optionally substituted with one to five groups selected from halo and C₁-C₄ haloalkyl.

7. The dyed article of claim 6, wherein the borate is [BF₄]⁻, [B(C₆F₅)₄]⁻, or [B(3,5-(CF₃)₂C₆H₃)₄]⁻.

8. The dyed article of claim 2, wherein the first dye is a compound selected from the group consisting of:
tris(4-di(n-butyl)amino-2-methylphenyl)amminium tetrafluoroborate;
bis(4-di(n-butyl)amino-2-methylphenyl)(4-di(n-butyl)amino-phenyl)amminium tetrafluoroborate;
bis(4-di(n-butyl)amino-phenyl)(4-di(n-butyl)amino-2-methylphenyl)amminium tetrafluoroborate;
tris(4-di(n-butyl)aminophenyl)amminium tetrakis(pentafluorophenyl)borate tetrafluoroborate;
tris(4-di(n-butyl)amino-2-methylphenyl)amminium perchlorate;
bis(4-di(n-butyl)amino-2-methylphenyl)(4-di(n-butyl)amino-phenyl)amminium perchlorate;
bis(4-di(n-butyl)amino-phenyl)(4-di(n-butyl)amino-2-methylphenyl)amminium perchlorate;
tris(4-di(n-butyl)aminophenyl)amminium perchlorate;
bis(4-di(n-butyl)amino-2-methylphenyl)(4-di(n-butyl)aminophenyl)amminium tetrakis(pentafluorophenyl)borate;
tris(4-di(n-butyl)amino-2-methylphenyl)amminium tetrakis(pentafluorophenyl)borate;
bis(4-di(n-butyl)amino-phenyl)(4-di(n-butyl)amino-2-methylphenyl)amminium tetrakis(pentafluorophenyl)borate;
tris(4-di(n-butyl)aminophenyl)amminium tetrakis(pentafluorophenyl)borate;
tris(4-di(n-butyl)amino-2-methylphenyl)amminium methanesulfonate;
bis(4-di(n-butyl)amino-2-methylphenyl)(4-di(n-butyl)amino-phenyl)amminium methanesulfonate;
bis(4-di(n-butyl)amino-phenyl)(4-di(n-butyl)amino-2-methylphenyl)amminium methanesulfonate;
tris(4-di(n-butyl)aminophenyl)amminium methanesulfonate;
tris(4-di(3-cyanopropyl)amino-2-methylphenyl)amminium tetrafluoroborate;
bis(4-di(3-cyanopropyl))amino-2-methylphenyl)(4-di(3-cyanopropyl)amino-phenyl)amminium tetrafluoroborate;
bis(4-di(3-cyanopropyl)amino-phenyl)(4-di(3-cyanopropyl)amino-2-methylphenyl)amminium tetrafluoroborate;
tris(4-di(3-cyanopropyl)aminophenyl)amminium tetrafluoroborate;
tris(4-di(3-cyanopropyl)amino-2-methylphenyl)amminium tetrakis(pentafluorophenyl)borate;
bis(4-di(3-cyanopropyl))amino-2-methylphenyl)(4-di(3-cyanopropyl)amino-phenyl)amminium tetrakis(pentafluorophenyl)borate;
bis(4-di(3-cyanopropyl)amino-phenyl)(4-di(3-cyanopropyl)amino-2-methylphenyl)amminium tetrakis(pentafluorophenyl)borate; and
tris(4-di(3-cyanopropyl)aminophenyl)amminium tetrakis(pentafluorophenyl)borate.

9. The dyed article of claim 1, wherein the minus-violet dye is a dye according to Formula II: 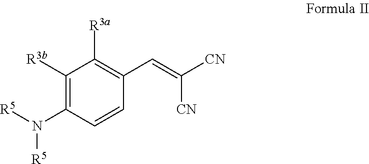
wherein:
R^{3a} and R^{3b} are each independently selected from the group consisting of H, C₁-C₄ alkyl, C₁-C₄ alkoxy, phenoxy, C₁-C₄ alkylthio, hydroxyl, and halo;
R⁴ and R⁵ are each independently selected from the group consisting of C₁-C₆ alkyl, C₁-C₆ haloalkyl, C₁-C₆ cyanoalkyl, C₆-C₁₀ aryl, C₁-C₆ alkylene-C(═O)OR^{4a}, C₁-C₆ alkylene-C(═O)R^{4a}, and C₁-C₆ alkylene-OC(═O)NR^{4a}R^{4b}; or
R⁴ and R⁵ are taken together with the nitrogen atom to which they are attached to form an optionally substituted 4- to 7-membered heterocycle;
R^{4a} is independently at each occurrence selected from the group consisting of C₁-C₆ alkyl and C₆-C₁₀ aryl; and
R^{4b} is independently at each occurrence selected from the group consisting of H and C₁-C₄ alkyl.

10. The dyed article of claim 9, wherein:
R^{3a} is H, methyl, methoxy, ethyloxy, phenoxy, hydroxyl, fluoro, chloro, or bromo;
R^{3b} is H; and
R⁴ and R⁵ are each independently selected from the group consisting of methyl, ethyl, n-butyl, phenyl, 3-cyanopropyl, —CH₂C(═O)OCH₂CH₃, —CH₂CH₂C(═O)CH₃ and —CH₂CH₂OC(═O)NH(C₆-C₁₀ aryl), or
R⁴ and R⁵ are taken together with the nitrogen atom to which they are attached to form a pyrrolidinyl group.

11. The dyed article of claim 9, wherein the minus-violet dye is a compound selected from the group consisting of:
2-(4-(dimethylamino)benzylidene)malononitrile;
2-(4-(diethylamino)benzylidene)malononitrile;
2-(4-(pyrrolidin-1-yl)benzylidene)malononitrile;
2-(4-(dimethylamino)-2-methylbenzylidene)malononitrile;
2-(4-(diethylamino)-2-ethoxybenzylidene)malononitrile;
2-(4-(diethylamino)-2-phenoxybenzylidene)malononitrile;
diethyl 2,2′-((4-(2,2-dicyanovinyl)phenyl)azanediyl)diacetate;
diethyl 2,2′-((4-(2,2-dicyanovinyl)-3-methoxyphenyl)azanediyl)diacetate;
diethyl 2,2′-((4-(2,2-dicyanovinyl)-3-fluorophenyl)azanediyl)diacetate;
2-(4-(bis(3-cyanopropyl)amino)-2-methoxybenzylidene)malononitrile; and
2-((4-(2,2-dicyanovinyl)-3-methylphenyl)(ethyl)amino)ethyl phenylcarbamate.

12. The dyed article of claim 1, wherein the minus-violet dye is a dye according to Formula III: 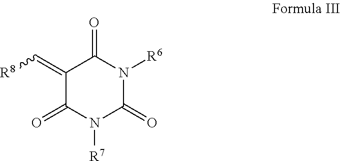
or a stereoisomer thereof, wherein:
R⁶ is selected from the group consisting of H, C₁-C₆ alkyl, —(CH₂)ₙO(CH₂)ₘCH₃, C₃-C₁₂ cycloalkyl, C₆-C₁₀ aryl, and C₆-C₁₀ arylene-C₁-C₄ alkyl;
R⁷ is selected from the group consisting of H, C₁-C₆ alkyl, —(CH₂)ₙO(CH₂)ₘCH₃, C₃-C₁₂ cycloalkyl, C₆-C₁₀ aryl, C₆-C₁₀ arylene-C₁-C₄ alkyl, and C₁-C₁₂ alkylene-R¹²;
n at each occurrence is independently an integer from 1 to 6;
m at each occurrence is independently an integer from 0 to 3;
R⁸ is 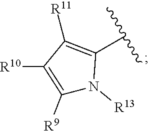
R⁹, R¹⁰, and R¹¹ are each independently selected from the group consisting of C₁-C₆ alkyl, C₃-C₁₂ cycloalkyl, phenyl, and phenylene-C₁-C₄ alkyl;
R¹³ is selected from the group consisting of H, C₁-C₆ alkyl, C₁-C₆ haloalkyl, C₁-C₆ cyanoalkyl, C₁-C₆ alkylene-C₆-C₁₀ aryl, C₁-C₆ alkylene-OC(═O)R¹⁴, and C₁-C₁₂ alkylene-R¹⁵;
R¹² is 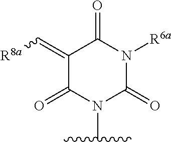
provided that when R⁷ is C₁-C₁₂ alkylene-R¹², R^{8a} is identical to R¹ and R^{6a} is identical to R⁶;
R¹⁴ is C₁-C₆ alkyl; and
R¹⁵ is 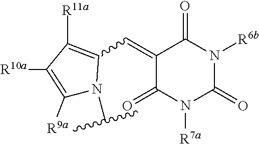
provided that when R¹³ is C₁-C₁₂ alkylene-R¹, R^{9a} is identical to R⁹, R^{10a} is identical to R¹⁰, R^{11a} is identical to R¹¹, R^{6b} is identical to R⁶, and R^{7a} is identical to R⁷.

13. The dyed article of claim 12, wherein:
R⁶ is methyl, 3-methoxypropyl, cyclohexyl, phenyl, or 3-tert-butylphenyl;
R⁷ is methyl, 3-methoxypropyl, cyclohexyl, phenyl, 3-tert-butylphenyl, or hexylene-R¹²;
R⁹ is H, methyl, tert-butyl, or —CH₂C(═O)OCH₂CH₃;
R¹⁰ is H, tert-butyl, or —CH₂C(═O)OCH₂CH₃;
R¹¹ is H or methyl; and
R¹³ is H, methyl, n-butyl, cyanomethyl, —CH₂C(═O)OCH₂CH₃, benzyl, 2-napthalenylmethyl, or hexylene-R¹.

14. The dyed article of claim 12, wherein R⁸ is:

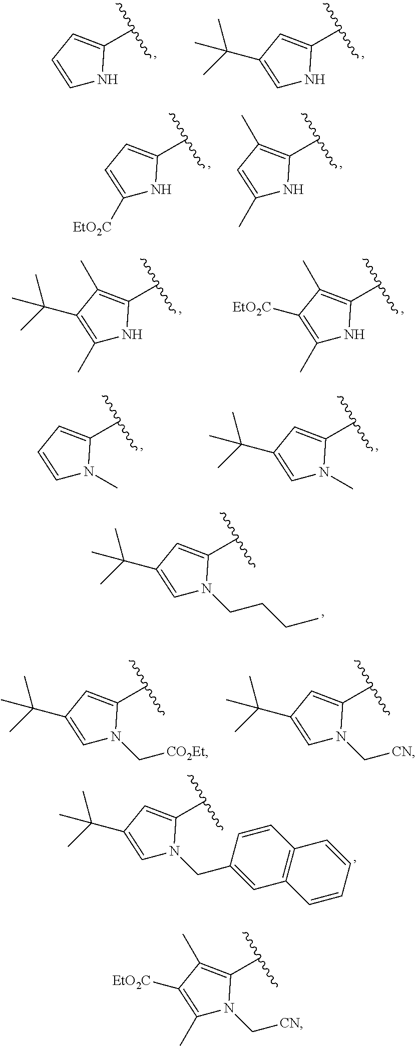

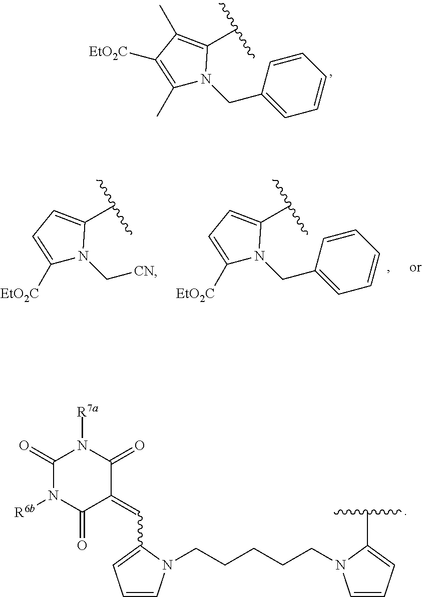

15. The dyed article of claim 12, wherein the minus-violet dye is a compound selected from the group consisting of:
5-((1H-pyrrol-2-yl)methylene)-1,3-dimethylpyrimidine-2,4,6(1H,3H,5H)-trione;
5-((1H-pyrrol-2-yl)methylene)-1,3-diphenylpyrimidine-2,4,6(1H,3H,5H)-trione;
5-((1H-pyrrol-2-yl)methylene)-1,3-dicyclohexylpyrimidine-2,4,6(1H,3H,5H)-trione;
5-((1H-pyrrol-2-yl)methylene)-1,3-bis(3-(tert-butyl)phenyl)pyrimidine-2,4,6(1H,3H,5H)-trione;
5-((1H-pyrrol-2-yl)methylene)-1-(3-methoxypropyl)-3-phenylpyrimidine-2,4,6(1H,3H,5H)-trione;
(E)-5-((1H-pyrrol-2-yl)methylene)-1-(3-methoxypropyl)-3-phenylpyrimidine-2,4,6(1H,3H,5H)-trione;
(Z)-5-((1H-pyrrol-2-yl)methylene)-1-(3-methoxypropyl)-3-phenylpyrimidine-2,4,6(1H,3H,5H)-trione;
5-((4-(tert-butyl)-1H-pyrrol-2-yl)methylene)-1,3-dimethylpyrimidine-2,4,6(1H,3H,5H)-trione;
5-((3,5-dimethyl-1H-pyrrol-2-yl)methylene)-1,3-dimethylpyrimidine-2,4,6(1H,3H,5H)-trione;
5-((3,5-dimethyl-1H-pyrrol-2-yl)methylene)-1,3-diphenylpyrimidine-2,4,6(1H,3H,5H)-trione;
1,3-dicyclohexyl-5-((3,5-dimethyl-1H-pyrrol-2-yl)methylene)pyrimidine-2,4,6(1H,3H,5H)-trione;
1,3-bis(3-(tert-butyl)phenyl)-5-((3,5-dimethyl-1H-pyrrol-2-yl)methylene)pyrimidine-2,4,6(1H,3H,5H)-trione;
1-cyclohexyl-5-((3,5-dimethyl-1H-pyrrol-2-yl)methylene)-3-phenylpyrimidine-2,4,6(1H,3H,5H)-trione;
(E)-1-cyclohexyl-5-((3,5-dimethyl-1H-pyrrol-2-yl)methylene)-3-phenylpyrimidine-2,4,6(1H,3H,5H)-trione;
(Z)-1-cyclohexyl-5-((3,5-dimethyl-1H-pyrrol-2-yl)methylene)-3-phenylpyrimidine-2,4,6(1H,3H,5H)-trione;
5-((3,5-dimethyl-1H-pyrrol-2-yl)methylene)-1-(3-methoxypropyl)-3-phenylpyrimidine-2,4,6(1H,3H,5H)-trione;
(E)-5-((3,5-dimethyl-1H-pyrrol-2-yl)methylene)-1-(3-methoxypropyl)-3-phenylpyrimidine-2,4,6(1H,3H,5H)-trione;
(Z)-5-((3,5-dimethyl-1H-pyrrol-2-yl)methylene)-1-(3-methoxypropyl)-3-phenylpyrimidine-2,4,6(1H,3H,5H)-trione;
5-((4-(tert-butyl)-3,5-dimethyl-1H-pyrrol-2-yl)methylene)-1,3-dimethylpyrimidine-2,4,6(1H,3H,5H)-trione;
ethyl 5-((1,3-dimethyl-2,4,6-trioxotetrahydropyrimidin-5(2H)-ylidene)methyl)-2,4-dimethyl-1H-pyrrole-3-carboxylate;
ethyl 2,4-dimethyl-5-((2,4,6-trioxo-1,3-diphenyltetrahydropyrimidin-5(2H)-ylidene)methyl)-1H-pyrrole-3-carboxylate;
ethyl 5-((1,3-dimethyl-2,4,6-trioxotetrahydropyrimidin-5(2H)-ylidene)methyl)-1H-pyrrole-2-carboxylate;
ethyl 5-((2,4,6-trioxo-1,3-diphenyltetrahydropyrimidin-5(2H)-ylidene)methyl)-1H-pyrrole-2-carboxylate;
1,3-dimethyl-5-((1-methyl-1H-pyrrol-2-yl)methylene)pyrimidine-2,4,6(11H,3H,5H)-trione;
5-((4-(tert-butyl)-1-methyl-1H-pyrrol-2-yl)methylene)-1,3-dimethylpyrimidine-2,4,6(11H,3H,5H)-trione;
5-((4-(tert-butyl)-1-butyl-1H-pyrrol-2-yl)methylene)-1,3-dimethylpyrimidine-2,4,6(11H,3H,5H)-trione;
ethyl 2-(4-(tert-butyl)-2-((1,3-dimethyl-2,4,6-trioxotetrahydropyrimidin-5(2H)-ylidene)methyl)-1H-pyrrol-1-yl)acetate;
2-(4-(tert-butyl)-2-((1,3-dimethyl-2,4,6-trioxotetrahydropyrimidin-5(2H)-ylidene)methyl)-1H-pyrrol-1-yl)acetonitrile;
5-((4-(tert-butyl)-1-(naphthalen-2-ylmethyl)-1H-pyrrol-2-yl)methylene)-1,3-dimethylpyrimidine-2,4,6(1H,3H,5H)-trione;
ethyl 1-(cyanomethyl)-5-((1,3-dimethyl-2,4,6-trioxotetrahydropyrimidin-5(2H)-ylidene)methyl)-2,4-dimethyl-1H-pyrrole-3-carboxylate;
ethyl 1-benzyl-5-((1,3-dimethyl-2,4,6-trioxotetrahydropyrimidin-5(2H)-ylidene)methyl)-2,4-dimethyl-1H-pyrrole-3-carboxylate;
ethyl 1-(cyanomethyl)-5-((1,3-dimethyl-2,4,6-trioxotetrahydropyrimidin-5(2H)-ylidene)methyl)-1H-pyrrole-2-carboxylate;
ethyl 1-(cyanomethyl)-5-((2,4,6-trioxo-1,3-diphenyltetrahydropyrimidin-5(2H)-ylidene)methyl)-1H-pyrrole-2-carboxylate;
ethyl 1-benzyl-5-((1,3-dimethyl-2,4,6-trioxotetrahydropyrimidin-5(2H)-ylidene)methyl)-1H-pyrrole-2-carboxylate;
5,5′-((pentane-1,5-diylbis(1H-pyrrole-1,2-diyl))bis(methaneylylidene))bis(1,3-dimethylpyrimidine-2,4,6(1H,3H,5H)-trione);
3,3′-(hexane-1,6-diyl)bis(5-((3,5-dimethyl-1H-pyrrol-2-yl)methylene)-1-(3-methoxypropyl)pyrimidine-2,4,6(1H,3H,5H)-trione);
(5E,5′E)-3,3′-(hexane-1,6-diyl)bis(5-((3,5-dimethyl-1H-pyrrol-2-yl)methylene)-1-(3-methoxypropyl)pyrimidine-2,4,6(1H,3H,5H)-trione);
(5E,5′Z)-3,3′-(hexane-1,6-diyl)bis(5-((3,5-dimethyl-1H-pyrrol-2-yl)methylene)-1-(3-methoxypropyl)pyrimidine-2,4,6(1H,3H,5H)-trione);
(5Z,5′Z)-3,3′-(hexane-1,6-diyl)bis(5-((3,5-dimethyl-1H-pyrrol-2-yl)methylene)-1-(3-methoxypropyl)pyrimidine-2,4,6(1H,3H,5H)-trione);
3,3′-(hexane-1,6-diyl)bis(1-(3-(tert-butyl)phenyl)-5-((3,5-dimethyl-1H-pyrrol-2-yl)methylene)pyrimidine-2,4,6(1H,3H,5H)-trione);
(5E,5′E)-3,3′-(hexane-1,6-diyl)bis(1-(3-(tert-butyl)phenyl)-5-((3,5-dimethyl-1H-pyrrol-2-yl)methylene)pyrimidine-2,4,6(1H,3H,5H)-trione);
(5E,5′Z)-3,3′-(hexane-1,6-diyl)bis(1-(3-(tert-butyl)phenyl)-5-((3,5-dimethyl-1H-pyrrol-2-yl)methylene)pyrimidine-2,4,6(1H,3H,5H)-trione);
(5Z,5′Z)-3,3′-(hexane-1,6-diyl)bis(1-(3-(tert-butyl)phenyl)-5-((3,5-dimethyl-1H-pyrrol-2-yl)methylene)pyrimidine-2,4,6(1H,3H,5H)-trione).

16. The dyed article of claim 1, wherein the dyed article is in the form of a shield, a lens, a window, a lid, a cover, a case, a plaque, a sheet, a film, clothing, a panel, or a curtain.

17. The dyed article of claim 1, wherein the polymer resin is selected from the group consisting of an acrylic resin, a styrenic resin, a cellulosic resin, a polyamide resin, a polycarbonate resin, a polyester resin, and a polyurethane resin.

18. The dyed article of claim 17, wherein the polymer resin is crosslinked.

19. A process of preparing the dyed article of claim 1, comprising coating, casting, extruding, or molding the polymer resin together with the first dye and the minus-violet dye.

20. The process of claim 19, comprising mixing the polymer resin, the first dye, and the minus-violet dye for about 30 minutes to about 90 minutes.

21. The process of claim 19, comprising mixing the polymer resin, the first dye, and the minus-violet dye with a radical initiator.

22. The process of claim 19, comprising heating the polymer resin, the first dye, and the minus-violet dye to a temperature of from about 60° C. to about 300° C.

23. The dyed article of claim 1, wherein the dyed article has an optical density of at least 7 at 1064 nm.
